(19) United States
(12) Patent Application Publication
(10) Pub. No.: US 2009/0261959 A1
(43) Pub. Date: Oct. 22, 2009

(54) Energy dissipative cushioning system

(76) Inventors: Roderick A. Hyde, Redmond, WA (US); Muriel Y. Ishikawa, Livermore, CA (US); Lowell L. Wood, JR., Bellevue, WA (US)

Correspondence Address: BRAKE HUGHES BELLERMANN LLP;Suite 400, 1700 Pennsylvania Ave., NW, Washington, DC, 20006, US

(21) Appl. No.: 12/148,514

(22) Filed: Apr. 19, 2008

(51) Int. Cl. G06F 19/00

(52) U.S. Cl. 340/436

(57) ABSTRACT

An apparatus, method, computer program product, and/or system are described that determine a pre-collision event, actuate, in response to determining the pre-collision event, a cushioning element prior to a collision between a first object and a second object, the cushioning element including one or more tension-bearing members to dissipate at least some of an energy associated with the collision based on deforming at least one of the tension-bearing members during the collision, determine an updated status of the collision, and adjust one or more properties of the cushioning element based on the updated status of the collision. Other example embodiments are also provided relating to energy dissipative cushioning systems.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/136,339 entitled WEARABLE/PORTABLE PROTECTION FOR A BODY, naming Muriel Y. Ishikawa, Edward K. Y. Jung, Cameron A. Myhrvold, Conor L. Myhrvold, Nathan P. Myhrvold, Lowell L. Wood, Jr. and Victoria Y. H. Wood, as inventors, filed May 24, 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/603,965 entitled ACTUATABLE CUSHIONING ELEMENTS, naming Muriel Y. Ishikawa, Edward K. Y. Jung, Cameron A. Myhrvold, Conor L. Myhrvold, Nathan P. Myhrvold, Lowell L. Wood, Jr. and Victoria Y. H. Wood, as inventors, filed Nov. 21, 2006, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/726,706 entitled ACTUATABLE CUSHIONING ELEMENTS, naming Muriel Y. Ishikawa, Edward K. Y. Jung, Cameron A. Myhrvold, Conor L. Myhrvold, Nathan P. Myhrvold, Lowell L. Wood, Jr. and Victoria Y. H. Wood, as inventors, filed Mar. 21, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/868,416 entitled ENERGY DISSIPATIVE CUSHIONING ELEMENTS, naming Roderick A. Hyde, Muriel Y. Ishikawa, and Lowell L. Wood, J, as inventors, filed Oct. 5, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s) from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent that such subject matter is not inconsistent herewith.

### SUMMARY

An embodiment provides a method. In one implementation, the method includes but is not limited to: determining a pre-collision event; actuating, in response to said determining the pre-collision event, a cushioning element prior to a collision between a first object and a second object, the cushioning element including one or more tension-bearing members to dissipate at least some of an energy associated with the collision based on deforming at least one of the tension-bearing members during the collision; determining an updated status of the collision; and adjusting one or more properties of the cushioning element based on the updated status of the collision. In addition to the foregoing, other method aspects are described in the claims, drawings, and text forming a part of the present disclosure.

An embodiment provides a method. In one implementation, the method includes but is not limited to: determining a collision-related profile for a first object; determining a pre-collision event; actuating, in response to said determining the pre-collision event, a cushioning element prior to a collision between the first object and a second object, the cushioning element including one or more tension-bearing members to dissipate at least some of an energy associated with the collision based on deforming at least one of the tension-bearing members during the collision; determining, during the collision, an updated status of the collision; and adjusting, during the collision, one or more properties of the cushioning element based on the updated status of the collision and the collision-related profile for the first object. In addition to the foregoing, other method aspects are described in the claims, drawings, and text forming a part of the present disclosure.

An embodiment provides a method. In one implementation, the method includes but is not limited to: determining a pre-collision event; actuating, in response to determining the pre-collision event, a cushioning element prior to a collision between a first object and a second object; determining an updated status of the collision; and adjusting, during the collision, one or more properties of the cushioning element based on the updated status of the collision. In addition to the foregoing, other method aspects are described in the claims, drawings, and text forming a part of the present disclosure.

An embodiment provides a computer program product. In one implementation, the computer program product includes but is not limited to a signal bearing medium bearing: one or more instructions for determining a pre-collision event; one or more instructions for actuating, in response to determining the pre-collision event, a cushioning element prior to a collision between a first object and a second object, the cushioning element including one or more tension-bearing members to dissipate at least some of an energy associated with the collision based on deforming at least one of the tension-bearing members during the collision; one or more instructions for determining an updated status of the collision; and one or more instructions for adjusting one or more properties of the cushioning element based on the updated status of the collision. In addition to the foregoing, other computer program product aspects are described in the claims, drawings, and text forming a part of the present disclosure.

An embodiment provides a system. In one implementation, the system includes but is not limited to: a computing device; and one or more instructions that when executed on the computing device cause the computing device to: determine a pre-collision event; actuate, in response to determining the pre-collision event, a cushioning element prior to a collision between a first object and a second object, the cushioning element including one or more tension-bearing members to dissipate at least some of an energy associated with the collision based on deforming at least one of the tension-bearing members during the collision; determine an updated status of the collision; and adjust one or more properties of the cushioning element based on the updated status of the collision. In addition to the foregoing, other system aspects are described in the claims, drawings, and text forming a part of the present disclosure.

An embodiment provides an apparatus. In one implementation, the apparatus includes but is not limited to: an event detector to determine a pre-collision event; a cushioning element including one or more tension-bearing members; and a controller configured to: actuate, in response to determining the pre-collision event, the cushioning element prior to a collision between a first object and a second object to dissipate at least some of an energy associated with the collision based on deforming at least one of the tension-bearing members during the collision; determine an updated status of the collision; and adjust one or more properties of the cushioning element based on the updated status of the collision. In addition to the foregoing, other apparatus aspects are described in the claims, drawings, and text forming a part of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

FIG. 1 illustrates an example system in which embodiments may be implemented.

FIG. 2 illustrates an actuatable cushioning element according to an example embodiment.

FIG. 3A illustrates an actuatable cushioning element according to another example embodiment.

FIG. 3B illustrates an actuatable cushioning element of FIG. 3A in a post-collision state according to an example embodiment.

FIG. 4 is a diagram illustrating an operation of an actuatable energy dissipative cushioning element according to an example embodiment.

FIG. 5A is a diagram illustrating a tension-bearing member according to an example embodiment.

FIG. 5B is a diagram illustrating a tension-bearing member according to another example embodiment.

FIG. 6A is a diagram illustrating an operation of an actuatable energy dissipative cushioning element according to an example embodiment.

FIG. 6B is a diagram illustrating an operation of an actuatable energy dissipative cushioning element according to another example embodiment.

FIG. 7A is a diagram illustrating one or more properties of a cushioning element and/or tension-bearing member that may be adjusted according to an example embodiment.

FIG. 7B is a diagram illustrating one or more properties of a cushioning element and/or tension-bearing member that may be adjusted according to another example embodiment.

FIG. 8 illustrates an operational flow 800 representing example operations related to an energy dissipative cushioning system.

FIG. 9 illustrates an alternative embodiment of the example operational flow of FIG. 8.

FIG. 10 illustrates an alternative embodiment of the example operational flow of FIG. 8.

FIG. 11 illustrates an alternative embodiment of the example operational flow of FIG. 8.

FIG. 12 illustrates an alternative embodiment of the example operational flow of FIG. 8.

FIG. 13 illustrates an alternative embodiment of the example operational flow of FIG. 8.

FIG. 14 illustrates an alternative embodiment of the example operational flow of FIG. 8.

FIG. 15 illustrates an alternative embodiment of the example operational flow of FIG. 8.

FIG. 16 illustrates an alternative embodiment of the example operational flow of FIG. 8.

FIG. 17 illustrates an alternative embodiment of the example operational flow of FIG. 8.

FIG. 18 illustrates an alternative embodiment of the example operational flow of FIG. 8.

FIG. 19 illustrates an alternative embodiment of the example operational flow of FIG. 8.

FIG. 20 illustrates an alternative embodiment of the example operational flow of FIG. 8.

FIG. 21 illustrates an alternative embodiment of the example operational flow of FIG. 8.

FIG. 22 illustrates an alternative embodiment of the example operational flow of FIG. 8.

FIG. 23 illustrates an alternative embodiment of the example operational flow of FIG. 8.

FIG. 24 illustrates an alternative embodiment of the example operational flow of FIG. 8.

FIG. 25 illustrates an alternative embodiment of the example operational flow of FIG. 8.

FIG. 26 illustrates an alternative embodiment of the example operational flow of FIG. 8.

FIG. 27 illustrates an alternative embodiment of the example operational flow of FIG. 8.

FIG. 28 illustrates an alternative embodiment of the example operational flow of FIG. 8.

FIG. 29 illustrates an alternative embodiment of the example operational flow of FIG. 8.

FIG. 30 illustrates an alternative embodiment of the example operational flow of FIG. 8.

FIG. 31 illustrates an alternative embodiment of the example operational flow of FIG. 8.

FIG. 32 illustrates an alternative embodiment of the example operational flow of FIG. 8.

FIG. 33 illustrates another operational flow 3300 representing example operations related to an energy dissipative cushioning system.

FIG. 34 illustrates an alternative embodiment of the example operational flow of FIG. 33.

FIG. 35 illustrates an alternative embodiment of the example operational flow of FIG. 33.

FIG. 36 illustrates an alternative embodiment of the example operational flow of FIG. 33.

FIG. 37 illustrates an alternative embodiment of the example operational flow of FIG. 33.

FIGS. 38A and 38B illustrate alternative embodiments of the example operational flow of FIG. 33.

FIG. 39 illustrates an operational flow 3900 representing example operations related to an energy dissipative cushioning system.

FIG. 40 illustrates a partial view of an example computer program product 4000.

FIG. 41 illustrates an example system 4100.

FIG. 42 illustrates an example apparatus 4200.

FIG. 43 illustrates an alternative embodiment of the example apparatus of FIG. 42.

FIG. 44 illustrates an alternative embodiment of the example apparatus of FIG. 42.

FIG. 45 illustrates an alternative embodiment of the example apparatus of FIG. 42.

The use of the same symbols in different drawings typically indicates similar or identical items.

### DETAILED DESCRIPTION

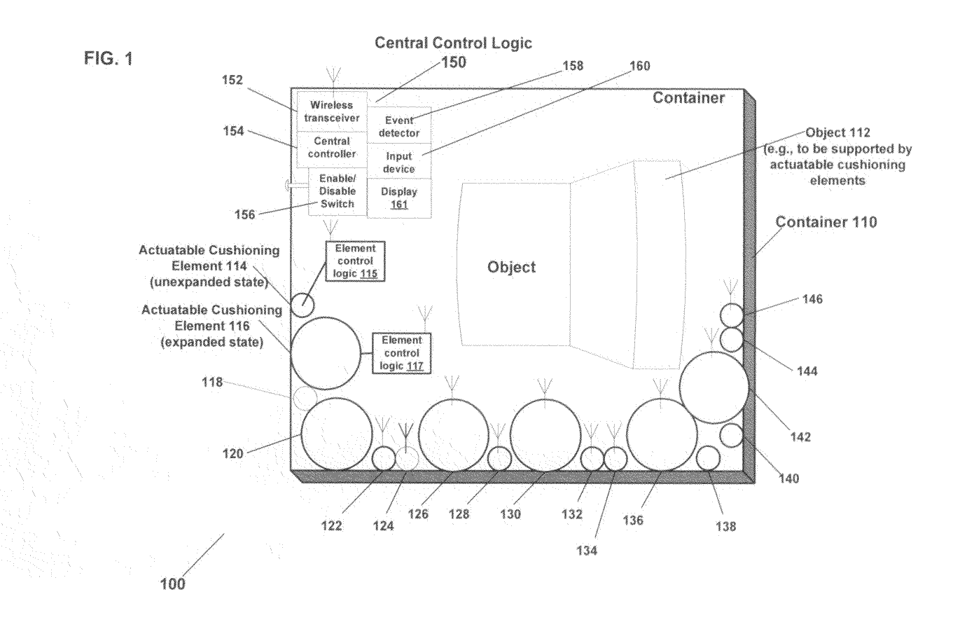

FIG. 1 illustrates an example system 100 in which embodiments may be implemented. System 100 may include, for example, a container 110, which may be any type of container, such as a box, a container for shipping cargo on a vehicle, boat, plane, train or other vehicle, a container for shipping or storing small or large items, a container for shipping fragile items, or any other container. Container 110 may be made from any suitable material, such as cardboard, plastic, steel, etc., as a few example materials, but any type of material may be used.

System 100 may also include one or more actuatable cushioning elements provided within container 110, such as actuatable cushioning elements 114, 116, 118, 120, 122, 124, 126, 128, 130, 132, 134, 136, 138, 140, 142, 144, 146, etc. The actuatable cushioning elements may provide cushioning support for an item or object, such as object 112, for example. Object 112 may be any type of object, such as electronics, books, food items, a vehicle (e.g., automobile, boat, train, and/or plane), cargo, fragile or delicate or breakable items which may be in need of cushioning support, people, animals, other organisms, or any other type of object. These are just a few examples of an object which may be supported by actuatable cushioning elements, and the various embodiments are not limited thereto. Actuatable cushioning elements 114, 116, etc. may spread a force or interaction of an object over a period of time or over an area within container 110, which may, at least in some cases, decrease potential impact and/or damage to the object, for example.

For example, one or more actuatable cushioning elements may be actuated (e.g., expanded) in response to an event to protect an object or passenger from damage or harm or collision effects. Also, for example, one or more actuatable cushioning elements may be actuated based upon one or more sensed values in accordance with a model of one or more objects to be protected, the actuatable cushioning elements, and the environment. Also, for example, one or more actuatable cushioning elements may be actuated over a series of events or in response to a series of events to provide a coordinated protection of one or more objects or passengers in a vehicle from harm, damage or other effects from a collision, acceleration or other event. The protection of one or more objects may be based upon a harm function of the actual or predicted damage to subsets or portions of such objects, such as a maximum value, a weighted value, a cumulative value, or other such functions. The harm function may include damage to the environment (e.g., pedestrians or other vehicles in a vehicular collision, higher valued objects in the vicinity of a container collision, etc.) as well as to the one or more nominally protected objects. These are merely a few illustrative examples and the disclosure is not limited thereto. Additional details and example embodiments are described herein.

Actuatable cushioning elements 114, 116, etc. may be in either an expanded state, such as shown for actuatable cushioning element 116, or an unexpanded state such as for actuatable cushioning element 114, for example. Or an actuatable cushioning element may also be partially expanded or partially unexpanded, for example.

In an example embodiment, some types of actuatable cushioning elements may be provided in an expanded state (e.g., inflated) for a limited period of time. For example, one or more actuatable cushioning elements may be actuated (e.g., expanded or unexpanded) in response to an event. In an example embodiment, a subset of actuatable cushioning elements may be actuated in response to an event. In another example embodiment, one or more actuatable cushioning elements may be expanded just prior to shipment and may remain in an expanded state for an extended period of time, or for a duration of transport, for example. In an example embodiment, an actuatable cushioning element may provide greater cushioning support for an object while in an expanded state, as compared to an unexpanded state (e.g., due to a greater volume of flexible or cushioning material or matter to absorb an impact). This is merely an example embodiment, and the disclosure is not limited thereto.

One or more of the actuatable cushioning elements may be actuated, which may include putting an actuatable cushioning element into motion or action. Actuation may include, for example, expanding an actuatable cushioning element from an unexpanded state to an expanded state (e.g., causing an element to expand or increase in size), or unexpanding an actuatable cushioning element from an expanded state to an unexpanded state (e.g., causing an element to shrink or reduce in size or contract), as examples. Actuation may include, for example, causing an airbag or other entity to inflate or deflate. Actuation may include, for example, changing or controlling the shape of an actuatable cushioning element. Actuation may also include partial motions or partial actions, such as partially expanding or partially unexpanding an actuatable cushioning element, for example.

Actuatable cushioning elements 114, 116, etc. may include any type of expandable element. For example, actuatable cushioning elements 114, 116, etc., may include expandable gas bags which may expand based on the application of pressurized gas to the bag similar to the airbags used in automobiles and other vehicles. Actuatable cushioning elements 114, 116, etc. may alternatively include a fluid-expandable bag or entity that may be expanded by fluid. For example, actuatable cushioning elements 114, 116, etc., may include fluid-actuatable elements, where fluid may be sourced from one or more fluid reservoirs, e.g., via a valving actuation. The fluid reservoirs may, for example, cause the fluid actuatable elements to actuate (e.g., expand and/or unexpand/contract) by causing fluid to flow into or out of the fluid-actuatable elements. For example, actuatable cushioning elements 114, 116, etc., may include magnetic field-actuatable elements, where magnetic field may be sourced from one or more electric energy sources, e.g., via a capacitor, an inductor, a flux generator, or other means. The electric energy sources may, for example, cause the magnetic field actuatable elements to actuate (e.g., expand and/or unexpand/contract) by causing magnetic fields to apply force to the fluid-actuatable elements. Actuatable cushioning elements 114, 116, etc. alternatively may include an expandable cushioning material which may expand (or unexpand), for example, through the application of a chemical, gas, liquid, electrical energy, reaction force or other energy or material. Electrical energy may, for example be used to expand (or unexpand) or shape an expandable cushioning material by means of an electric motor, a linear electromagnetic motor, a piezoelectric actuator, or other means. Reaction force may, for example be used to expand (or unexpand) or shape an expandable cushioning material by means of a rocket engine, a pulsed microimpulse reaction engine, a magnetic repulsion coil, or other means. Expandable cushioning material may apply cushioning force by means of pressure, electric/magnetic fields, inertia, compressive stress, tensile force, or shear force, or a combination thereof. Expandable cushioning material may apply cushioning force and/or dissipate interaction energy by means of crushing (e.g., foam or shells), breaking (e.g., fibers or wires), buckling (e.g., struts or plates) or other mechanisms.

In an example embodiment, the actuatable cushioning elements may be re-usable, where the cushioning elements may be expanded to absorb an impact, later fully or partially unexpanded, and then subsequently expanded again to provide cushioning support or protect the object for a second event or impact, or to provide cushioning support in another container, for example. While in another example embodiment, the actuatable cushioning elements may be disposable, wherein the elements, for example, may be expanded or used only once or only a few times.

Any number of actuatable cushioning elements may be used to provide cushioning support for object 112. For example, in one embodiment, at least 12 actuatable cushioning elements may be used to provide cushioning support for an object. This may include providing at least 12, 20, 50, 100 or even 500 actuatable cushioning elements (or more) to provide cushioning support, according to different example embodiments.

The actuatable cushioning elements may be any shape (e.g., round, oblong, rectangular, irregular shape) and any size. In an example embodiment, one or more of actuatable cushioning elements 114, 116, etc. may be 2.5 cm in width or less in an unexpanded state, or may be 2.5 cm in width or more in an unexpanded state, or may be 5 cm or less in an unexpanded state, or may be 8 cm or less in an unexpanded state, as examples. For example, different numbers and/or sizes of cushioning elements may be used, e.g., depending on the application, the type of object to be protected, the type or size of container to be used, or other factors. These are some example numbers and sizes and the disclosure is not limited thereto. In an example embodiment, smaller-sized actuatable cushioning elements may be more applicable for smaller containers, whereas larger actuatable cushioning elements may be more applicable for larger containers, for example.

In another example embodiment, a group of actuatable cushioning elements may be provided within a container, or outside of the container, to provide cushioning support for an object, such as a vase or other object within the container. A first subset of actuatable cushioning elements may be pre-inflated or pre-expanded in response to a first event, e.g., at packing time or just prior to shipment. At some later point, a second subset of actuatable cushioning elements may be actuated (e.g., expanded), in response to a second event (such as an acceleration that exceeds a threshold, or an impact or likely impact), for example. At some point later, a third subset of actuatable cushioning elements may be actuated (e.g., inflated or expanded), in response to a third event, for example. Also, in an example embodiment, upon arrival (which may be considered a fourth event), one or more (or even all) of the actuatable cushioning elements in the container may be actuated (e.g., unexpanded or deflated), to allow the object to be unpacked from the container. The actuatable cushioning elements may also be-reused in another container, for example. In this manner, the group of actuatable cushioning elements may provide cushioning support for an object, e.g., for one or more events.

Actuatable cushioning elements may be actuated outside of a container or outside of the preactivation envelope of a system. For example, such actuation may provide additional cushioning to that provided with interior actuatable cushioning elements alone. For example, such exterior actuation may also act by modification of the dynamics of the interaction with the environment, such as by introducing sliding contacts, aerodynamic lift, sideways steering forces, or by other means. For example, such exterior actuatable cushioning elements may have spherical shapes, cylindrical shapes, high aspect ratio shapes, lifting-body shapes, or other shapes. For example, exterior actuatable cushioning elements may include expandable gas bags, fluid actuatable elements, expandable cushioning materials, skids, reaction engines, drag-inducing devices, anchors, or other such elements. For example, such exterior actuatable cushioning elements may act in a time dependent (e.g., via a specified actuation profile, by stretching, deforming, breaking) and/or time sequenced manner (e.g., by timed activation of one or more exterior actuatable cushioning elements).

According to an example embodiment, one or more actuatable cushioning elements may be actuated (e.g., expanded or unexpanded) for or in response to an event. The event may be any of a variety of different events. For example, the event may include determining an impact or likely impact, determining an acceleration or change in acceleration that exceeds a threshold (such as when a container has been dropped), determining a temperature (e.g., inside or outside the container) that reaches a selected temperature, determining a time that reaches a specific time, determining that a location has been reached or that a selected distance within the location has been reached (e.g., either approaching or leaving the location), determining that a selected subset of actuatable cushioning elements (e.g., some or all of the elements) have not yet been expanded (thus more elements should be expanded to provide support), or other event. These are merely a few examples of events, e.g., events which may cause or result in one or more actuatable cushioning elements to be actuated.

Referring to FIG. 1 again, in an example embodiment, system 100 may include central control logic 150, including a central controller 154 which may provide overall control for system 100. Central control logic 150 may include a number of additional blocks coupled to central controller 154, which will be briefly described.

A wireless transceiver 152 may transmit and receive wireless signals such as RF (radio frequency) signals. Wireless signals such as RF signals may include any wireless or other electromagnetic signals, and are not limited to any particular frequency range.

An event detector 158 may detect or determine an event (or condition), or a series of events, such as an acceleration or change in acceleration that exceeds a threshold, a temperature that reaches a specific temperature, a location that is within a specific distance of a selected location, or any other event. Event detector 158 may include any type of detector or sensor. Event detector 158 may, for example, include any well-known detector, instrument or device to detect an event or condition. For example, a thermometer may detect a temperature. A GPS (Global Positioning System) receiver may determine that a specific location has been reached. An accelerometer may determine that an acceleration or change in acceleration has exceeded a threshold. In another example embodiment, event detector 158 may include a Micro Electro Mechanical System (MEMS) accelerometer, which may, for instance, sense a displacement of a micro-cantilevered beam under acceleration transverse to its displacement-direction, e.g., by capacitive means. An angular accelerometer may determine that an angular acceleration or change in angular acceleration has exceeded a threshold. In another example embodiment, event detector 158 may include a Ring Laser Gyro, a Fiber Optic Gyro, a Vibrating Structure Gyro, a MEMS Gyro, or a mechanical gyroscope.

Or, alternatively for event detector 158, electrodes may be placed on a suitably shaped and mounted piezoelectric material for sensing a current and/or voltage generated by the piezoelectric material deforming in response to acceleration induced stress. Some examples of materials that may be used in the piezoelectric version of the event detector 158 may include lead zirconate titanate (PZT), lead zincate niobate (PZN), lead zincate niobate lead-titanate (PZN-PT), lead magnesium niobate lead-titanate (PMN-PT), lead lanthanum zirconate titanate (PLZT), Nb/Ta doped PLZT, and Barium zirconate titanate (BZT). These are just a few examples of event detectors.

Event detector 158 may also, for example, include a GPS receiver, a speedometer, an accelerometer, Radar, a camera, a Gyro, or any other sensor or device that may allow the detection of one or more of the following: a relative location of a first object with respect to a second object; a relative velocity of a first object with respect to a second object; a relative acceleration of a first object with respect to a second object; a relative orientation of a first object with respect to a second object; a relative angular velocity of a first object with respect to a second object; or a relative angular acceleration of a first object with respect to a second object. The first and second objects in this example may be any type of objects. For example, the detected event or information (e.g., relative location, velocity, acceleration, orientation, angular velocity, and/or angular acceleration) may indicate that a collision between a first object (such as a vehicle) and a second object (e.g., another vehicle, a tree, a railing . . . ) has occurred or is likely to occur.

An enable/disable switch 156 may be used to enable or disable system 100. For example, enable/disable switch 156 may be used to enable the one or more actuatable cushioning elements to be actuated, or may disable the one or more actuatable cushioning elements from being actuated, for example. System 100 may also include an input device 160, such as a mouse, keypad or other input device, which may allow a user to configure operation of system 100, for example. For example, enable/disable switch 156 and/or input device 160 may enable a first subset of actuatable cushioning elements to be actuatable during a first time period (or first time interval), and may enable a second subset of actuatable cushioning elements to be actuatable during a second time period (or second time interval), e.g., to provide cushioning support for an object over (or for) a series of events. The phrase “time period” may, for example, include any time interval, and is not necessarily cyclical or periodic, and may include random, non-periodic and/or non-cyclical time periods or time intervals, as examples.

An output device or display 161 may also be provided to display information. Input device 160 and display 161 may be provided in a position which may be reached or accessed by a user, such as on the outside of the container 110, for example.

One or more of the actuatable cushioning elements may include an element control logic to control overall operation and/or actuation of the element(s) to which the control logic is connected. For example, element control logic 115 may provide control to actuatable cushioning element 114, while element control logic 117 may control operation of actuatable cushioning element 116.

An element control logic may control a single actuatable cushioning element, or may control multiple cushioning elements, for example. The element control logic for one or more actuatable cushioning elements may communicate with other element control logic to provide a cushioning support for object 112 in a coordinated manner, for example. According to an example embodiment, this may include an element control logic transmitting a wireless signal(s) when the associated actuatable cushioning element has been actuated (or otherwise an element control logic for an element transmitting a signal notifying other elements of the cushioning element's state) which may allow the element control logic associated with other actuatable cushioning elements to determine how many or what percentage of cushioning elements are in an expanded state. For example, if an insufficient number of cushioning elements are currently in an expanded state, then one or more actuatable cushioning elements (via their element control logic) may then actuate or move to an expanded state to improve cushioning support for the object. Thus, distributed control may be provided via communication between the element control logic for different actuatable cushioning elements.

In another example embodiment, central controller 154 (FIG. 1) of central control logic 150 may provide central control for operation of the one or more actuatable cushioning elements within container 110. For example, event detector 158 may detect an event, and then wireless transceiver 152 (e.g., under control of central controller 154) may transmit wireless signals to one or more element control logic (e.g., 115, 117, . . . ) to cause one or more actuatable cushioning elements to actuate in response to the event.

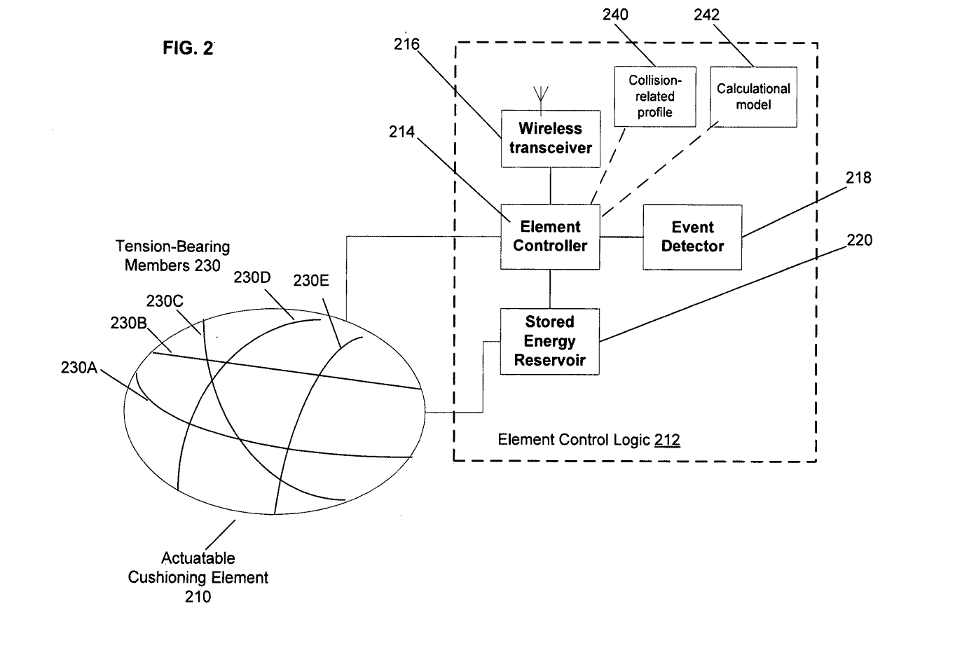

FIG. 2 illustrates an actuatable cushioning element according to an example embodiment. An actuatable cushioning element 210 may be coupled to (or may include) an associated element control logic 212. Although not shown, one or more of the actuatable cushioning elements (e.g., actuatable cushioning elements 114, 116, 118, 120, 122, 124, . . . ) may each include a similar element control logic. For example, element control logic 115 and 117 may be the same as or similar to element control logic 212, for example. In an alternative embodiment, element control logic 212 may be omitted.

Element control logic 212 may include an element controller 214 to provide overall control for an actuatable cushioning element 210. An event detector 218 may detect or determine an event. Event detector 218 may be, for example, the same as or similar to the event detector 158. A wireless transceiver 216 may transmit and receive wireless signals. Alternatively, actuatable cushioning elements may be coupled together (and/or to central control logic 150) via any communications media, such as a wireless media (e.g., via RF or other electromagnetic signals, acoustic signals), a wired communication media, such as cable, wire, fiber optic line, etc., or other media.

A stored energy reservoir 220 may store gas, liquid, energy (chemical or electrical energy or the like) or other energy or substance, which may be used to actuate actuatable cushioning element 210. For example, stored energy reservoir 220 may receive signals from element controller 214, causing stored energy reservoir 220 to release pressurized liquid or gas to actuatable cushioning element 210 to cause element 210 to expand or inflate, or may release a chemical or other substance causing an expandable cushioning material to expand, for example. In an example embodiment, actuatable cushioning element 210 may include one or more fluid-actuatable elements, where fluid may be sourced from one or more fluid reservoirs (such as from stored energy reservoir 220), e.g., via a valving actuation. The fluid reservoirs may, for example, cause the fluid actuatable element(s) to actuate (e.g., expand and/or unexpand/contract) by causing fluid to flow into or out of the fluid-actuatable elements.

One or more actuatable cushioning elements, such as actuatable cushioning element 210, may be coupled to an element controller (e.g., element controller 214) via any communications media, such as a wireless media (e.g., via RF or other electromagnetic signals, acoustic signals), a wired communication media, such as cable, wire, fiber optic line, etc., or other communications media.

According to an example embodiment, one or more actuatable cushioning elements may include fluid-actuated cushioning elements or structures, or may include gas-actuated or gas-powered cushioning elements, or other types of elements. For example, one or more of the actuatable cushioning elements, when actuated, may have at least one of a size, shape, position, orientation, stress-strain tensor components (or other component) of the cushioning elements changed or modified as a result of one or more actuating actions applied to the cushioning element. For example, an actuating action or sequence of actuating actions which may be applied to an actuatable cushioning element, may, e.g., first change its position (or center of mass), then its orientation, then its size, and/or its rigidity or other characteristic. These changes to the actuatable cushioning element may occur, e.g., in a pre-programmed manner, and may occur, e.g., in response to or based upon an event, such as based on a measurement, signals received from cooperating cushioning elements or a controller(s) in the system 100, or other signals or criteria or event. The signals that may be received from other cooperating structures (e.g., elements or controllers) may, for example, describe or indicate their own characteristics, such as size, pressure, orientation, shape, etc. A model (e.g., of the system or operation of the system or objects) may be used to determine one or more actions that may be performed (such as actuation of an element), e.g., to protect one or more objects or passengers from harm or damage.

Also, in another example embodiment, one or more objects or passengers may include one or more associated actuatable cushioning elements on or near each object or passenger, where one or more of the group of associated actuatable cushioning elements may be independently controlled so as to provide cushioning support and/or protection for the associated object or passenger. Also, in another example embodiment, two or more separate objects, each protected by their own sets of actuatable cushioning elements may interact (for instance, by an actual or predicted collision). The actuation of one or more object's actuatable cushioning elements may occur with or without cooperation from that of the actuatable cushioning elements of one or more of the other objects. For example, one or more of the objects may sense the actions or state of the actuatable cushioning elements associated with one or more of the other objects. For example, two or more of the objects may share information on the actual and/or planned actuation histories of their actuatable cushioning elements. For example, one or more of the objects may sense the actions or state of the actuatable cushioning elements associated with one or more of the other objects. For example, one or more objects may base the actuation of one or more of its actuatable cushioning elements upon the sensed or predicted actions of one or more actuatable cushioning elements associated with one or more of the other objects. For example, one or more objects may command the actuation or nonactuation of one or more actuatable cushioning elements associated with one or more of the other objects. This commanded actuation process may be performed by a joint decision process, by a hierarchical process, by a master-slave process, or by other means.

In an example embodiment, the actuatable cushioning element may include one or more tension-bearing members 230, such as tension bearing members 230A, 230B, 230C, 230D and 230E. Tension-bearing members 230 may, for example, bear tension or force, and may deform in one or more ways, and/or may stretch, e.g., during a collision or impact to dissipate energy associated with a collision and/or provide cushioning support for an object. The tension-bearing members 230 may be provided in a number of different directions, and may, for example, lie on a surface (e.g., interior or exterior surface) of the cushioning element 210. Alternatively, one or more of the tension-bearing members 230 may be provided within an interior portion of the cushioning element 210.

In an example embodiment, one or more of the tension-bearing members 230 may deform during a collision between two objects. This deformation of one or more of the tension-bearing members 230 may include, for example, stretching of the tension-bearing member(s). The deforming or stretching, may include, for example, at least a portion of one or more tension-bearing members substantially inelastically stretching after the tension-bearing member has reached an elastic limit.

In an example embodiment, the actuatable cushioning element 210 may dissipate at least some of an energy (e.g., kinetic energy) associated with a collision based on a deforming or stretching of one or more of the tension-bearing members 230. For example, during a collision, at least one tension-bearing member that extends in a direction other than a direction of impact of the collision may stretch beyond an elastic limit, and dissipate at least some of an energy associated with the collision. For example, a tension-bearing member that extends in a direction that is substantially perpendicular to a direction of impact of the collision may stretch or deform during the collision to dissipate energy or provide cushioning support for an object.

By stretching or deforming, the tension-bearing members 230 may perform work or have work performed on them, allowing the dissipation of at least some energy associated with a collision. In this manner, the cushioning element 210 and associated tension-bearing member(s) 230 may, for example, provide cushioning support during a collision for an object or objects, such as a vehicle, person, or other object.

The tension-bearing members may be made of a variety of different materials, and may, for example, have a relatively high tensile strength and/or a high strength to weight ratio. In an example embodiment, tension-bearing members may be provided as one or more polyaramid fibers (also known as aramid or aromatic polyamide fibers). Polyaramid fibers may be a class of heat-resistant and high-strength synthetic fibers, such as for example, fibers in which the fiber-forming substance may be a long-chain synthetic polyamide in which at least some of the amide linkages (—CO—NH—) are attached directly to two aromatic rings. Polyaramid fibers have been manufactured under a number of different brand names, and have been used in a number of different aerospace and military applications, such as ballistic rated body armor, for example.

Polyaramid fiber(s) are merely one example of a tension-bearing member. Tension bearing members 230 may be made from other material (e.g., which may have relatively high tensile strength) that may perform work (or may allow work to be performed on the fiber or member), e.g., through stretching or deforming, or otherwise may provide cushioning or dissipation of energy associated with a collision or other impact. Yet more specific instances of such materials might include at least one of a graphitic fiber, a carbon fiber, and/or a natural fiber. Yet more specific instances of such material might also include at least one of a poly-benzobisoxazole fiber and/or a synthetic fiber. In some instances of such materials, the various fiber types referred to herein are hybridized and/or combined.

In an example embodiment, actuatable cushioning element 210 and element control logic 212 may provide cushioning support for an object, or may dissipate at least some energy associated with a collision. For example, cushioning element 210 may provide cushioning support for a vehicle, or otherwise dissipate at least some energy associated with a collision between the vehicle and another vehicle or object.

In an example embodiment, the element control logic 212 (FIG. 2) or central control logic 150 (FIG. 1) may also include a collision-related profile 240 and/or a calculational model 242. A collision-related profile 240 may include information related to an object or sub-object (e.g., object within the object), such as a maximum or preferred value for an object, e.g., without damaging or injuring the object. For example, the collision-related profile for an object (or sub-object) may include a maximum acceleration, stress, pressure, velocity, angular velocity temperature, etc. that may be applied to the object without damaging the object or its contents. The collision-related profile may also indicate other information related to the object, such as a preferred location (e.g., keep to the right side of the road, minimum of 2 feet from guard rail and a minimum of 3 feet from oncoming traffic or other objects), orientation (e.g., which side of the object should face forward, which side should preferably face down), or other preferences, limitations or other information related to an object or sub-object (an object provided within the object, such as a passenger, fragile cargo, etc.). A collision-related profile 240 related to an object may be useful, for example, in actuating or controlling an actuatable cushioning element 210 and/or tension-bearing member(s) 230 to provide cushioning support for the object or vehicle, control the object or vehicle during the collision, dissipate at least some of the energy associated with the collision, or perform other action or adjustment, e.g., while not exceeding one or more maximum or preferred values for the object as indicated by the collision-related profile 240.

In another example, a collision-related profile 240 for a specific vehicle may indicate that a maximum sustained force of 3 G may be applied to the vehicle three seconds or less, and a lesser force of, for example, 1 G may be applied to the vehicle up to 60 seconds, e.g., without causing significant damage to the vehicle. The collision-related profile 240 may also indicate that a maximum force of 8 G may be applied to the vehicle over a very short period of time, e.g., one-half second (500 ms) or less. In another example embodiment, the collision-related profile 240 may indicate that a stress on a specific component should not exceed a specified maximum amount (e.g., stress or force on the frame of an automobile should not exceed 900 PSI). These are merely some examples of what a collision-related profile may include, and the disclosure is not limited thereto.

In an example embodiment, the various limitations or preferences, etc. within the collision-related profile 240 may be used by a controller 214 or 154 to determine, e.g., how, when, where to actuate a cushioning element 210, to select or determine one or more adjustments or changes to a cushioning element 210 and/or to select or determine one or more adjustments or changes one or more tension-bearing members 230. For example, the collision-related profile 240 for a vehicle may be used to increase or decrease an amount of fluid (gas or liquid) within a cushioning element, or to adjust a length of one or more tension-bearing members, so as to sufficiently dissipate at least some of the energy associated with a collision and/or to bring the vehicle to rest, while not exceeding one or more of the limitations or preferences for the vehicle indicated by the collision-related profile 240 (e.g., while not apply a sustained force to the vehicle greater than 3 G for more than 3 seconds).

For example, event detector 218 (e.g., accelerometer provided on a vehicle) may measure the acceleration applied to the vehicle, which may be monitored by the controller 214 or 154. The controller 154/214 may receive periodic updates from event detector 218 as to the acceleration (or other measurement) applied to the vehicle, such as before a collision, and at various points during a collision (while the vehicle is colliding with another object). Based in part on these acceleration measurements (and possibly other information, such as a calculational model 242), the controller 154 or 214 may then adjust one or more properties of the vehicle, such as adjusting one or more properties of an actuatable cushioning element(s) and/or adjust one or more properties of a tension-bearing member(s) 230, so as to, e.g., dissipate at least some of the energy associated with the collision and/or bring the vehicle to rest without exceeding one or more limitations or preferences of the collision-related profile 240 for the vehicle. Further details and examples are provided herein.

A calculational model 242 may provide a model of how one or more objects may operate, respond, move or change under various conditions related to a collision or in response to an actuation or control of an actuatable cushioning element and/or tension-bearing member(s) 230, or from other conditions or stimulus, for example. In an example embodiment, although not required, the calculational model 242 may include one or more (or even all) of the aspects or information of the collision-related profile 240.

According to an example embodiment, acceleration may include a scalar quantity, or may include a vector quantity. Acceleration may include linear acceleration, angular acceleration, or other type of acceleration. A detected or determined acceleration may include an acceleration having components with varying degrees of interest or relevance (e.g., one or more linear components may be used, or one or more angular components to indicate an event or events to trigger actuation of an actuatable cushioning element). For example, an event may include an acceleration or change in acceleration that may include an acceleration (e.g., one or more acceleration components) or a change in acceleration that may exceed a threshold. Alternatively, the acceleration may be determined in more complex manners, such as ad hoc, time and situation-dependent manners, or other manners. For example, the calculational model 242 may be provided or used to model the operation of a system (e.g., system 100), or model the operation of actuatable cushioning elements, or model the free-fall or acceleration or movement of one or more objects or passengers, or the like. For example, one or more actuatable cushioning elements may be actuated (e.g., expanded or unexpanded/contracted) based on the model and/or based on determination of one or more events. For example, the selected actuation of one or more actuatable cushioning elements may be based upon the predicted shift of the time profile of one or more accelerations from a value associated with one actuation state to another value corresponding to the selected actuation state, the value of which is predicted to reduce damage to one or more protected objects. For example, measured and model-forecasted time-integrals of acceleration that may exceed case dependent thresholds may be used, e.g., to identify criteria or likely situations where objects may be damaged or broken (e.g., which may be provided in a collision-related profile 240). In another example embodiment, a time-history of acceleration may, in some cases, inform the system 100 as to the level of protection that may or should be used to protect the object. For example, an extended time-interval of free-fall may result in decelerations of significant magnitudes being purposefully applied to protect objects when, e.g., an event is detected. For example, measured or model-forecasted stresses within the object may be used, e.g., to identify criteria or likely situations where objects may be damaged or broken. Such stress thresholds may include peak values or time-dependent value profiles of a function of one or more elements of the stress tensor, or may include initiation or propagation of fracture. For example, measured or model-forecasted temperatures within the object may be used, e.g., to identify criteria or likely situations where objects may be damaged or broken. Such temperature thresholds may include peak temperature values, or energy deposition values (e.g., a substance that will undergo a phase change—e.g., liquid to gas—after accumulation of a certain energy, which those skilled in the art will appreciate is an example of a more general determination that an energy exceeds a threshold), or time dependent temperature profiles. These are merely a few additional example embodiments relating to acceleration, and the disclosure is not limited thereto.

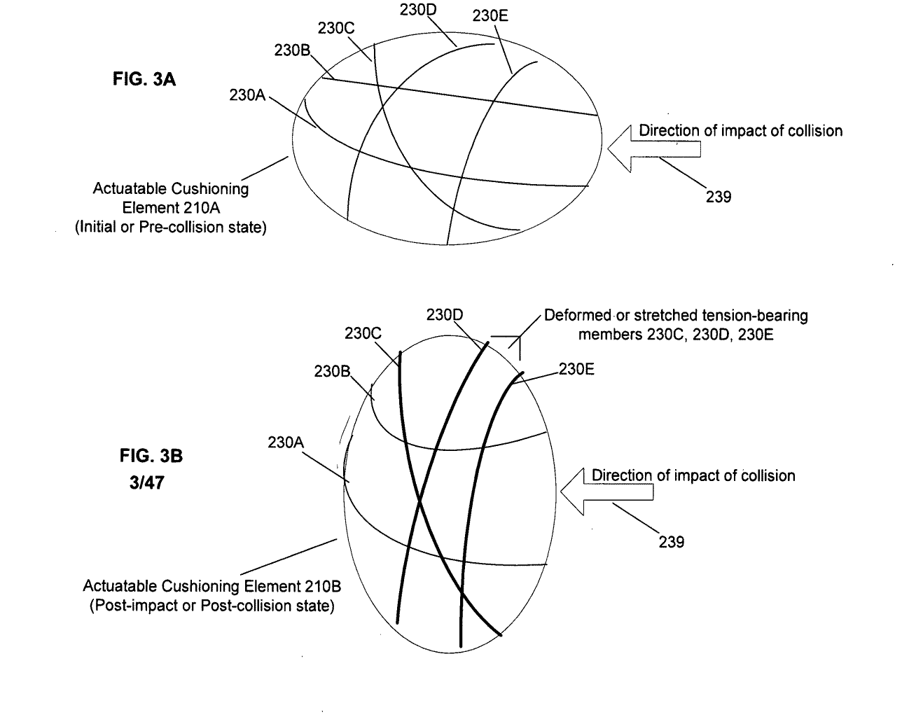

FIG. 3A illustrates an actuatable cushioning element according to another example embodiment. Actuatable cushioning element 210A is shown in an initial or pre-collision state. Actuatable cushioning element 210A may include one or more tension-bearing members, including tension-bearing members 230A, 230B, 230C, 230D and/or 230E. In an example embodiment, a controller, such as central controller 154 or element controller 214 may control or cause the actuation of the actuatable cushioning element into an initial or pre-collision state (e.g., in response to detecting or determining an event). A direction of impact 239 of a collision is shown. Tension-bearing members 230A and 230B, at least in part, may be considered to extend in a direction that may be substantially in a direction of the impact of collision 239. Other tension-bearing members may extend in other directions. For example, tension-bearing members 230C, 230D and 230E may be considered to extend in directions other than the direction of impact of the collision 239. For example, one or more tension-bearing members, such as tension-bearing member 230E, may extend in a direction that may be approximately (or substantially) perpendicular to the direction of impact of the collision 239.

FIG. 3B illustrates an actuatable cushioning element of FIG. 3A in a post-collision state according to an example embodiment. In an example embodiment, during a collision between two objects, the actuatable cushioning element 210 may provide cushioning support for an object (not shown) or dissipate energy associated with the collision via a deforming or stretching of one or more of the tension-bearing members. For example, tension-bearing members 230C, 230D and 230E may deform or stretch during a collision and dissipate energy associated with a collision.

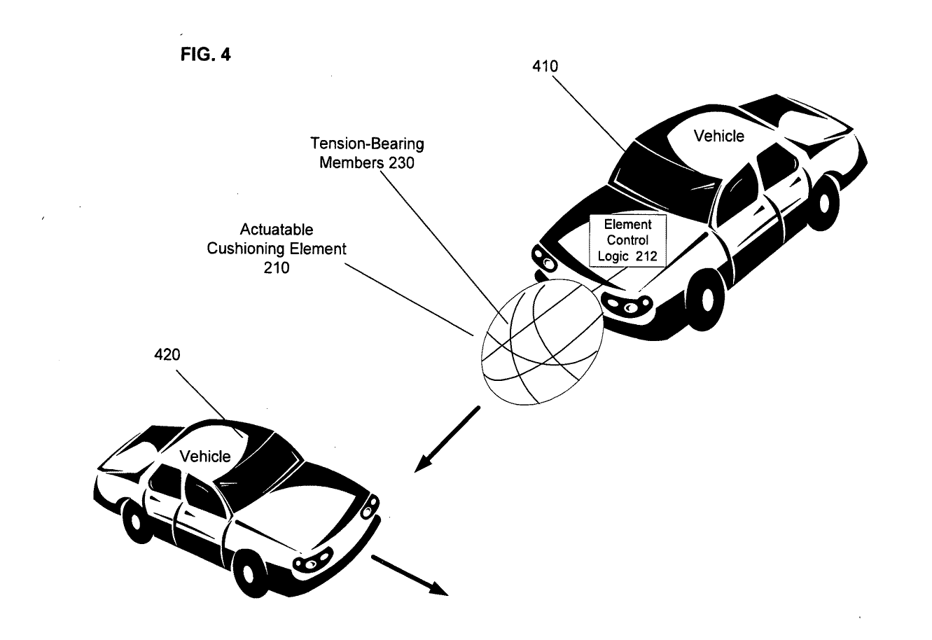

FIG. 4 is a diagram illustrating an operation of an actuatable energy dissipative cushioning element according to an example embodiment. Two objects are shown in FIG. 4, including vehicle 410 and vehicle 420, although any type of objects may be used. Vehicle 410 may include an actuatable cushioning element 210 that includes one or more tension-bearing members 230. An element control logic 212 may be coupled to the actuatable cushioning element. Event detector 218 of element control logic 212 (FIG. 2) may determine or detect an event, and element controller or central controller 154 may actuate and/or otherwise control actuatable cushioning element 210 and/or tension-bearing members 230 to dissipate energy associated with a collision between vehicle 410 and vehicle 420. Event detector 218 and/or element control logic 212 may detect or determine a number of different events, and may then actuate or deploy the actuatable cushioning element 210. Actuatable cushioning element 210 is shown as being provided outside of vehicle 410, but may be located anywhere, such as inside a cabin or driver's space of vehicle 410, for example.

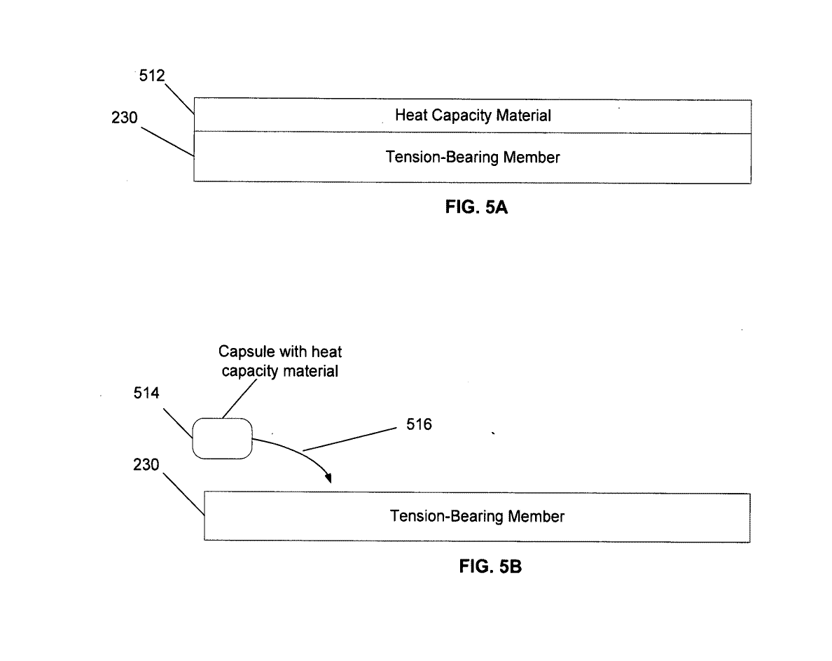

FIG. 5A is a diagram illustrating a tension-bearing member according to an example embodiment. In an example embodiment, a tension-bearing member 230 may stretch or deform during a collision to dissipate some of the kinetic energy associated with a collision. This may be performed by, for example, at least in part converting some of the kinetic energy associated with the collision into thermal energy. In an example embodiment, tension-bearing member 230 may include a heat capacity material 512 associated with the tension-bearing member 230 to absorb at least some of the thermal energy associated with the collision, or to increase a capacity of the tension-bearing member 230 to perform work or to increase a capacity to have work done on the tension-bearing member 230.

For example, the heat capacity material may increase the temperature at which the tension-bearing member fails or breaks, thereby, at least in some cases increasing the capacity of the tension-bearing member 230 to perform work or stretch during a collision. This may, for example, increase an amount of kinetic energy that the actuatable cushioning element may dissipate during a collision between two objects.

Although not required, in an example embodiment, heat capacity material 512 may use (or may include) a phase-change material that may change phases (e.g., solid-to-liquid, liquid-to-gas, solid-to-gas) while the tension-bearing member is performing work or is stretching or deforming, which may, for example, increase the amount of kinetic energy that the cushioning element may dissipate. This may include, for example, a liquid or other heat capacity material boiling or changing from liquid to gas to dissipate additional energy associated with the collision. For example, water may be used to cool or decrease the temperature of the tension-bearing member during a collision. Thus, using a tension-bearing member having a heat capacity material may increase the temperature at which the tension-bearing member may fail or no longer be able to perform work. Thus, heat capacity material or phase change material may be used to increase or enhance mechanical performance of the tension bearing member 230, for example.

In one example embodiment, if phase change is used, the phase change of the heat capacity material may, for example, occur at temperatures that may be well above ordinary environmental temperatures, e.g., greater than 50 degrees Centigrade (50° C.), and may be (for example) less than 300° C. or 400° C. These are merely some examples, and a number of different temperatures may be used for phase change.

The heat capacity material 512 may, for example, be provided on a surface of the tension bearing member 230, or may be provided within one or more fibers of the tension-bearing member. These are merely some examples.

FIG. 5B is a diagram illustrating a tension-bearing member according to another example embodiment. In this example, a capsule 514 may be provided with heat capacity material therein. For example, when the temperature a threshold temperature, the capsule 514 may melt or rupture, causing the heat capacity material to be released and applied to the tension-bearing member 230. The application of heat capacity material (for example, water or other material) may operate to cool the tension-bearing member 230 and/or increase the work capacity of the tension-bearing member 230.

A wide variety of materials may be used for a heat capacity material 512, or a phase change material. According to an example embodiment, heat capacity materials may, include one or more qualities, such as:
a. non-toxic (as people or objects may come into contact with the material);
b. non-corrosive to its storage environment (e.g., since the material may be in contact with the tension-bearing member or the actuatable cushioning element 210); for example, during storage, the material may be non-corrosive for long periods of time, and during operation or at higher temperatures the material may be non-corrosive for shorter periods of time.
c. a comparatively high heat of transformation (e.g., relatively high temperature for boiling or vaporization, fusion), e.g., so that relatively little material may be used to increase the work capacity of the tension bearing member
d. can be readily brought into contact (either in advance or in response to an event, or based on a temperature change, etc.) with high-tensility material (tension-bearing member 230) being worked or deformed during a collision;
e. reasonable cost, e.g., sufficient quantities of the heat capacity material would not necessarily dominate the cost of the cushioning element or tension bearing member.

An example of a heat capacity material may be water, although many other materials may be used. The tension-bearing member (e.g., polyaramid fibers) may be soaked in water (or other material), which may increase the amount of work that the tension bearing member may perform, for example. Or, the water, as it is heated and boils or vaporizes, increases the work that may be performed on or by the associated tension-bearing member. As noted, the heat capacity material may use phase change in an example embodiments. In other example embodiments, heat capacity materials may be used that may improve the work capacity of the tension bearing member without necessarily involving a phase change or phase change material.

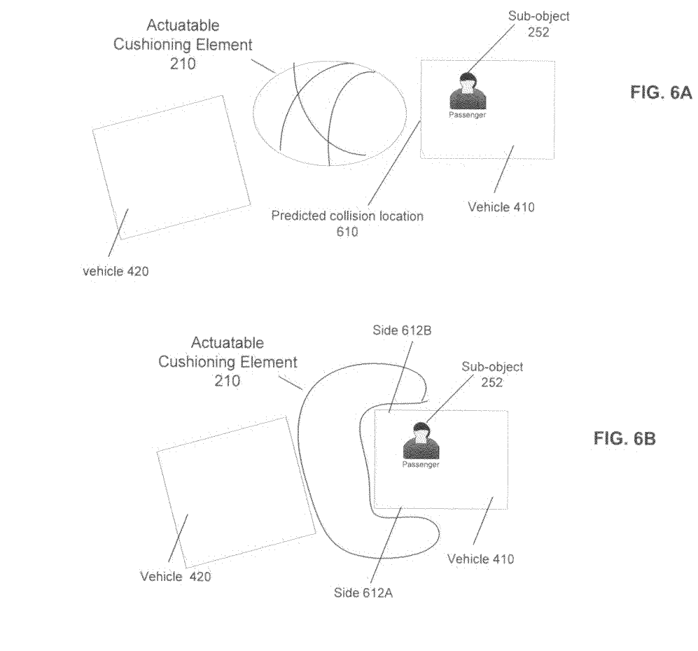

FIGS. 6A and 6B are diagrams illustrating an operation of an actuatable energy dissipative cushioning element according to another example embodiment. FIG. 6A illustrates a pre-collision (or initial) state, while FIG. 6B illustrates a post-collision state.

Referring to FIG. 6A, two vehicles are shown, including vehicle 410 and vehicle 420. Vehicles 410 and 420 may be any type of vehicle (e.g., automobile, aircraft, train, boat, or other object). In this example, vehicle 410 may be moving in a generally forward direction (towards vehicle 420, for example), and vehicle 420 may be moving or stationary at the time of a collision with vehicle 410. Vehicle 410 may include a sub-object 252 therein, such as valuable cargo, a passenger, or other sub-object. In this example, vehicle 410 may be moving or traveling in a forward direction (e.g., right to left shown on FIG. 6A), towards vehicle 420. While FIG. 6 shows 410 and 420 as vehicles (as an example), 410 and 420 may be any type of object.

In an example embodiment, an event detector 158 or 218 provided in vehicle 410 may detect a pre-collision event (e.g., determine based on relative location, relative velocity and/or relative acceleration of vehicles 410 and 420 that a collision between vehicles 410 and 420 will occur or is likely to occur). In response to determining the pre-collision event, a controller 154 and/or 214 for vehicle 410 may actuate a cushioning element 210, which may include expanding the cushioning element 210 to place one or more tension-bearing members 230 of cushioning element 210 in an initial (or pre-collision) state. The actuation may include, for example, determining, prior to the collision, a location or distance to place the cushioning element 210 based on a relative velocity and relative location of vehicle 410 with respect to vehicle 420, and then expanding the cushioning element 210 to place the cushioning element 210 at the determined distance or location from (or with respect to) vehicle 410.

In another example embodiment, referring to FIG. 6A, a controller 154 (FIG. 1) or 214 (FIG. 2) of vehicle 410 may determine a predicted collision location 610 (e.g., a primary point of impact on vehicle 410 for the expected collision between vehicles 410 and 420) for vehicle 410. For example, controller 154 or 214 of vehicle 410 may determine a predicted collision location for vehicle 410 based on data from one or more event detectors 158, 218 or sensors on vehicle 410 or event detector(s) or sensor(s) on vehicle 420 (e.g., where such information may be communicated via wireless link from vehicle 420 to vehicle 410), and/or based on a calculational model 242 for object(s) 410 and/or 420 and/or a collision-related profile 242 for object(s) 410 and/or 420 and/or a collision-related profile 240 or calculational model 242 or for sub-object 252), or other information.

In another example embodiment, determining a pre-collision event may include a controller 154 or 214 of vehicle 410 predicting, based on a calculational model 242of vehicle 410, one or more outcomes of the collision between vehicles 410 and 420. Predicting an outcome of the collision may include, for example, predicting a collision location 610, force of impact, and the response of one or more components of vehicle 410 to the predicted collision between vehicles 410 and 420. Predicting one or more outcomes of the expected collision between vehicles 410 and 420 may, for example, be based in part upon an anticipated actuation of one or more cushioning elements 210, for vehicle 410 and/or vehicle 420. The cushioning elements may be external cushioning elements (external to vehicle 410, 420, and/or may be an internal cushioning element (internal or inside vehicle 410 and/or 420).

In an example embodiment, in response to determining a pre-collision event, controller 154 or 214 of vehicle 410 may actuate a cushioning element 210 (and associated tension-bearing members 230) at or near the predicted collision location 610 prior to the collision between vehicles 410 and 420, as shown in FIG. 6A. Referring to FIG. 6B, during the collision between vehicles 410 and 420, at least a portion of cushioning element 210 may extend around at least a portion of one or more sides (such as sides 612A, 612B) of vehicle 410 that are proximate to the predicted collision location 610. For example, one or more adjustments may be made, such as before or during the collision, to the cushioning element and/or associated tension-bearing members for vehicle 410, which may allow or facilitate at least a portion of the cushioning element 210 to extend around at least a portion of one or both sides 612A, 612B of vehicle 410, as shown in FIG. 6B. When the cushioning element 210 extends around at least a portion of one or both sides 612A and 612B, this may create a glove or catcher's mitt, so to speak, which may provide support for vehicle 410 on multiple sides, e.g., three sides in this example, including support in the front of vehicle 410 and on both sides 612A and 612B. This three-sided support may provide cushioning support in the front at the predicted collision location 610, and may also inhibit movement of vehicle 410 during the collision based on the portion of the cushioning element extending around sides 612A and 612B, for example. For example, the support on sides 612A and 612B may inhibit, at least in some cases, movement of vehicle 410 from side-to-side, and thus may improve the performance of the cushioning element 210 and/or improve the safety or operation of vehicle 410 during the collision, e.g., by decreasing the likelihood the vehicle 410 may skid to the side, roll over, etc., or be placed in some other orientation that may be dangerous or violate the collision-related profile for vehicle 410. For example, the collision-related profile 240 may specify that vehicle 410 should not roll over, or has no roll cage.

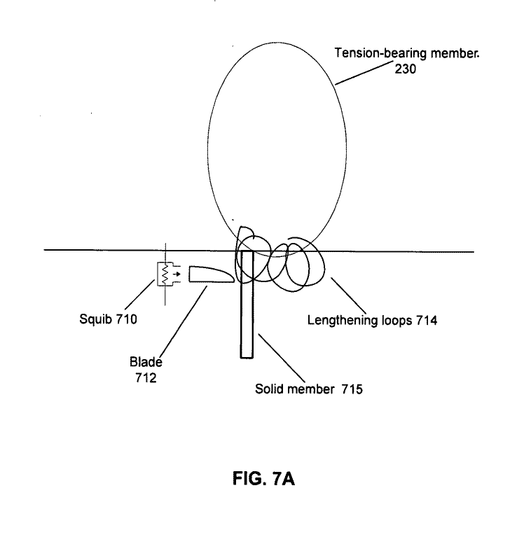

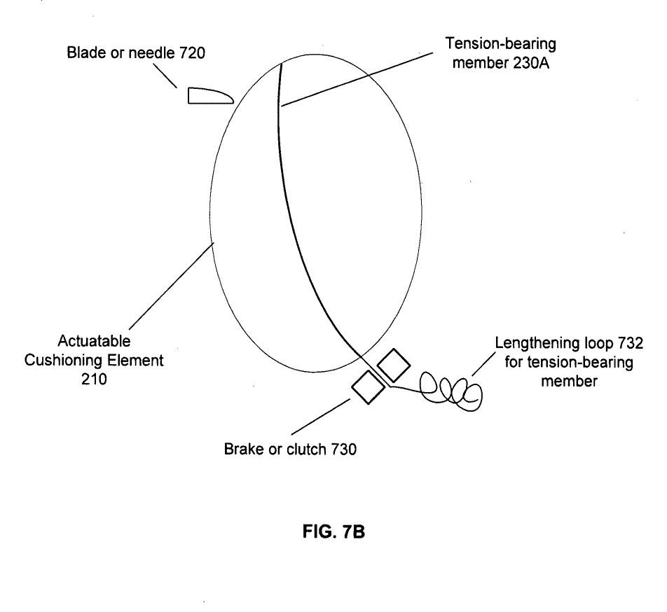

FIGS. 7A and 7B are diagrams illustrating one or more properties of a cushioning element and/or tension-bearing members that may be adjusted according to example embodiments. Referring to FIG. 7A, an example tension-bearing member 230 may include lengthening loops 714. Each of the lengthening loops 714 may be cut to increase the length of tension-bearing member. By increasing or decreasing the length of tension-bearing member, the operation of the cushioning element may change or be adjusted, for example. In an example embodiment, as shown in FIG. 7A, a squib 710 (or small explosive device) may be activated or exploded, which may propel a blade 712. The moving blade 712 may cut one of the lengthening loops against a solid member 715.

In FIG. 7B, a blade or needle 720 may puncture a fluid occupied portion of cushioning element 210. The fluid within cushioning element 210 may be liquid or gas, for example. By puncturing a portion of cushioning element 210, this may adjust (e.g., decrease) a pressure or amount of fluid in at least a portion of the cushioning element 210.

Also, in FIG. 7B, a lengthening loop 732 may be connected to a tension-bearing member 230A. In an example embodiment, a brake or clutch 730 may grip and release tension-bearing member 230A/lengthening loop 732, under control of a controller 154 or 214, to increase or decrease a length of tension-bearing member 230A. For example, the brake or clutch 730 may release its grip on tension-bearing member 230A and lengthening loop 732. When brake or clutch 730 releases its grip on tension-bearing member 230A and loop 732, this may allow a portion of loop 732 to be pulled through the brake or clutch 730, increasing the length of tension-bearing member 230A.

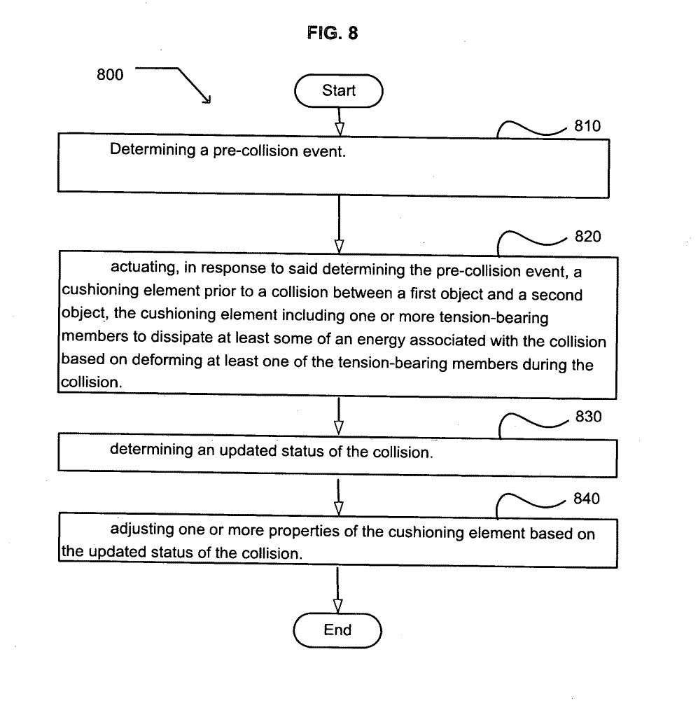

FIG. 8 illustrates an operational flow 800 representing example operations related to an energy dissipative cushioning system. In FIG. 8 and in following figures that include various examples of operational flows, discussion and explanation may be provided with respect to the above-described examples of FIGS. 1-7B, and/or with respect to other examples and contexts. However, it should be understood that the operational flows may be executed in a number of other environments and contexts, and/or in modified versions of FIGS. 1-7B. Also, although the various operational flows are presented in the sequence(s) illustrated, it should be understood that the various operations may be performed in other orders than those which are illustrated, or may be performed concurrently.

After a start operation, the operational flow 800 moves to a determining operation 810 where a pre-collision event is determined. For example, an event detector 158 or 218 may detect or determine an event (or condition), or a series of events, such as a velocity that exceeds a threshold, an acceleration that exceeds a threshold, a change in acceleration or change in location or velocity, a relative location, velocity or acceleration of an object with respect to another object that is within a range or exceeds a threshold, etc. In an example embodiment, an event detector 158 or 218 provided in vehicle 410 may detect a pre-collision event (e.g., determine based on relative location, relative velocity and/or relative acceleration of objects (or vehicles) 410 and 420, that a collision between objects (or vehicles) 410 and 420 is likely to occur). This determining may be performed by event detector 158/218 and also possibly with controller 154 or 214. Event detector 158 or 218 may include any type of detector or sensor. Event detector 158 may, for example, include any well-known detector, instrument or device to detect an event or condition, or location of objects, or velocity, acceleration or other measurement of objects. For example, a GPS (Global Positioning System) receiver or a Radar, in conjunction with a controller 154 or 214, may determine that vehicle 410 is 8.5 meters from a second vehicle 420. The controller 154 or 214 may determine the event based on a distance between vehicles 410 and 420 being less than 15, and a relative velocity between the vehicles 410 and 420 of more than 30 mile per hour, as an example. Other types of event detectors or sensors may be used, such as an accelerometer to determine that an acceleration or change in acceleration has exceeded a threshold, for example. In another example embodiment, event detector 158 may include a Micro Electro Mechanical System (MEMS) accelerometer. These are merely a few examples, and the disclosure is not limited thereto.

Event detector 158 and/or 218 may also, for example, include a speedometer, an accelerometer, Radar, a camera, a Gyro, or any other sensor, instrument or device that may allow the detection or determination of one or more of a variety of conditions or events, such as determining, for example: a relative location of a first object with respect to a second object; a relative velocity of a first object with respect to a second object; a relative acceleration of a first object with respect to a second object; a relative orientation of a first object with respect to a second object; a relative angular velocity of a first object with respect to a second object; or a relative angular acceleration of a first object with respect to a second object. These are merely some additional example events, and many other types of events may be detected or determined. The first and second objects in this example may be any type of objects.

Then, in an actuating operation 820, a cushioning element is actuated, in response to determining the pre-collision event, prior to a collision between a first object and a second object, the cushioning element including one or more tension-bearing members to dissipate at least some of an energy associated with the collision based on deforming at least one of the tension-bearing members during the collision. For example, as shown in FIG. 2, element controller 214 may actuate actuatable cushioning element 210 in response to event detector 218 determining the event. This actuating may include element controller 214 or central controller 154 deploying or placing the actuatable cushioning element 210 in an initial or pre-collision state, for example. Actuatable cushioning element 210 (FIG. 2) may include one or more tension-bearing members 230 (e.g., 230A, 230B, 230C, 230D, 230E, . . . ), which may dissipate at least some of an energy associated with the collision based on deforming at least one of the tension-bearing members during the collision.

Then, in a determining operation 830, an updated status of the collision is determined. For example, determining operation 830 may include controller 154 or 214 determining or measuring one or more parameters with respect to a first vehicle 410, the second vehicle 420 and/or the cushioning element 210. For example, controller 154 or 214 may determine the relative location of vehicle 410 to vehicle 420 during the collision, based on, e.g., GPS or Radar or other sensor data. Or in another example embodiment, controller 154 or 214 may determine that a passenger (or sub-object 252) within vehicle 410 has undergone an acceleration of 3 G; or that the vehicles 410 and 420 have collided, or obtained the relative location and orientation of the vehicles 410 and 420 after the initial collision, or the location of the cushioning element with respect to the first vehicle 410, etc.

Then, in an adjusting operation 840, one or more properties of the cushioning element are adjusted based on the updated status of the collision. For example, a controller 154 or 214 may adjust a pressure or amount of a fluid (e.g., either gas or liquid) in at least a portion of the cushioning element 210. The pressure of the fluid in the cushioning element may be adjusted to decrease or control an acceleration that is being applied to vehicle 410 and/or sub-object 252, as an example.

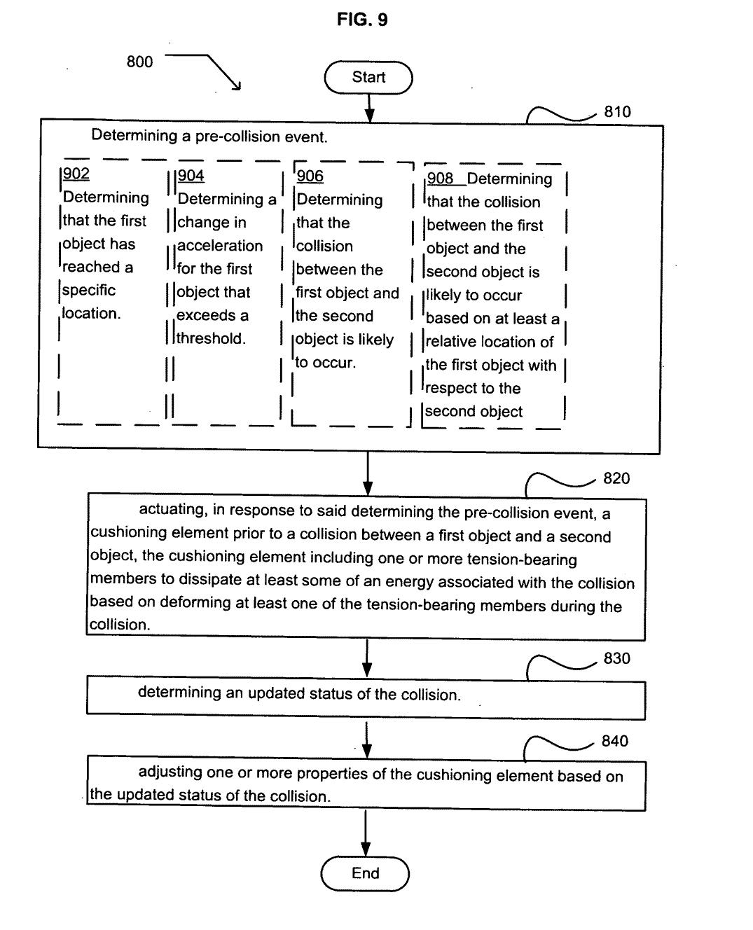

FIG. 9 illustrates alternative embodiments of the example operational flow 800 of FIG. 8. FIG. 9 illustrates example embodiments where the determining operation 810 may include at least one additional operation. Additional operations may include operations 902, 904, 906 and/or 908.

At the operation 902, it is determined that the first object has reached a specific location. For example, controller 154 or 214, based on signals from a GPS receiver, may determine that vehicle 410 is 3 feet from a guard rail, or that an airplane has reached a specific altitude (e.g., based on signals from an altimeter)

At the operation 904, it is determined that a change in acceleration for the first object exceeds a threshold. For example, an accelerometer may detect that vehicle 410 has exceeded 3 G of acceleration.

At the operation 906, it is determined that the collision between the first object and second object is likely to occur. For example, based on one or more speedometer (or velocity) readings and GPS readings for vehicle 410, and location information for vehicle 420 (e.g., based on a camera, Radar, or known location), controller 154 or 214 may determine that a collision between vehicle 410 and vehicle 420 is likely to occur.

At the operation 908, it is determined that the collision between the first object and the second object is likely to occur based on at least a relative location of the first object with respect to the second object. For example, controller 154 or 214 may determine (e.g., based on location information obtained from a camera, Radar, GPS receiver or other sensor or detector) that a collision is likely to occur between vehicles 410 and 420, based on a relative location of vehicle 410 with respect to vehicle 420.

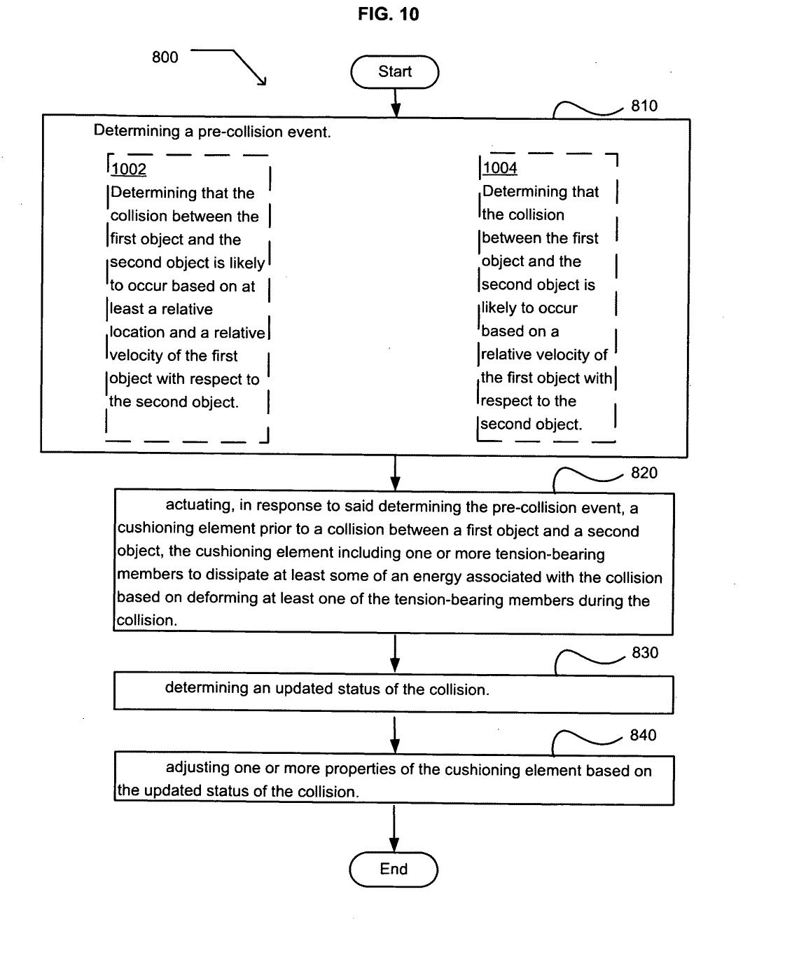

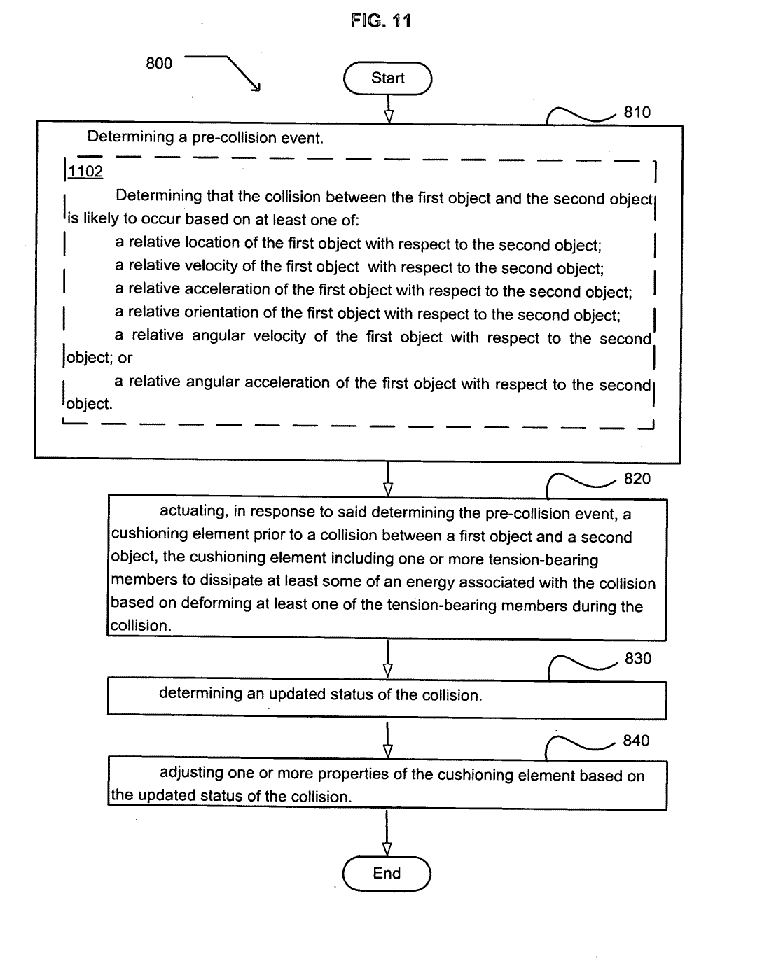

FIG. 10 illustrates alternative embodiments of the example operational flow 800 of FIG. 8. FIG. 10 illustrates example embodiments where the determining operation 810 may include at least one additional operation. Additional operations may include operations 1002 and/or 1004.

At the operation 1002, it is determined that the collision between the first object and the second object is likely to occur based on at least a relative location and a relative velocity of the first object with respect to the second object. For example, controller 154 or 214 on vehicle 410 may, based on velocity and location information received from one or more event detectors 158 or 218, determine that a collision between vehicles 410 and 420 is likely to occur based on at least a relative location and a relative velocity of vehicle 410 with respect to vehicle 420.

At the operation 1004, it is determined that the collision between the first object and the second object is likely to occur based on a relative velocity of the first object with respect to the second object. For example, controller 154 or 214 for vehicle 410 may, based on location information received from one or more event detectors 158 or 218 (e.g., speedometer and/or GPS receiver or other sensor), determine that a collision between vehicles 410 and 420 is likely to occur based on at least a relative velocity of vehicle 410 with respect to vehicle 420.

FIG. 11 illustrates alternative embodiments of the example operational flow 800 of FIG. 8. FIG. 11 illustrates example embodiments where the determining operation 810 may include at least one additional operation. Additional operations may include operation 1102.

At the operation 1102, it is determined that the collision between the first object and the second object is likely to occur based on at least one of: a relative location of the first object with respect to the second object; a relative velocity of the first object with respect to the second object; a relative acceleration of the first object with respect to the second object; a relative orientation of the first object with respect to the second object; a relative angular velocity of the first object with respect to the second object; or a relative angular acceleration of the first object with respect to the second object. For example, controller 154 or 214 on vehicle 410, based on measurement(s) or signal(s) from event detector 158 or 218 (e.g., speedometer and/or GPS receiver or other sensor) may determine that a collision is likely to occur based on one or more of a relative location, a relative velocity, a relative acceleration, a relative orientation, a relative angular velocity, or a relative angular acceleration of vehicle 410 with respect to vehicle 420.

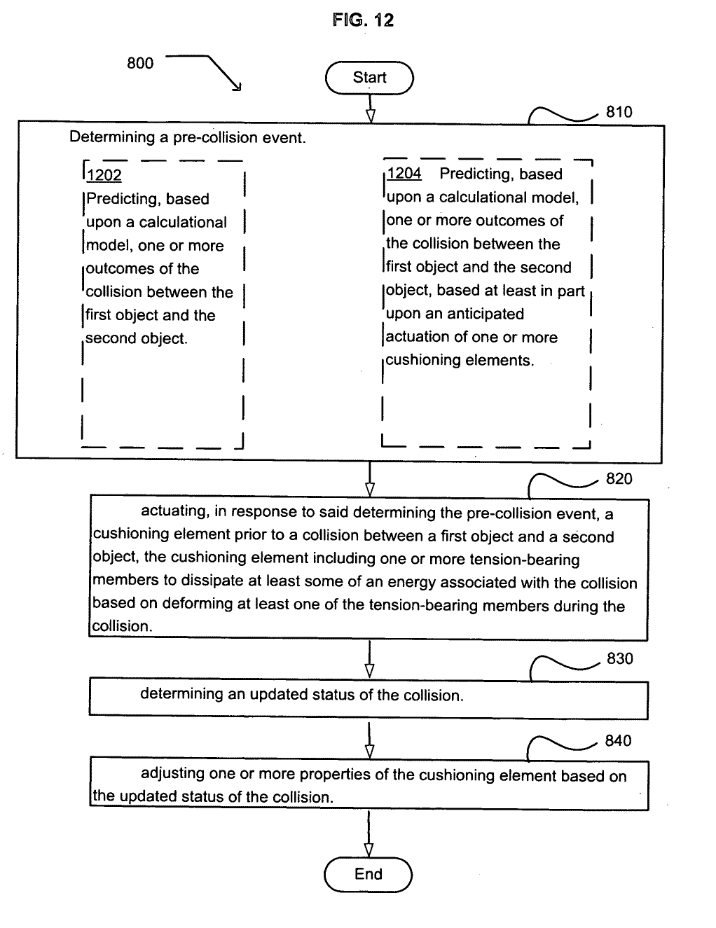

FIG. 12 illustrates alternative embodiments of the example operational flow 800 of FIG. 8. FIG. 12 illustrates example embodiments where the determining operation 810 may include at least one additional operation. Additional operations may include operations 1202 and/or 1204.

At the operation 1202, it is predicted, based upon a calculational model, one or more outcomes of the collision between the first object and the second object. A calculational model 242, for example, may provide a model of how one or more objects may operate, respond, move or change under various conditions related to a collision or in response to an actuation or control of an actuatable cushioning element and/or tension-bearing member(s) 230, or from other conditions or stimulus, for example. In an example embodiment, although not required, the calculational model 242 may include one or more (or even all) of the aspects or information of the collision-related profile 240. For example, a calculational model may include a mathematical model providing one or more equations that model the operation, movement, or change, of vehicle 410, such as indicating a specific location and velocity that may result for vehicle 410×seconds after being struck or impacted by another vehicle (traveling at a specific speed or velocity) at a specific location on vehicle 410. This is merely a simple example of how a calculational model 242 may be used, and many other examples or embodiments may be provided. For example, controller 154 or 214 for vehicle 410 may predict, based on a calculational model 242 for vehicle 410, one or more outcomes of the collision between vehicle 410 and vehicle 420. For example, controller 214 may predict based on a calculational model 242 one or more possible collision locations 610 on vehicle 410, or one or more possible relative speed or relative velocity between vehicles 410 and 420, or a predicted force of impact, or a possible acceleration that may be applied to a passenger 252 (or other sub-object) during various points of an expected collision between vehicles 410 and 420.

At the operation 1204 it is predicted, based upon a calculational model, one or more outcomes of the collision between the first object and the second object, based at least in part upon an anticipated actuation of one or more cushioning elements. For example, a controller 154 or 214 may predict, based upon a calculational model 242 for vehicle 410 and/or cushioning element 210, one or more possible outcomes of the collision between vehicles 410 and 420, based at least in part upon an anticipated actuation of cushioning element 210. For example, controller 154 may predict, based on an anticipated actuation of cushioning element 210 at the front of vehicle 410, that vehicle 410 may undergo a deceleration upon impact, while applying an acceleration of 1.3 G to the sub-objects or passengers within vehicle 410 approximately ½ second after the collision. This is merely one example of a predicted outcome, e.g., based upon a calculational mode, and many other examples may be used.

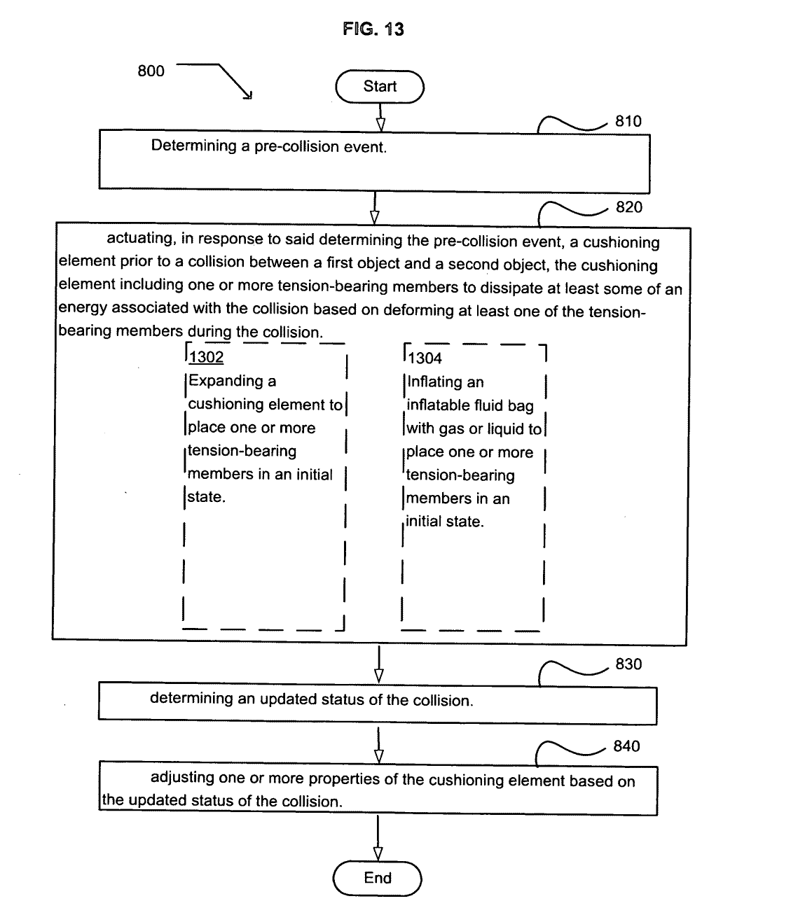

FIG. 13 illustrates alternative embodiments of the example operational flow 800 of FIG. 8. FIG. 13 illustrates example embodiments where the actuating operation 820 may include at least one additional operation. Additional operations may include operations 1302 and/or 1304.

At the operation 1302, a cushioning element is expanded to place one or more tension-bearing members in an initial state. For example, under control of controller 214 or 154, stored energy reservoir 220 may be used to expand actuatable cushioning element 210 to place one or more tension-bearing members 230 in an initial (e.g., pre-collision) state.

At the operation 1304, an inflatable fluid bag is inflated with gas or liquid to place one or more tension-bearing members in an initial state. For example, under control of controller 214 or 154, stored energy reservoir 220 may be used to inflate actuatable cushioning element 210 to place one or more tension-bearing members 230 in an initial (e.g., pre-collision) state.

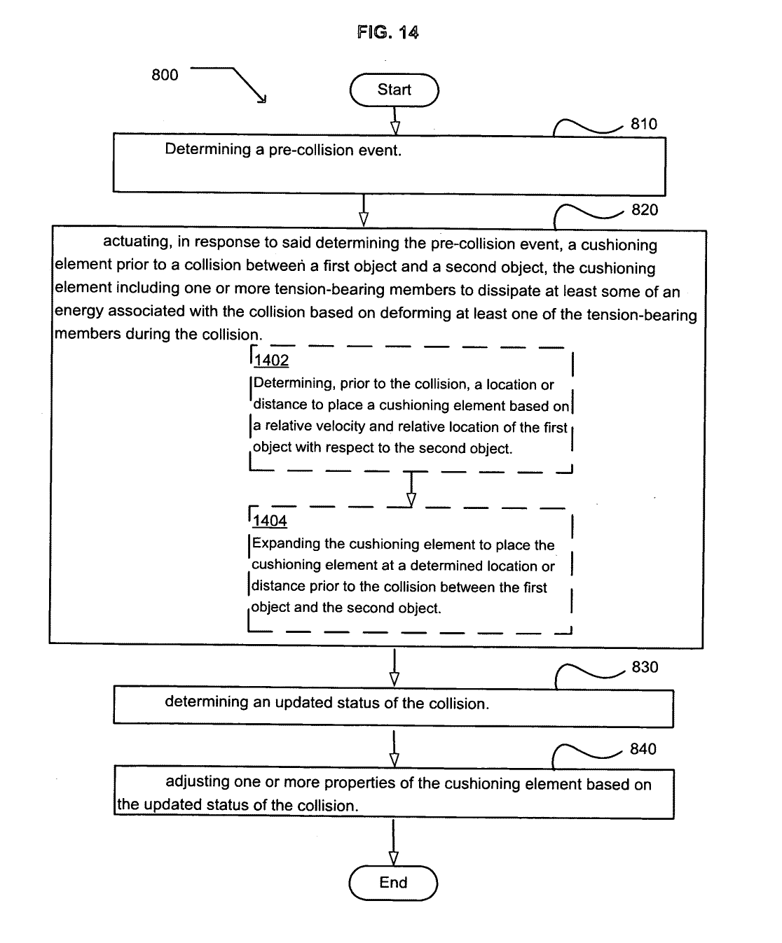

FIG. 14 illustrates alternative embodiments of the example operational flow 800 of FIG. 8. FIG. 14 illustrates example embodiments where the actuating operation 820 may include at least one additional operation. Additional operations may include operations 1402 and 1404.

At the operation 1402, it is determined, prior to the collision, a location or distance to place a cushioning element based on a relative velocity and relative location of the first object with respect to the second object. For example, controller 154 or 214 may determine to place the cushioning element 210 at the front center of vehicle 410, with the cushioning element 210 initially deployed or located at 10 inches in front from the front bumper of vehicle 410, e.g., based on the relative velocity and relative location of vehicle 410 with respect to vehicle 420.

At the operation 1404, the cushioning element is expanded to place the cushioning element at a determined location or distance prior to the collision between the first object and the second object. For example, under control of controller 214 or 154, stored energy reservoir 220 may be used to inflate actuatable cushioning element 210 to place cushioning element 210 at the determined location (e.g., at the front of vehicle 410), prior to the collision between the vehicle 410 and vehicle 420.

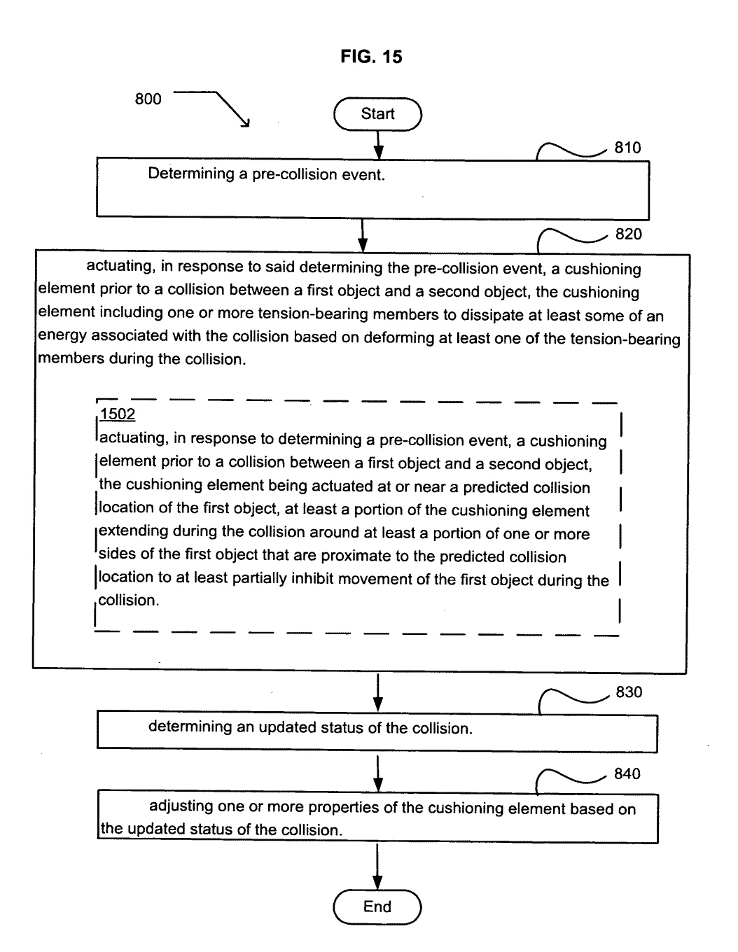

FIG. 15 illustrates alternative embodiments of the example operational flow 800 of FIG. 8. FIG. 15 illustrates example embodiments where the actuating operation 820 may include at least one additional operation. Additional operations may include operation 1502.

At the operation 1502, in response to determining a pre-collision event, a cushioning element is actuated prior to a collision between a first object and a second object, the cushioning element being actuated at or near a predicted collision location of the first object, at least a portion of the cushioning element extending during the collision around at least a portion of one or more sides of the first object that are proximate to the predicted collision location to at least partially inhibit movement of the first object during the collision. In an example embodiment, in response to determining a pre-collision event, controller 154 or 214 of vehicle 410 may actuate a cushioning element 210 (and associated tension-bearing members 230) at or near the predicted collision location 610 prior to the collision between vehicles 410 and 420, as shown in FIG. 6A. Referring to FIG. 6B, during the collision between vehicles 410 and 420, at least a portion of cushioning element 210 may extend around at least a portion of one or more sides (such as sides 612A, 612B) of vehicle 410 that are proximate to the predicted collision location 610. For example, one or more adjustments may be made, such as before or during the collision, to the cushioning element and/or associated tension-bearing members for vehicle 410, which may allow or facilitate at least a portion of the cushioning element 210 to extend around at least a portion of one or both sides 612A, 612B of vehicle 410, as shown in FIG. 6B. When the cushioning element 210 extends around at least a portion of one or both sides 612A and 612B, this may create a glove or multi-sided support for the vehicle, which may inhibit movement of vehicle 410 during the collision based on the portion of the cushioning element extending around sides 612A and 612B, for example.

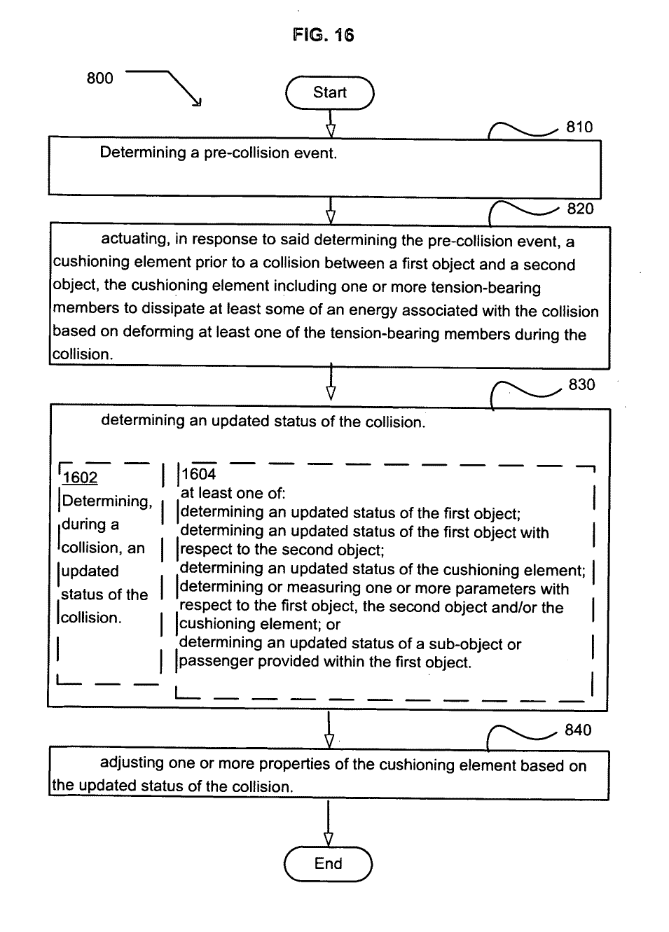

FIG. 16 illustrates alternative embodiments of the example operational flow 800 of FIG. 8. FIG. 16 illustrates example embodiments where the determining operation 830 may include at least one additional operation. Additional operations may include operation 1602 and/or 1604.

At the operation 1602, it is determined, during a collision, an updated status of the collision. For example, determining operation 830 may include controller 154 or 214 determining or measuring one or more parameters with respect to a first vehicle 410, the second vehicle 420 and/or the cushioning element 210, during the collision. For example, controller 154 or 214 may determine the relative location of vehicle 410 to vehicle 420 during the collision, based on, e.g., GPS or Radar or other sensor data. Or in another example embodiment, controller 154 or 214 may determine that a passenger (or sub-object 252) within vehicle 410 has undergone an acceleration of 3 G, or that the vehicles 410 and 420 have collided, or obtained the relative location and orientation of the vehicles 410 and 420 after the initial collision, or the location of the cushioning element with respect to the first vehicle 410, etc.

At the operation 1604, at least one of the following is determined: determining an updated status of the first object; determining an updated status of the first object with respect to the second object; determining an updated status of the cushioning element; determining or measuring one or more parameters with respect to the first object, the second object and/or the cushioning element; or determining an updated status of a sub-object or passenger provided within the first object. For example, controller 154 or 214 may determine the relative location of vehicle 410 to vehicle 420 during the collision, based on, e.g., GPS or Radar or other sensor data.

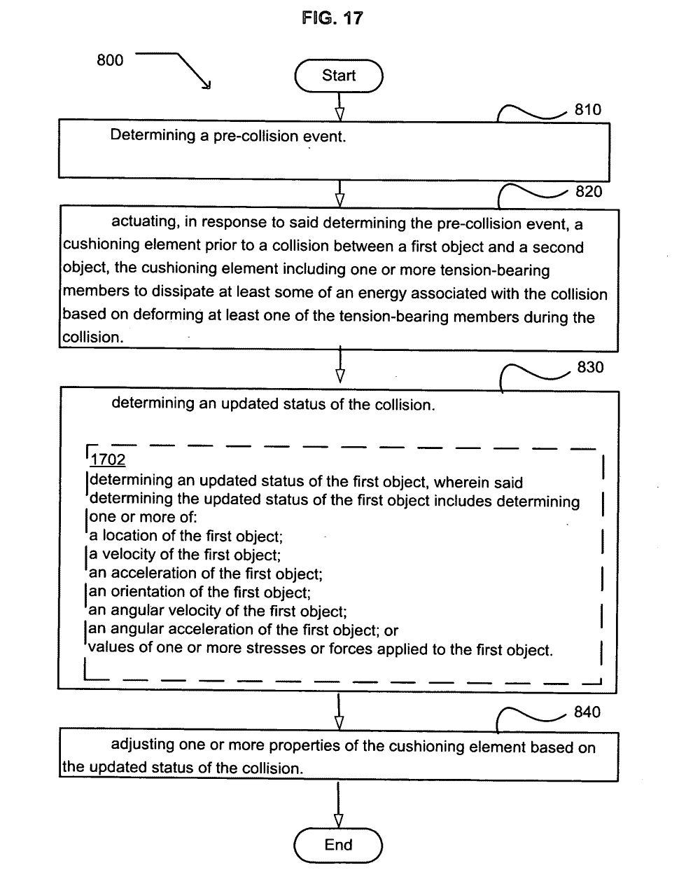

FIG. 17 illustrates alternative embodiments of the example operational flow 800 of FIG. 8. FIG. 17 illustrates example embodiments where the determining operation 830 may include at least one additional operation. Additional operations may include operation 1702.

At the operation 1702, an updated status of the first object is determined, including determining one or more of the following: a location of the first object; a velocity of the first object; an acceleration of the first object; an orientation of the first object; an angular velocity of the first object; an angular acceleration of the first object; or values of one or more stresses or forces applied to the first object. For example, controller 214 or 154 may determine a location, velocity, acceleration, orientation, angular velocity, angular acceleration or other measurement, e.g., based on measurements or values received from one or more detectors 158/218 or sensors.

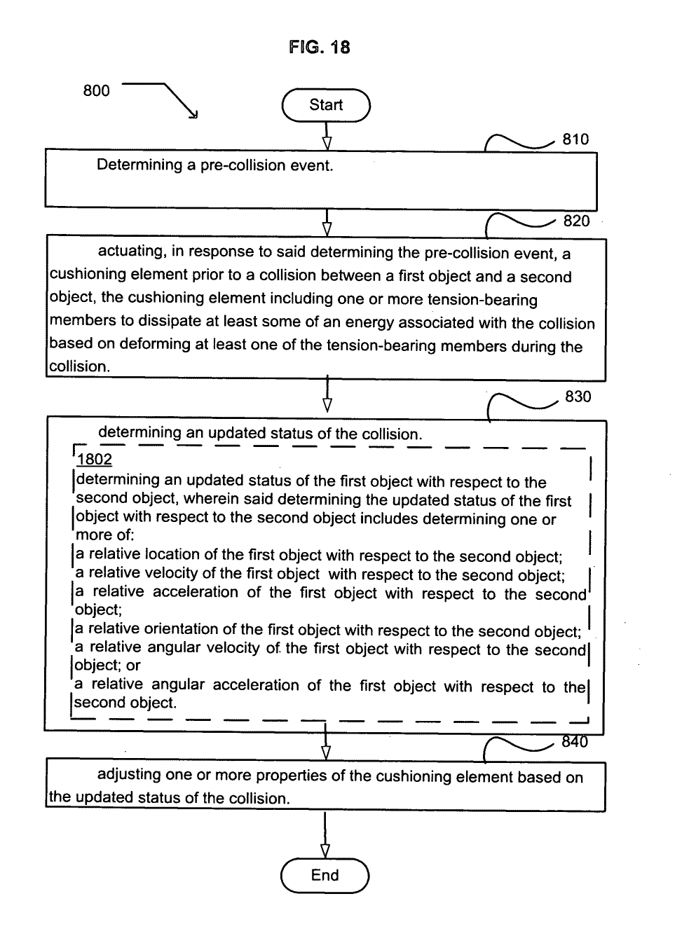

FIG. 18 illustrates alternative embodiments of the example operational flow 800 of FIG. 8. FIG. 18 illustrates example embodiments where the determining operation 830 may include at least one additional operation. Additional operations may include operation 1802.

At the operation 1802, an updated status of the first object with respect to the second object is determined, including determining one or more of: a relative location of the first object with respect to the second object; a relative velocity of the first object with respect to the second object; a relative acceleration of the first object with respect to the second object; a relative orientation of the first object with respect to the second object; a relative angular velocity of the first object with respect to the second object; or a relative angular acceleration of the first object with respect to the second object. For example, controller 214 or 154 (e.g., FIGS. 1, 2) may determine a relative location, a relative velocity, a relative acceleration, a relative orientation, a relative angular velocity, a relative angular acceleration, values of stresses applied to the first object, or other measurement, e.g., based on measurements or values received from one or more detectors 158/218 or sensors.

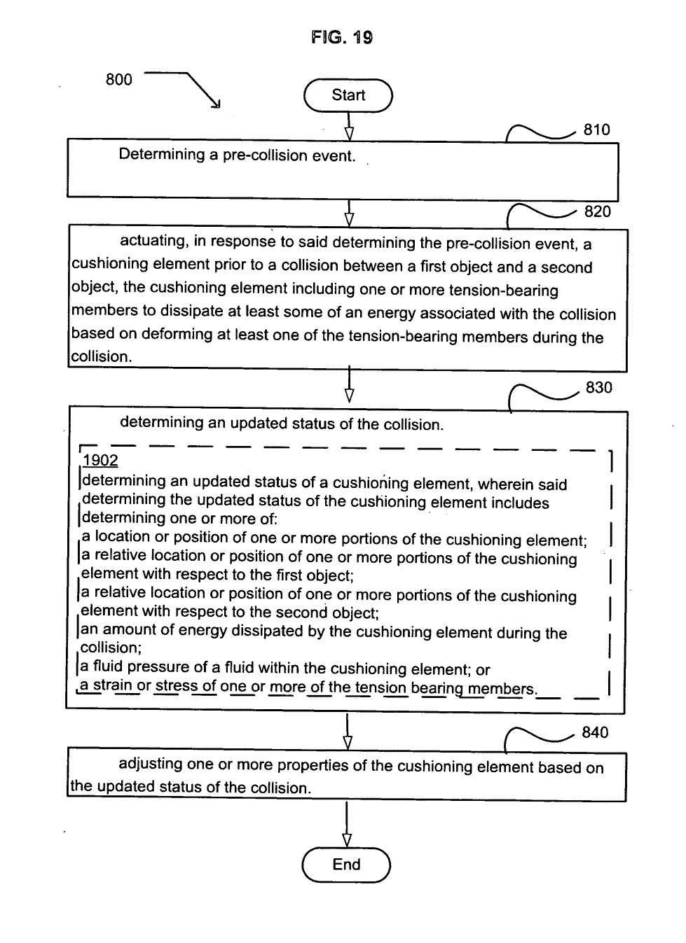

FIG. 19 illustrates alternative embodiments of the example operational flow 800 of FIG. 8. FIG. 19 illustrates example embodiments where the determining operation 830 may include at least one additional operation. Additional operations may include operation 1902.

At the operation 1902, an updated status of a cushioning element is determined, including determining one or more of: a location or position of one or more portions of the cushioning element; a relative location or position of one or more portions of the cushioning element with respect to the first object; a relative location or position of one or more portions of the cushioning element with respect to the second object; an amount of energy dissipated by the cushioning element during the collision; a fluid pressure of a fluid within the cushioning element; or a strain or stress of one or more of the tension bearing members.

For example, controller 214 or 154 (e.g., FIGS. 1, 2) of object 410 may determine a relative location of a cushioning element 210, or controller 214/154 may determine (e.g., based on signals received from an accelerometer or other detectors 158/218 or sensors) a location or position of one or more portions of the cushioning element, a relative location or position of one or more portions of the cushioning element 210 with respect to vehicle 410, a relative location or position of one or more portions of the cushioning element 210 with respect to the vehicle 420, an amount of energy dissipated by the cushioning element 210 during the collision, a fluid pressure of a fluid within the cushioning element 210 (e.g., by a pressure sensor), or, an amount or stress applied to the vehicle 410 (e.g., based on an accelerometer or other sensor).

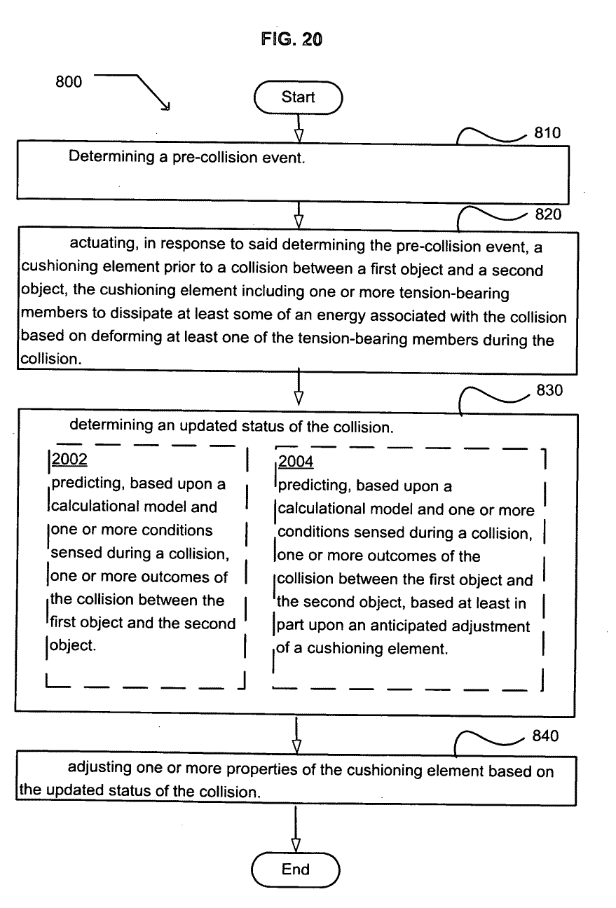

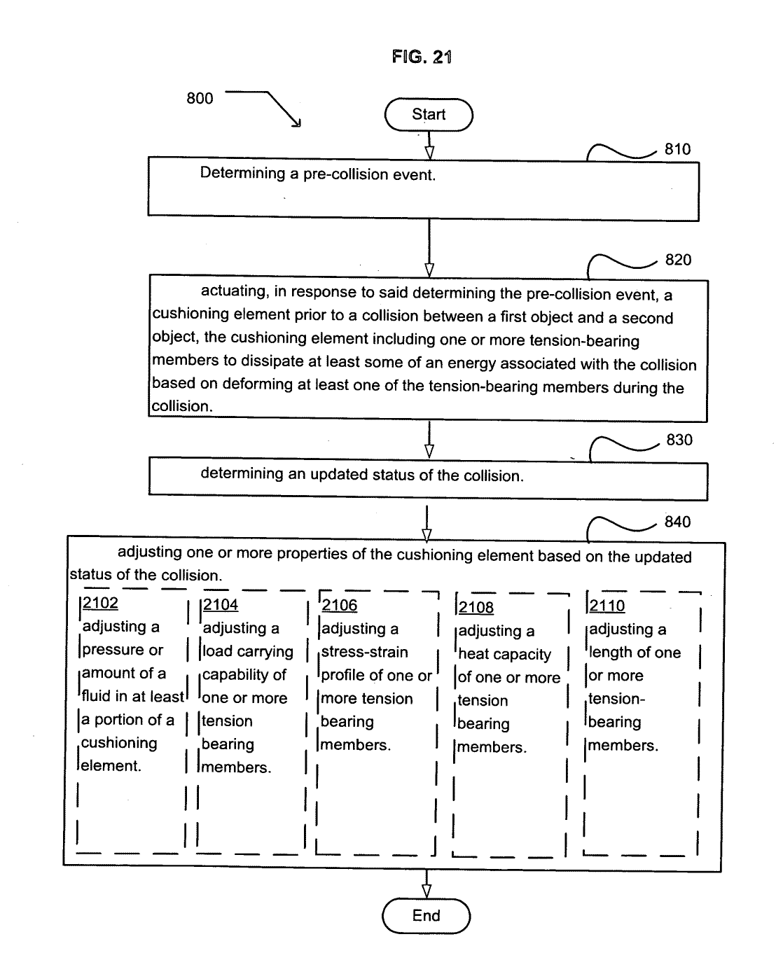

FIG. 20 illustrates alternative embodiments of the example operational flow 800 of FIG. 8. FIG. 20 illustrates example embodiments where the determining operation 830 may include at least one additional operation. Additional operations may include operation 2002 and/or 2004.

At the operation 2002, it is predicted, based upon a calculational model and one or more conditions sensed during a collision, one or more outcomes of the collision between the first object and the second object. For example, controller 154 or 214 of vehicle 410 may predict, based on a calculational model 242 of vehicle 410, one or more outcomes of the collision between vehicle 410 and 420. Predicting an outcome of the collision may include, for example, predicting a collision location 610 (FIG. 6), a force of impact, or the response of one or more components of vehicle 410 to the predicted collision between vehicles 410 and 420. For example, based on a sensed collision location at vehicle 410 (e.g., front right corner of vehicle 410) and a calculational model, an outcome (e.g., collision result) may be predicted that the vehicle 410 will undergo an acceleration of 2.3 G during the collision, and vehicle 410 will rotate or spin during the collision between 40 and 50 degrees. This is just one example of a predicted outcome.

At the operation 2004, it is predicted, based upon a calculational model and one or more conditions sensed during a collision, one or more outcomes of the collision between the first object and the second object, based at least in part upon an anticipated adjustment of a cushioning element. For example, controller 154 or 214 of vehicle 410 may predict, based on a calculational model 242 of vehicle 410 and an anticipated adjustment of cushioning element 210 (e.g., an anticipated increase in fluid pressure in cushioning element 210 during the collision), one or more outcomes of the collision between vehicle 410 and 420. For example, based on the calculational model 242 for vehicle 410 and an anticipated increase in fluid pressure for cushioning element 210 during the collision to partially absorb a force of the impact, it may be predicted that the vehicle will undergo an acceleration of approximately 1.7 G, and will rotate between 20 and 40 degrees during the collision. This is just one example of a predicted outcome.

FIG. 21 illustrates alternative embodiments of the example operational flow 800 of FIG. 8. FIG. 21 illustrates example embodiments where the adjusting operation 840 may include at least one additional operation. Additional operations may include operation 2102, 2104, 2106, 2108, and/or 2110.

At the operation 2102, a pressure or amount of a fluid in at least a portion of a cushioning element is adjusted. For example, a controller 154 or 214 may adjust a pressure or amount of a fluid (e.g., either gas or liquid) in at least a portion of the cushioning element 210, e.g., via operation of stored energy reservoir 220 (FIG. 2).

At the operation 2104, a load carrying capability of one or more tension-bearing members is adjusted. For example, under control of controller 154 or 214, a heat capacity material 512 may be applied to a tension-bearing member 230 (FIG. 5A) to increase a load carrying capability of the member, or a blade (such as blade 720, FIG. 7B) or electric cutter may be used to thin or cut one or more tension-bearing members, thereby decreasing their load carrying capability.

At operation 2106, a stress-strain profile of one or more tension bearing members is adjusted. For example, a stress-strain profile of a tension-bearing member 230A is adjusted, e.g., by using a blade, electric cutter, or needle 720 to thin or partially cut tension-bearing member 230A (FIG. 7B) to control how much force (e.g., newtons) the one or more tension bearing members can sustain before or during an inelastic deformation, or to control the amount of deformation (e.g., centimeters) the one or more tension bearing members will undergo when loaded with a specified force.

At operation 2108 a heat capacity of one or more tension-bearing members is adjusted. For example, a heat capacity material 512 may be applied to a tension-bearing member 230 (FIGS. 5A, 5B) to increase the heat or work capacity of the tension-bearing member 230.

At operation 2110, a length of one or more tension-bearing members is adjusted. For example, a brake or clutch 730 (FIG. 7B) may be used to increase or decrease a length of a tension-bearing member 230A.

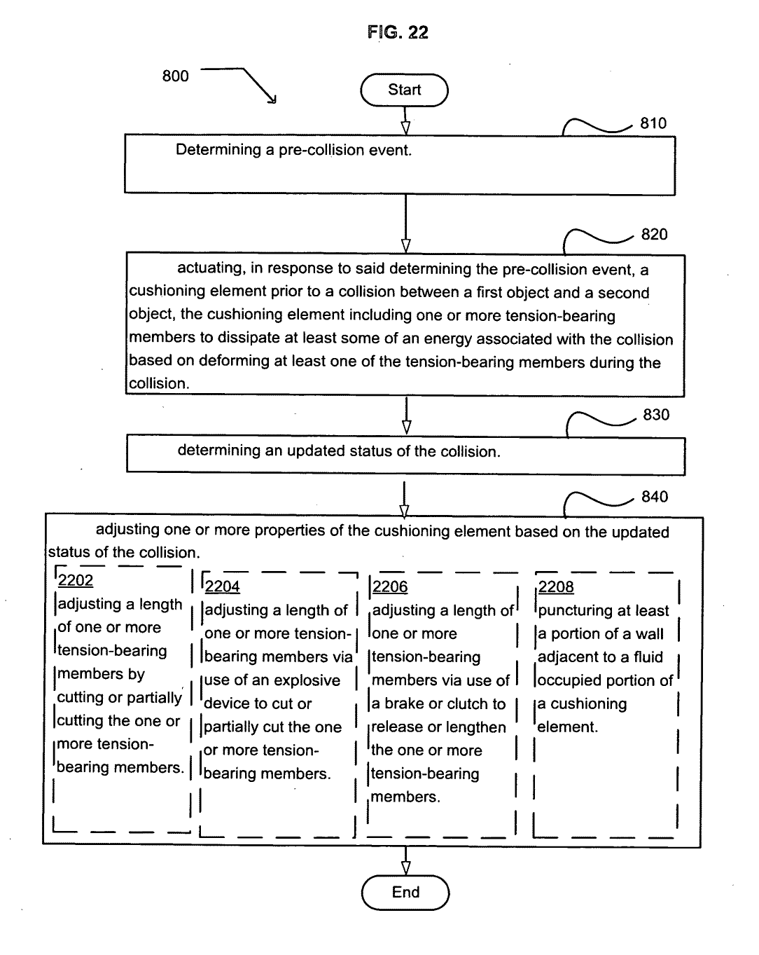

FIG. 22 illustrates alternative embodiments of the example operational flow 800 of FIG. 8. FIG. 22 illustrates example embodiments where the adjusting operation 840 may include at least one additional operation. Additional operations may include operation 2202, 2204, 2206, and/or 2208.

At the operation 2202, a length of one or more tension-bearing members is adjusted by cutting or partially cutting the one or more tension-bearing members. In an example embodiment, as shown in FIG. 7A, a squib 710 (or small explosive device) may be activated or exploded, which may propel a blade 712. The moving blade 712 may cut one of the lengthening loops 714 against a solid member 715, to lengthen the tension-bearing member 230. Also, an electric cutter may be used to cut or partially cut one or more tension-bearing members 230.

At the operation 2204, a length of one or more tension-bearing members may be adjusted via use of an explosive device to cut or partially cut the one or more tension-bearing members. In an example embodiment, as shown in FIG. 7A, a squib 710 (or small explosive device) may be activated or exploded, which may propel a blade 712. The moving blade 712 may cut one of the lengthening loops 714 against a solid member 715. When a lengthening loop 714 is cut, this may lengthen the tension-bearing member 230.

At the operation 2206, a length of one or more tension-bearing members is adjusted via use of a brake or clutch to release or lengthen the one or more tension-bearing members. For example, a brake or clutch 730 (FIG. 7B) may be used to increase or decrease a length of a tension-bearing member 230A.

At operation 2208, at least a portion of a wall is punctured that is adjacent to a fluid occupied portion of a cushioning element. For example, a cushioning element 210 may include one or more partitions or sections. For example, a blade, electric cutter, or needle 720 (FIG. 7B) may be used to puncture a wall that is adjacent to a fluid (e.g., gas or liquid) occupied portion of the cushioning element 210.

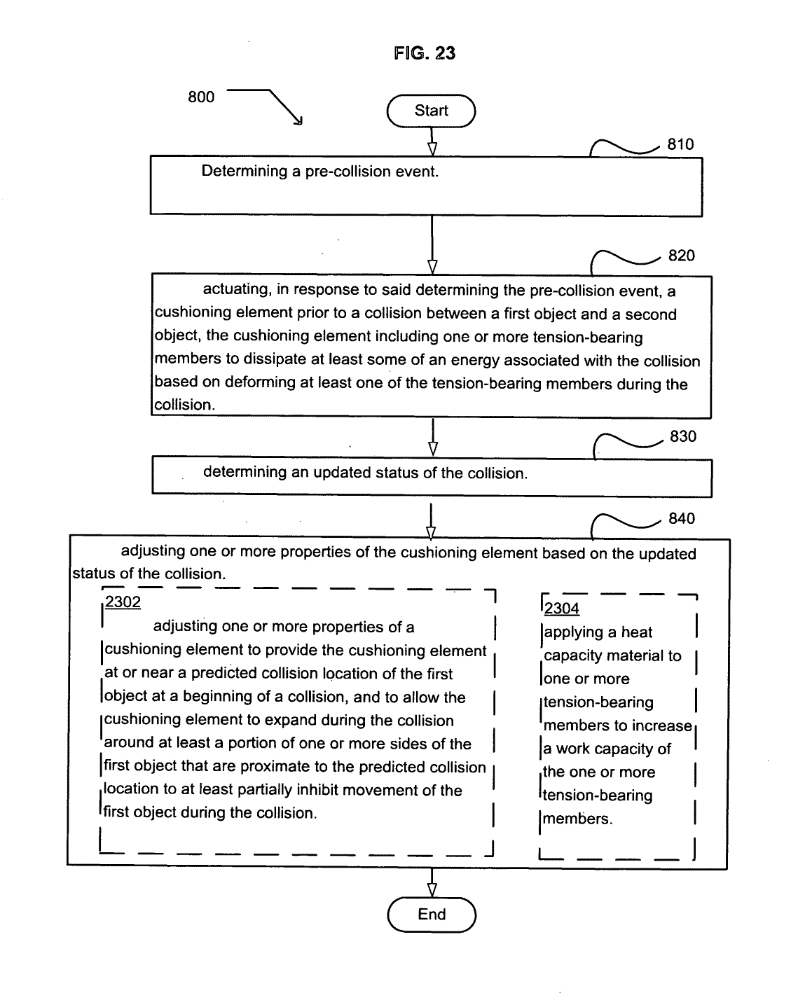

FIG. 23 illustrates alternative embodiments of the example operational flow 800 of FIG. 8. FIG. 23 illustrates example embodiments where the adjusting operation 840 may include at least one additional operation. Additional operations may include operation 2302 and/or 2304.

At the operation 2302, one or more properties of a cushioning element are adjusted to provide the cushioning element at or near a predicted collision location of the first object at a beginning of a collision, and to allow the cushioning element to expand during the collision around at least a portion of one or more sides of the first object that are proximate to the predicted collision location to at least partially inhibit movement of the first object during the collision. In an example embodiment, under control of controller 154 or 214, a pressure of fluid in the cushioning element 210 may be adjusted, or a length of one or more tension-bearing members 230 may be adjusted so as to provide or deploy the cushioning element 210 at a predicted collision location 610 (FIG. 6A) of vehicle 410. Referring to FIG. 6B, during the collision between vehicles 410 and 420, at least a portion of cushioning element 210 may extend around at least a portion of one or more sides (such as sides 612A, 612B) of vehicle 410 that are proximate to the predicted collision location 610. This three-sided support may provide cushioning support in the front at the predicted collision location 610, and may also inhibit movement of vehicle 410 during the collision based on the portion of the cushioning element 210 extending around sides 612A and 612B of vehicle 410, for example.

At the operation 2304, a heat capacity material is applied to one or more tension-bearing members to increase a work capacity of the one or more tension-bearing members. For example, a heat capacity material 512 may be applied to a tension-bearing member 230 (FIG. 5A), e.g., via a capsule 514 (FIG. 5B), which may increase a work capacity of the tension-bearing member 230 (or its capacity to do work).

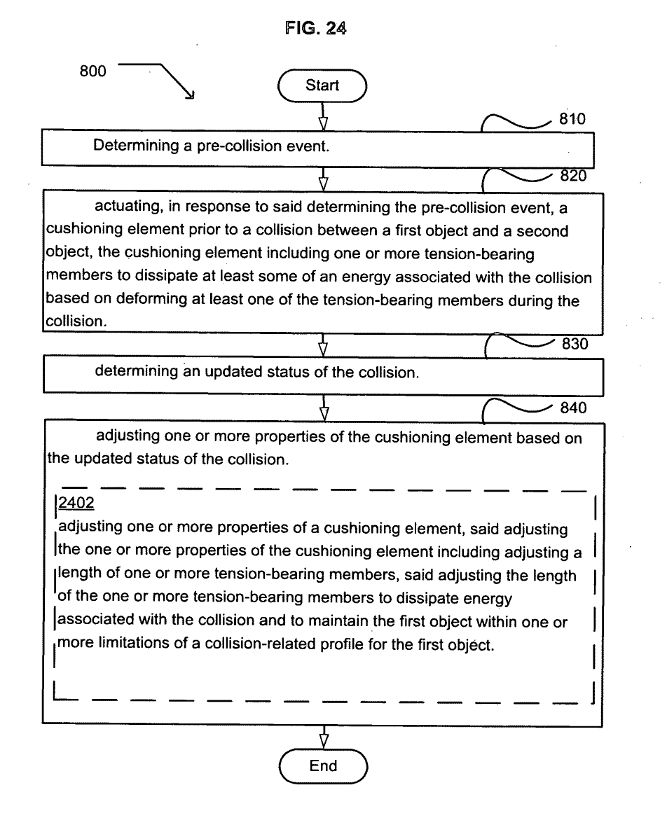

FIG. 24 illustrates alternative embodiments of the example operational flow 800 of FIG. 8. FIG. 24 illustrates example embodiments where the operational flow 800 may include at least one additional operation, and where the adjusting operation 840 may include at least one additional operation. Additional operations may include operation 2402.

At the operation 2402, one or more properties of a cushioning element are adjusted, the adjusting the one or more properties of the cushioning element including adjusting a length of one or more tension-bearing members, the adjusting the length of the one or more tension-bearing members to dissipate energy associated with the collision and to maintain the first object within one or more limitations of a collision-related profile for the first object. For example, a length of a tension-bearing member 230 for vehicle 410 may be increased, e.g., via use of a clutch or brake 730 (FIG. 7B), to dissipate energy associated with the collision wits vehicle 420, and maintain the vehicle 410 within one or more limitations of the collision-related profile (e.g., dissipate energy without allowing the vehicle 410 to exceed a 3 G acceleration limitation as indicated by the collision-related profile 240 for vehicle 410).

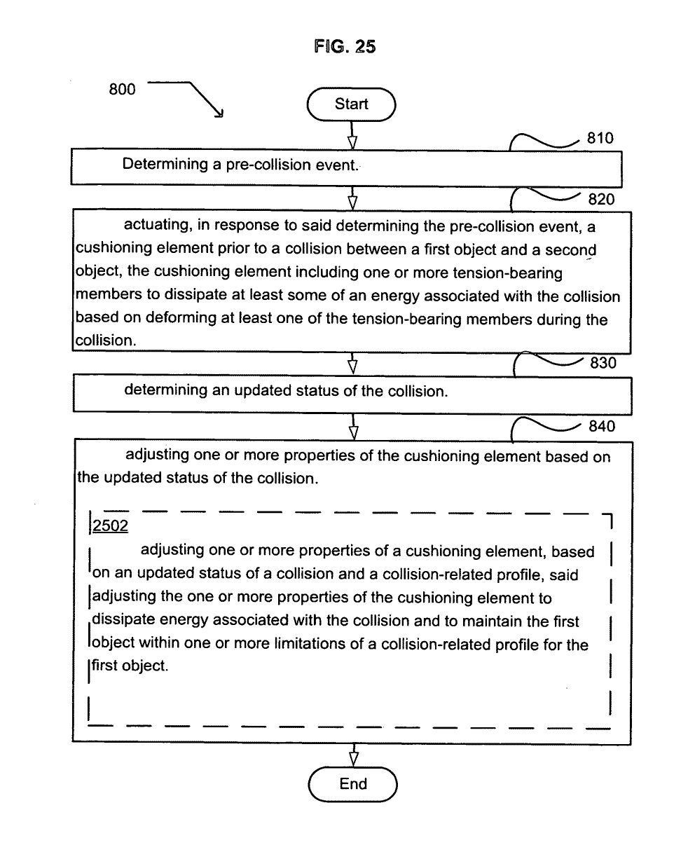

FIG. 25 illustrates alternative embodiments of the example operational flow 800 of FIG. 8. FIG. 25 illustrates example embodiments where the operational flow 800 may include at least one additional operation, and where the adjusting operation 840 may include at least one additional operation. Additional operations may include operation 2502.

At the operation 2502, one or more properties of a cushioning element are adjusted, based on an updated status of a collision and a collision-related profile, the adjusting the one or more properties of the cushioning element to dissipate energy associated with the collision and to maintain the first object within one or more limitations of a collision-related profile for the first object. For example, based on an updated location or updated fluid pressure of the cushioning element 210, a length of a tension-bearing member 230 for vehicle 410 may be increased, e.g., via use of a clutch or brake 730 (FIG. 7B), to dissipate energy associated with the collision with vehicle 420, and maintain the vehicle 410 within one or more limitations of the collision-related profile (e.g., dissipate energy without allowing the vehicle 410 to exceed a 3 G acceleration limitation as indicated by the collision-related profile 240 for vehicle 410).

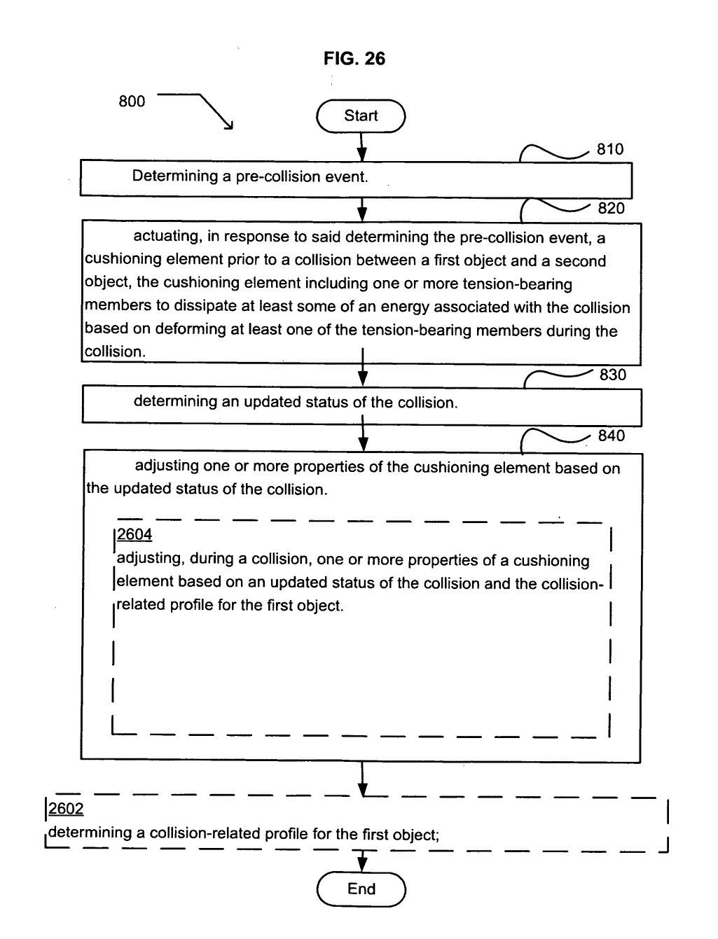

FIG. 26 illustrates alternative embodiments of the example operational flow 800 of FIG. 8. FIG. 26 illustrates example embodiments where the operational flow 800 may include at least one additional operation, and where the adjusting operation 840 may include at least one additional operation. Additional operations may include operation 2602 and/or 2604.

At the operation 2602, a collision-related profile is determined for the first object. For example, a collision-related profile 240 (FIG. 2) for vehicle 410 (FIGS. 4, 6A, 6B) may be read or obtained by controller 154 or 214.

At the operation 2604, during a collision, one or more properties of a cushioning element are adjusted based on an updated status of the collision and the collision-related profile for the first object. For example, during the collision between vehicles 410 and 420, controller 154 or 214 may control or adjust one or more properties of the cushioning element 210, such as adjusting a fluid pressure, or adjusting a length or tension in one or more tension-bearing members 230.

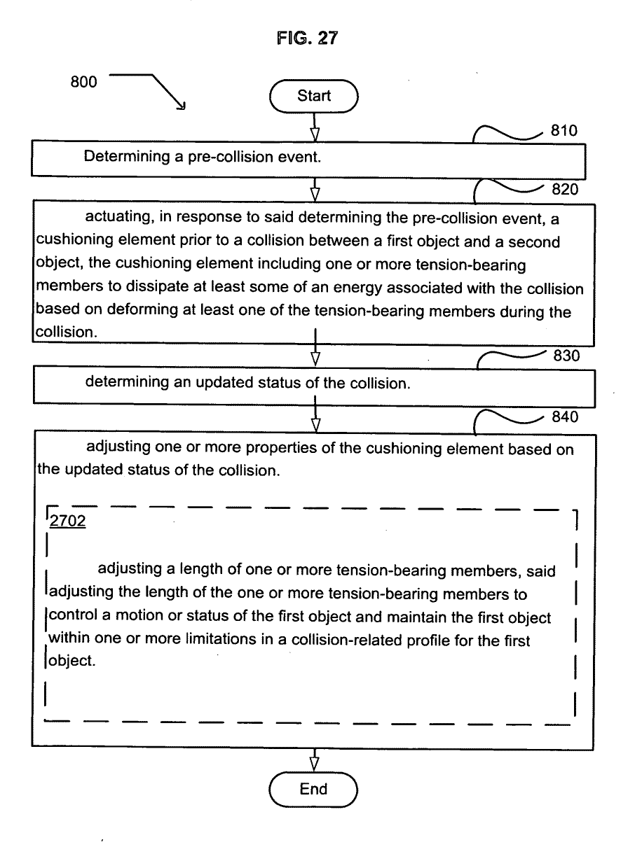

FIG. 27 illustrates alternative embodiments of the example operational flow 800 of FIG. 8. FIG. 27 illustrates example embodiments where the operational flow 800 may include at least one additional operation, and where the adjusting operation 840 may include at least one additional operation. Additional operations may include operation 2702.

At the operation 2702, a length of one or more tension-bearing members are adjusted, the adjusting the length of the one or more tension-bearing members to control a motion or status of the first object and maintain the first-object within one or more limitations in a collision-related profile for the first object. For example, controller 154 or 214 of vehicle 410 may adjust a length of one or more tension-bearing members 230 to control a motion or status of the vehicle 410 (e.g., reduce its speed to zero MPH), and maintain the vehicle within one or more limitations (e.g., acceleration to vehicle 410 less than 3 G during the collision) of the collision-related profile 240 (FIG. 2) of vehicle 410 (FIGS. 4, 6A, 6B).

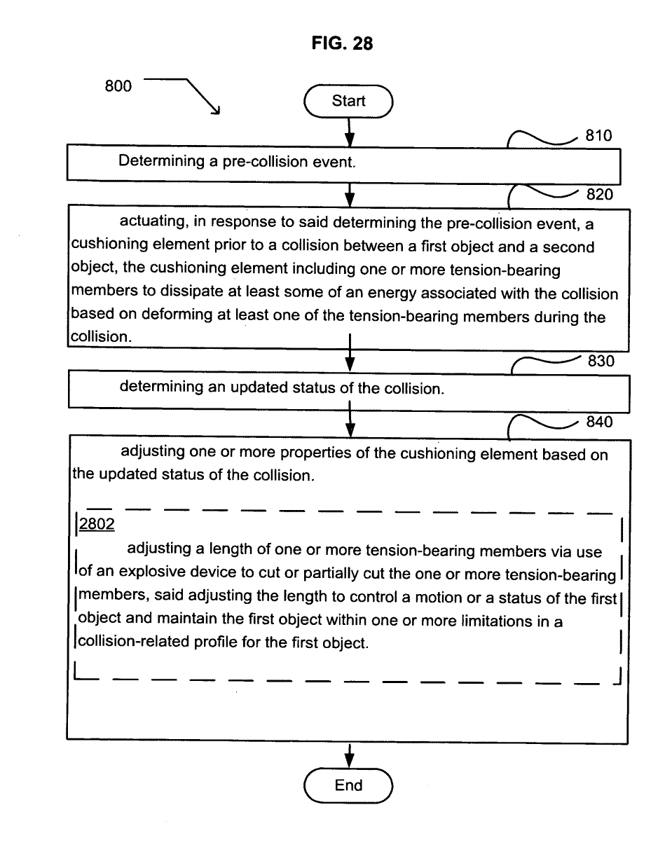

FIG. 28 illustrates alternative embodiments of the example operational flow 800 of FIG. 8. FIG. 28 illustrates example embodiments where the operational flow 800 may include at least one additional operation, and where the adjusting operation 840 may include at least one additional operation. Additional operations may include operation 2802.

At the operation 2802, a length of one or more tension-bearing members are adjusted via use of an explosive device to cut or partially cut the one or more tension-bearing members. The length of one or more tension-bearing members may be adjusted to control a motion or a status of the first object and maintain the first object within one or more limitations of a collision-related profile for the first object. For example, a length of one or more tension-bearing members 230 may be adjusted via use of a squib 710 and blade 712 (FIG. 7A). In an example embodiment, as shown in FIG. 7A, a squib 710 (or small explosive device) may be activated or exploded, which may propel a blade 712. The moving blade 712 may cut one of the lengthening loops 714 against a solid member 715. When a lengthening loop 714 is cut, this may lengthen the tension-bearing member 230, which may control a motion of a first object (e.g., vehicle 410) to maintain the vehicle within one or more limitations (e.g., acceleration to vehicle 410 less than 3 G during the collision) of the collision-related profile 240 (FIG. 2) of vehicle 410 (FIGS. 4, 6A, 6B).

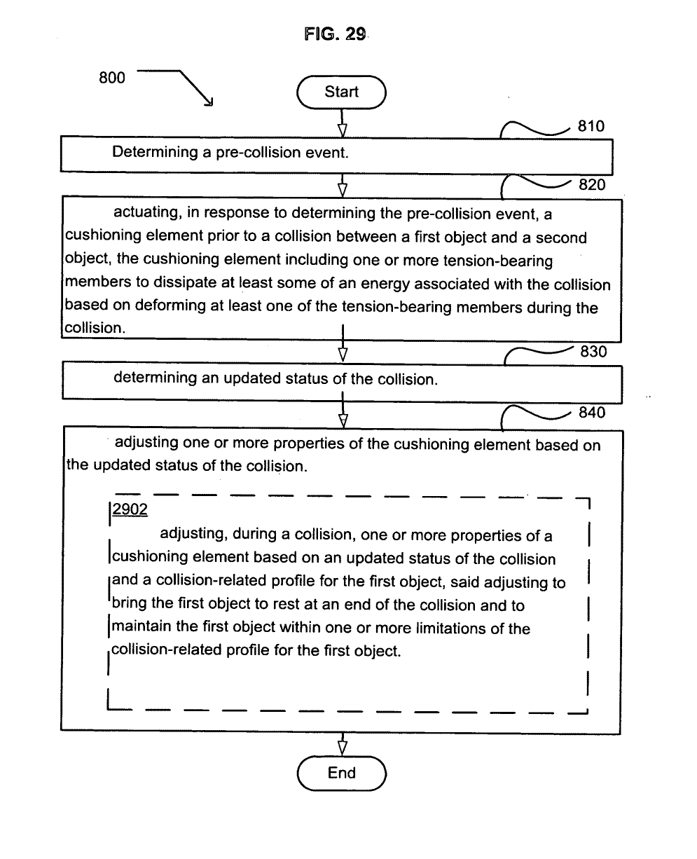

FIG. 29 illustrates alternative embodiments of the example operational flow 800 of FIG 8. FIG. 29 illustrates example embodiments where the operational flow 800 may include at least one additional operation, and where the adjusting operation 840 may include at least one additional operation. Additional operations may include operation 2902.

At the operation 2902, during a collision, one or more properties of a cushioning element are adjusted based on an updated status of the collision and a collision-related profile for the first object. The one or more properties of a cushioning element may be adjusted to bring the first object to rest at an end of the collision and maintain the first object within one or more limitations of the collision-related profile for the first object. For example, during the collision with vehicle 420 (FIGS. 4, 6A, 6B), controller 154 or 214 of vehicle 410 may adjust a length of one or more tension-bearing members 230 to bring the vehicle 410 to rest at the end of the collision, and to maintain the vehicle 410 within one or more limitations (e.g., acceleration to vehicle 410 less than 3 G during the collision) of the collision-related profile 240 (FIG. 2) for vehicle 410 (FIGS. 4, 6A, 6B).

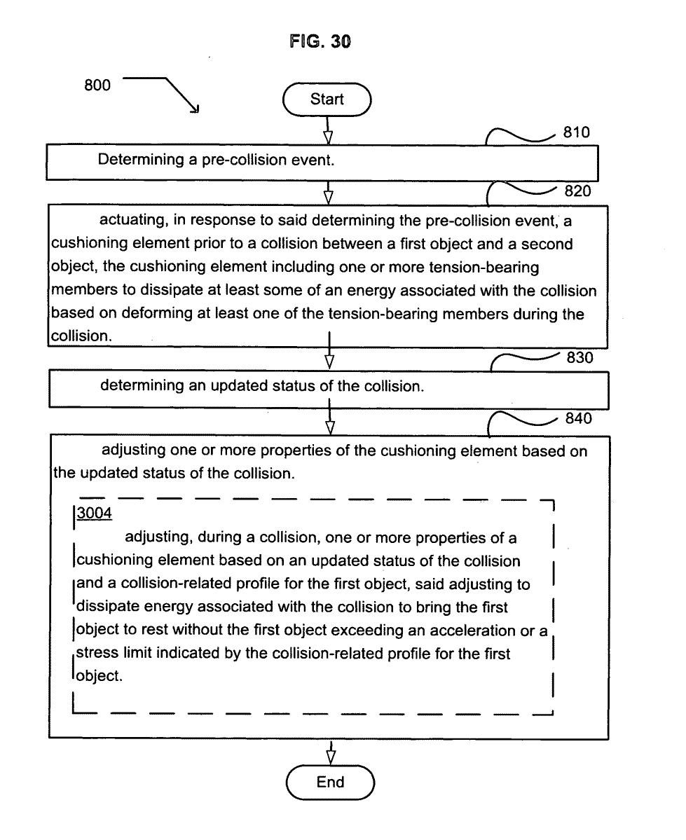

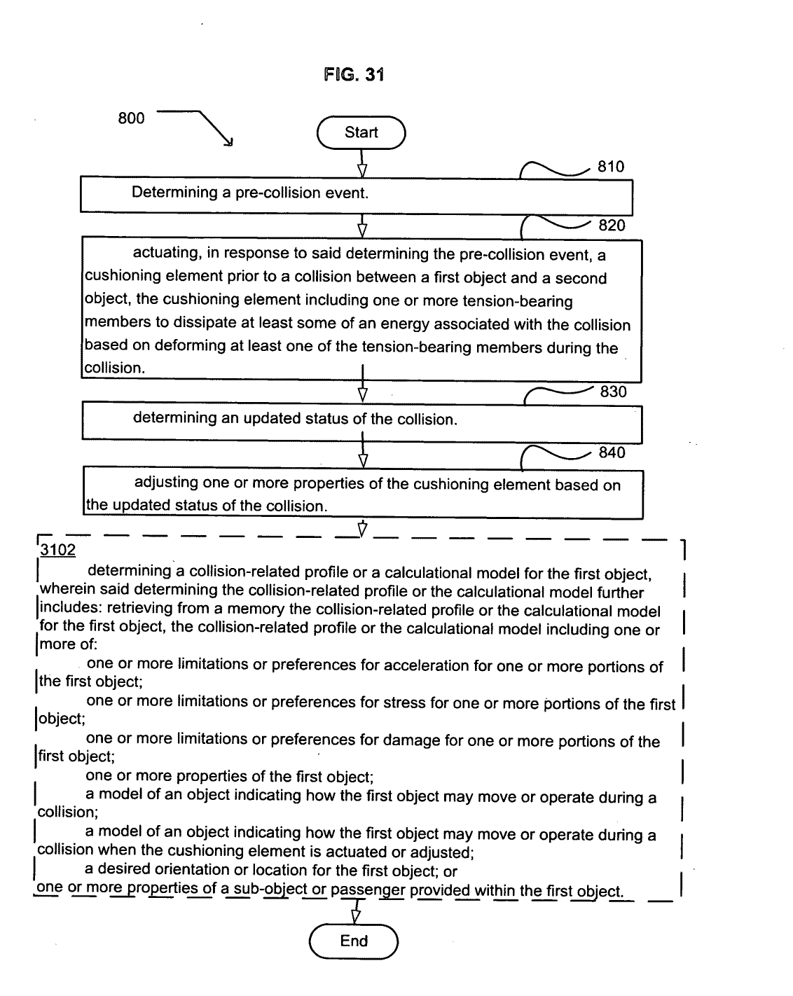

FIG. 30 illustrates alternative embodiments of the example operational flow 800 of FIG. 8. FIG. 30 illustrates example embodiments where the operational flow 800 may include at least one additional operation, and where the adjusting operation 840 may include at least one additional operation. Additional operations may include operation 3002.

At the operation 3002, during a collision, one or more properties of a cushioning element are adjusted based on an updated status of the collision and a collision-related profile for the first object. The one or more properties of the cushioning element may be adjusted to dissipate energy associated with the collision to bring the first object to rest without the first object exceeding an acceleration or a stress limit indicated by the collision-related profile for the first object. For example, during the collision with vehicle 420 (FIGS. 4, 6A, 6B), controller 154 or 214 of vehicle 410 may adjust a length of one or more tension-bearing members 230 (e.g., via clutch or brake 730, FIG. 7B) to bring the vehicle 410 to rest without vehicle 410 exceeding an acceleration limitation (e.g., maximum acceleration of 3 G for vehicle 410) indicated by the collision-related profile 240 (FIG. 2) for vehicle 410 (FIGS. 4, 6A, 6B).

FIG. 31 illustrates alternative embodiments of the example operational flow 800 of FIG. 8. FIG. 31 illustrates example embodiments where the operational flow 800 may include at least one additional operation. Additional operations may include operation 3102.

At the operation 3102, a collision-related profile (e.g., collision-related profile 240, FIG. 2) or a calculational model (calculational model 242) is determined for the first object (e.g., for vehicle 410, FIGS. 4, 6A, 6B). The determining of the collision-related profile or the calculational model may further include retrieving from a memory a collision-related profile or the calculational model for the first object (e.g., controller 154 or 214 of vehicle 410 may retrieve a collision-related profile 240 or calculational model 242, FIG. 2, from memory for vehicle 410), the collision-related profile or the calculational model including one or more of: one or more limitations or preferences for acceleration for one or more portions of the first object (e.g., a 3 G limitation for acceleration vehicle 410); one or more limitations or preferences for stress for one or more portions of the first object (e.g., a maximum stress of 5,000 PSI applied to a front bumper of vehicle 410); one or more limitations or preferences for damage for one or more portions of the first object (e.g., a front hood crumple zone of vehicle 410 that may crumple up to 30% without damaging a passenger); one or more properties of the first object (e.g., weight, length, center of gravity of vehicle 410); a model (e.g., calculational model 242 for vehicle 410) of an object indicating how the first object may move or operate during a collision; a model (e.g., calculational model 242 or vehicle 410) of an object indicating how the first object may move or operate during a collision when the cushioning element is actuated or adjusted; a desired orientation or location for the first object (e.g., an indication of preferred side of vehicle 410 that should be up, so that vehicle should not roll over); or one or more properties of a sub-object or passenger provided within the first object (e.g., indication of a maximum acceleration that may be applied to a passenger or cargo without injuring/damaging the passenger/cargo).

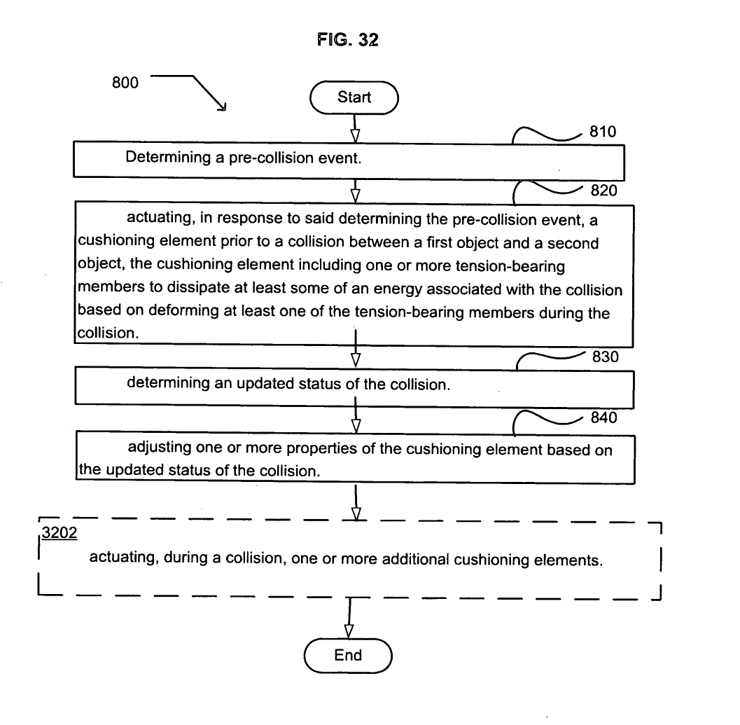

FIG. 32 illustrates alternative embodiments of the example operational flow 800 of FIG. 8. FIG. 32 illustrates example embodiments where the operational flow 800 may include at least one additional operation. Additional operations may include operation 3202.

At the operation 3202, during a collision, one or more additional cushioning elements are actuated. For example, under control of controller 154 or 214 (FIGS. 1, 2) three additional cushioning elements 210 may be actuated for vehicle 410, including cushioning elements on the sides 612A and 612B, and at the rear of vehicle 410.

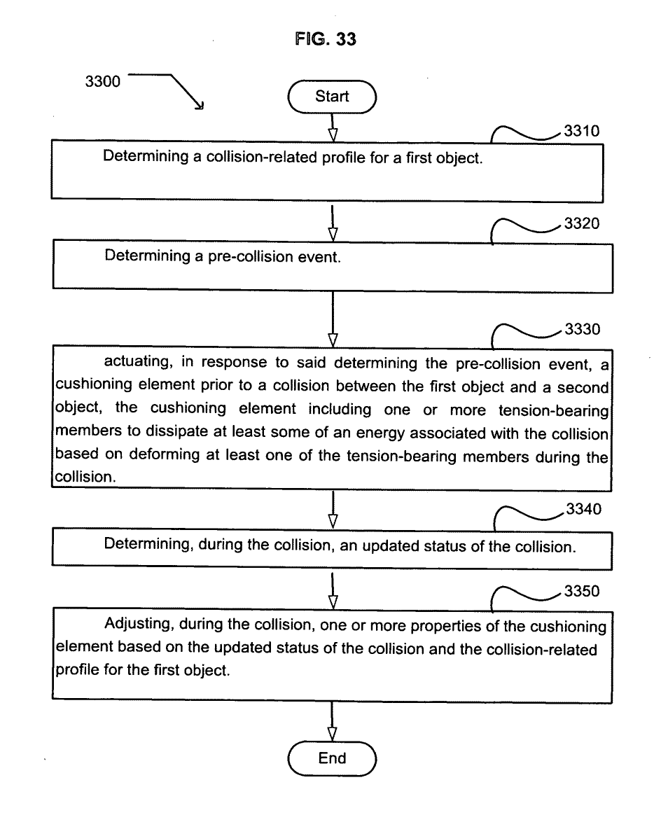

FIG. 33 illustrates an operational flow 3300 representing example operations related to an energy dissipative cushioning system.

After a start operation, the operational flow 3300 moves to a determining operation 3310 where a collision-related profile is determined for a first object. For example, a collision-related profile 240 (FIG. 2) for vehicle 410 (FIGS. 4, 6A, 6B) may be read or obtained by controller 154 or 214.

In a determining operation 3320, a pre-collision event is determined. For example, an event detector 158 or 218 may detect or determine an event (or condition), or a series of events, such as a velocity that exceeds a threshold, an acceleration that exceeds a threshold, a change in acceleration or change in location or velocity, a relative location, velocity or acceleration of an object with respect to another object that is within a range or exceeds a threshold, etc. In an example embodiment, an event detector 158 or 218 provided in vehicle 410 may detect a pre-collision event (e.g., determine based on relative location, relative velocity and/or relative acceleration of objects (or vehicles) 410 and 420, that a collision between objects (or vehicles) 410 and 420 is likely to occur). This determining may be performed by event detector 158/218 and also possibly with controller 154 or 214. Event detector 158 or 218 may include any type of detector or sensor. Event detector 158 may, for example, include any well-known detector, instrument or device to detect an event or condition, or location of objects, or velocity, acceleration or other measurement of objects. For example, a GPS (Global Positioning System) receiver or Radar, in conjunction with a controller 154 or 214, may determine that vehicle 410 is 8.5 meters from a second vehicle 420. The controller 154 or 214 may determine the event based on a distance between vehicles 410 and 420 being less than 15 units of distance (e.g., 15 meters), and a relative velocity between the vehicles 410, 420 of more than 30 miles per hour, as an example. Other types of event detectors or sensors may be used, such as an accelerometer to determine that an acceleration or change in acceleration has exceeded a threshold, for example. In another example embodiment, event detector 158 may include a Micro Electro Mechanical System (MEMS) accelerometer. These are merely a few examples, and the disclosure is not limited thereto.

Then, in an actuating operation 3330, a cushioning element is actuated, in response to determining the pre-collision event, prior to a collision between a first object and a second object, the cushioning element including one or more tension-bearing members to dissipate at least some of an energy associated with the collision based on deforming at least one of the tension-bearing members during the collision. For example, as shown in FIG. 2, element controller 214 may actuate actuatable cushioning element 210 in response to event detector 218 determining the event. This actuating may include element controller 214 or central controller 154 deploying or placing the actuatable cushioning element 210 in an initial or pre-collision state, for example. Actuatable cushioning element 210 (FIG. 2) may include one or more tension-bearing members 230 (e.g., 230A, 230B, 230C, 230D, 230E, . . . ), which may dissipate at least some of an energy associated with the collision based on deforming at least one of the tension-bearing members during the collision.

Then, in a determining operation 3340, during the collision, an updated status of the collision is determined. For example, determining operation 3340 may include controller 154 or 214 determining or measuring one or more parameters with respect to a first vehicle 410, the second vehicle 420 and/or the cushioning element 210. For example, controller 154 or 214 may determine the relative location of vehicle 410 to vehicle 420 during the collision, based on, e.g., GPS or Radar or other sensor data. Or in another example embodiment, controller 154 or 214 may determine that a passenger (or sub-object 252) within vehicle 410 has undergone an acceleration of 30, or that the vehicles 410 and 420 have collided, or obtained the relative location and orientation of the vehicles 410 and 420 after the initial collision, or the location of the cushioning element with respect to the first vehicle 410, etc.

Then, in an adjusting operation 3350, during the collision, one or more properties of the cushioning element are adjusted based on the updated status of the collision and the collision-related profile. For example, a controller 154 or 214 may adjust a pressure or amount of a fluid (e.g., either gas or liquid) in at least a portion of the cushioning element 210. For example, the pressure of the fluid in the cushioning element may be adjusted to decrease or control an acceleration that is being applied to vehicle 410 such that the acceleration applied to the vehicle 410 does not exceed an acceleration limitation (e.g., 3 G) as indicated by the collision-related profile 240 for vehicle 410.

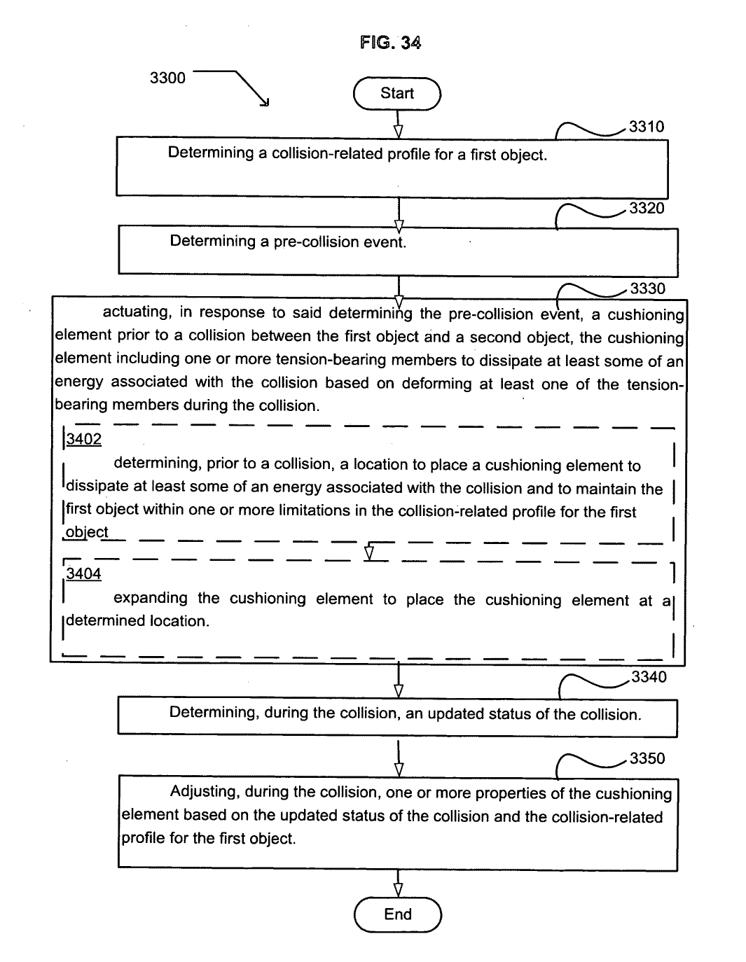

FIG. 34 illustrates alternative embodiments of the example operational flow 3300 of FIG. 33. FIG. 34 illustrates example embodiments where the actuating operation 3330 may include at least one additional operation. Additional operations may include operations 3402 and/or 3404.

At the operation 3402, it is determined, prior to a collision, a location to place a cushioning element to dissipate at least some of an energy associated with the collision and to maintain the first object within one or more limitations in the collision-related profile for the first object. For example, controller 154 or 214 may determine to place the cushioning element 210 at the front of vehicle 410 (or at a particular location or distance from the vehicle 410), to dissipate at least some of the energy associated with the collision while not exceeding a 3 G acceleration limitation indicated by the collision-related profile 240 (FIG. 2).

At the operation 3404, the cushioning element is expanded to place the cushioning element at the determined location. For example, under control of controller 214 or 154, stored energy reservoir 220 may be used to inflate actuatable cushioning element 210 to place cushioning element 210 at the determined location (e.g., at the front of vehicle 410), prior to the collision between the vehicle 410 and vehicle 420.

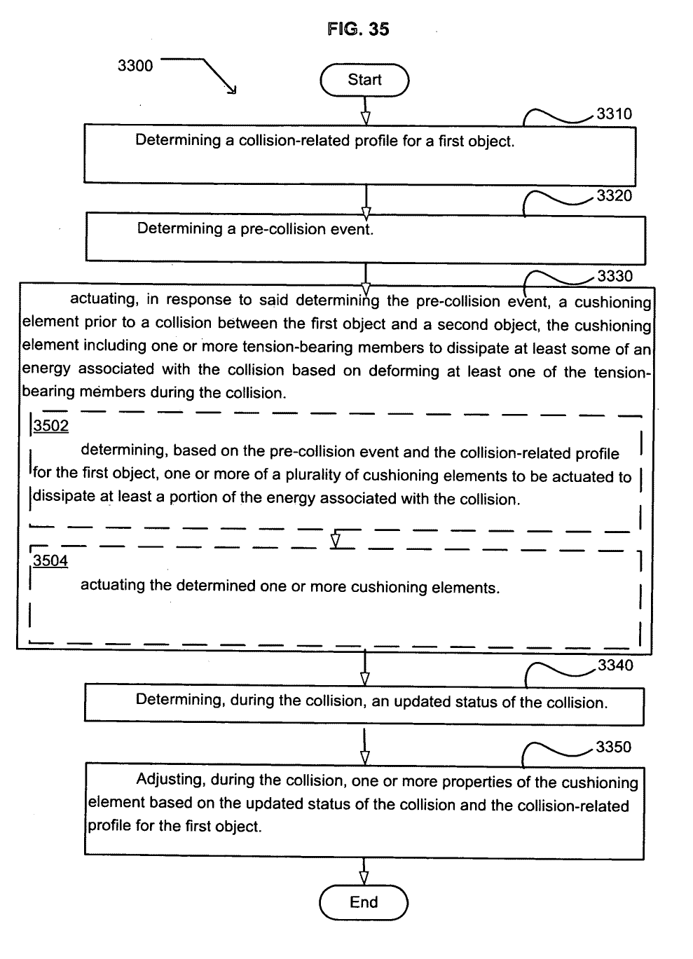

FIG. 35 illustrates alternative embodiments of the example operational flow 3300 of FIG. 33. FIG. 35 illustrates example embodiments where the actuating operation 3330 may include at least one additional operation. Additional operations may include operations 3502 and/or 3504.

At the operation 3502, based on the pre-collision event and the collision-related profile for the first object, one or more of a plurality of cushioning elements are determined to be actuated to dissipate at least a portion of the energy associated with the collision. For example, one or two cushioning elements 210 are determined or identified by controller 154 or 214 to be actuated, e.g., based on the pre-collision event and the collision-related profile 240 for vehicle 410.

At operation 3504, the one or more determined cushioning elements are actuated. For example, under control of controller 154 or 214, a stored energy reservoir for each cushioning element may inflate each determined cushioning element 210 (FIG. 2).

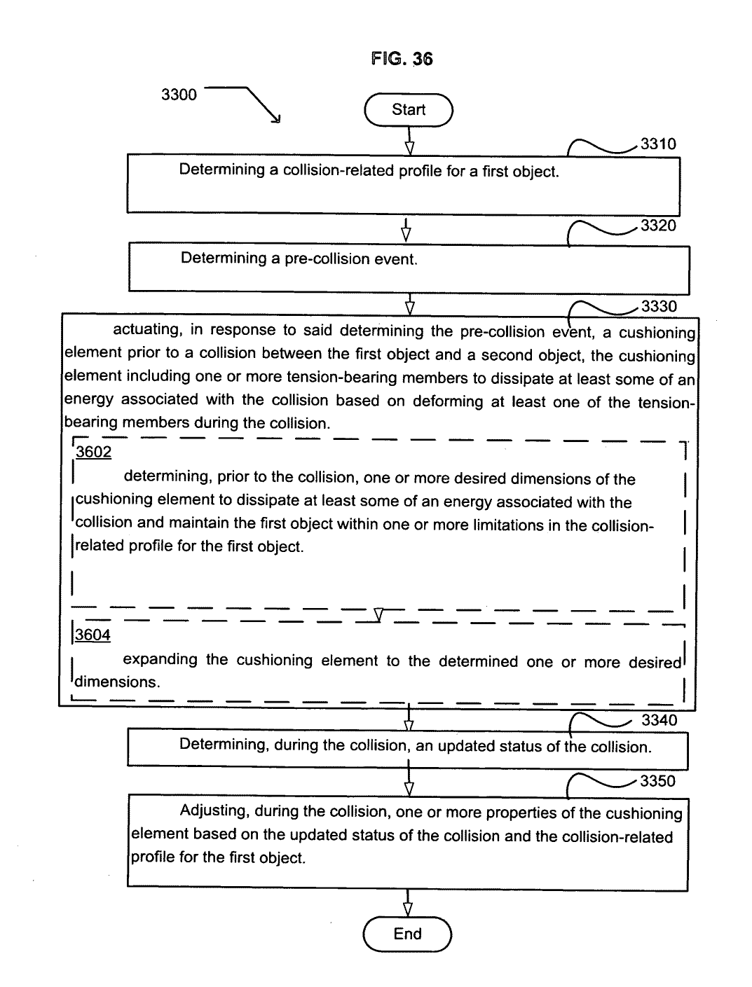

FIG. 36 illustrates alternative embodiments of the example operational flow 3300 of FIG. 33. FIG. 36 illustrates example embodiments where the actuating operation 3330 may include at least one additional operation. Additional operations may include operations 3602 and/or 3604.

At the operation 3602, it is determined, prior to the collision, one or more desired dimensions of the cushioning element to dissipate at least some of an energy associated with the collision and maintain the first object within one or more limitations in the collision-related profile for the first object. For example, controller 154 or 214 may determine a height, width and depth, and fluid pressure for a cushioning element 210 based on a relative velocity and a relative location of vehicle 410 with respect to vehicle 420 and the collision-related profile 240 for vehicle 410, e.g., such that at least some of the energy of the collision will be dissipated without exceeding one or more limitations of collision-related profile 240.

At the operation 3604, the cushioning element is expanded to the determined one or more desired dimensions. For example, the stored energy reservoir 220, under control of controller 154 or 214, may inflate the cushioning element(s) 210 to the desired fluid pressure and height, width and depth.

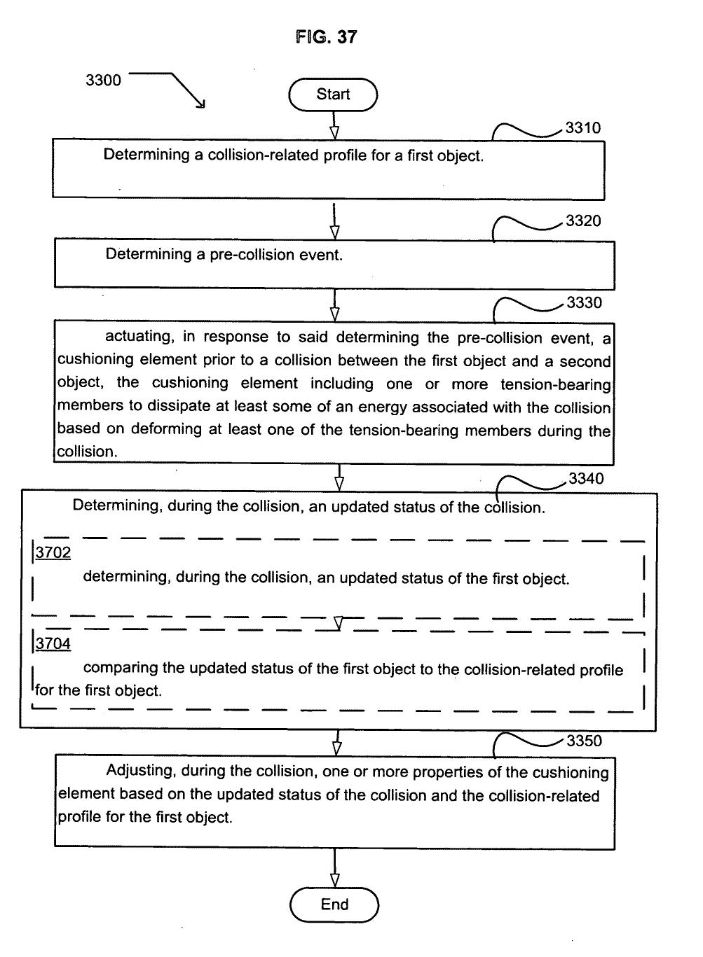

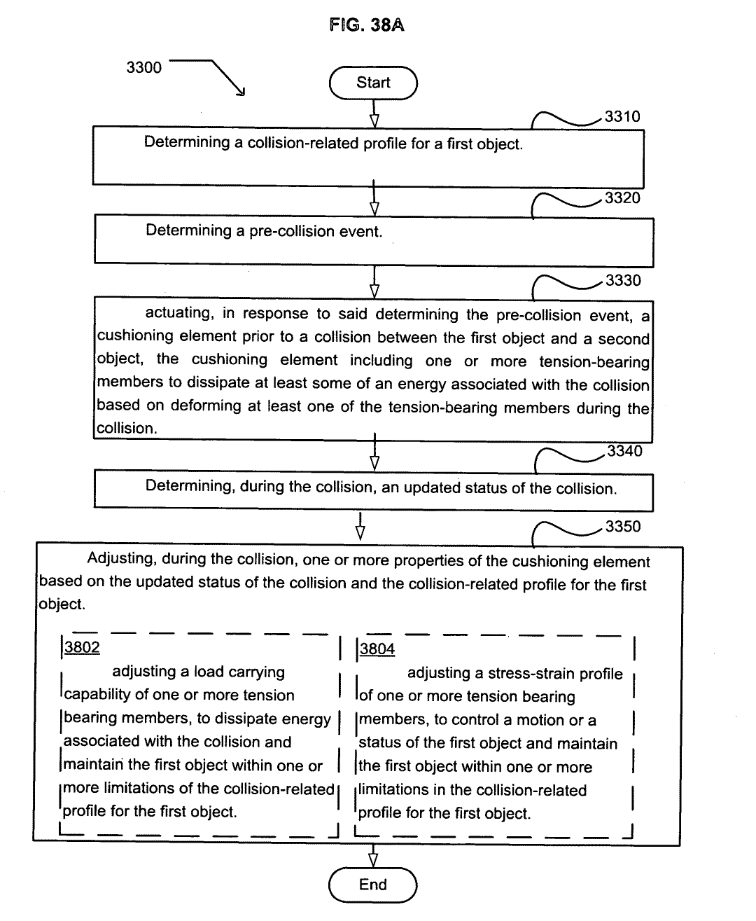

FIG. 37 illustrates alternative embodiments of the example operational flow 3300 of FIG. 33. FIG. 37 illustrates example embodiments where the determining operation 3340 may include at least one additional operation. Additional operations may include operations 3702 and/or 3704.

At the operation 3702, an updated status of the first object is determined during the collision. For example, based on signals from a detector 158, 218 or sensor, controller 154 or 214 may determine an updated location, velocity, orientation, etc., for vehicle 410, or an updated acceleration applied to vehicle 410, as examples.

At operation 3704, the updated status of the first object is compared to the collision-related profile for the first object. For example, the updated acceleration (e.g., 1.7 G) that is being applied to the vehicle 410, or the updated location of vehicle 410 is compared to the collision-related profile 240 for vehicle 410 (e.g., which may specify a maximum acceleration of 3.2 G for the vehicle 410).

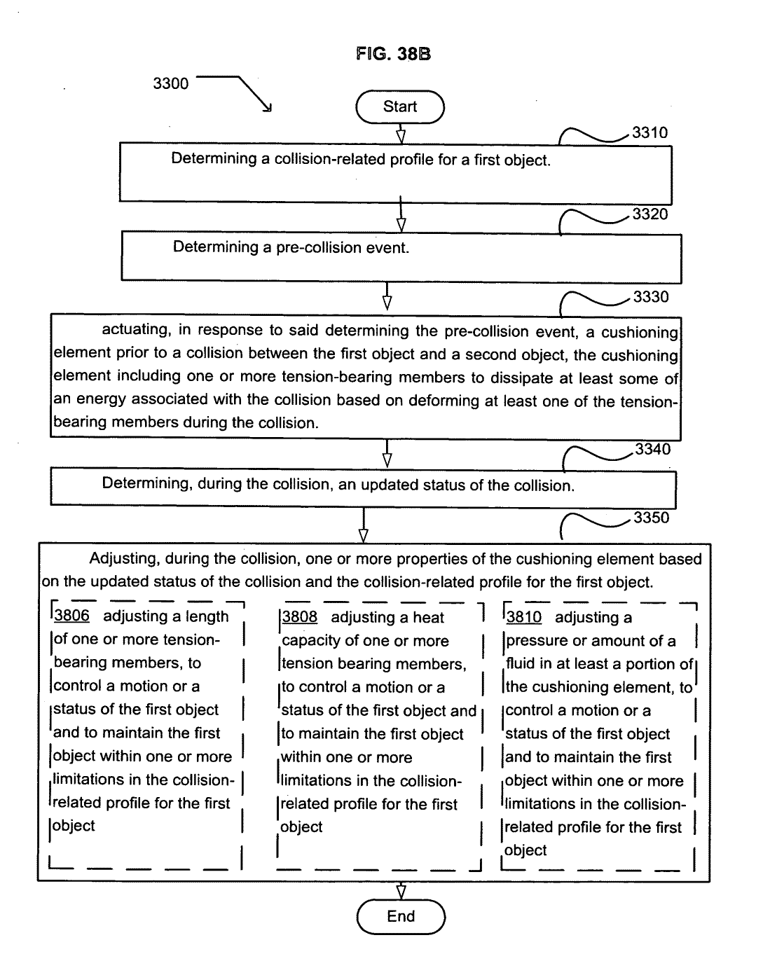

FIGS. 38A and 38B illustrate alternative embodiments of the example operational flow 3300 of FIG. 33. FIGS. 38A and 38B illustrate example embodiments where the adjusting operation 3350 may include at least one additional operation. Additional operations may include operations 3802, 3804, 3806, 3808 and/or 3810.

At the operation 3802, a load carrying capability of one or more tension bearing members is adjusted, to dissipate energy associated with the collision and maintain the first object within one or more limitations of the collision-related profile for the first object. For example, a heat capacity material 512 (FIG. 5A) may be applied to a tension-bearing member 230, or a portion of a tension-bearing member may be cut/damaged by a blade 720 (FIG. 7B) or electric cutter, which may adjust a load carrying capability of the tension-bearing member 230 to control how much force (e.g., newtons) the one or more tension bearing members can sustain before breaking.

At the operation 3804, a stress-strain profile of one or more tension bearing members is adjusted, to control a motion or a status of the first object and maintain the first object within one or more limitations in the collision-related profile for the first object. For example, a heat capacity material 512 (FIG. 5A) may be applied to a tension-bearing member 230, or a portion of a tension-bearing member may be cut/damaged by a blade 720 (FIG. 7B) or electric cutter, which may adjust a stress-strain profile of the tension-bearing member 230 to control how much force (e.g., newtons) the one or more tension bearing members can sustain before or during an inelastic deformation, or to control the amount of deformation (e.g., centimeters) the one or more tension bearing members will undergo when loaded with a specified force. At the operation 3806, a length of one or more tension-bearing members is adjusted to control a motion or a status of the first object and to maintain the first object within one or more limitations in the collision-related profile for the first object. For example, a length of one or more tension-bearing members 230 may be adjusted via use of a squib 710 and blade 712 (FIG. 7A). In an example embodiment, as shown in FIG. 7A, a squib 710 (or small explosive device) may be activated or exploded, which may propel a blade 712. The moving blade 712 may cut one of the lengthening loops 714 against a solid member 715. When a lengthening loop 714 is cut, this may lengthen the tension-bearing member 230, which may control a motion of a first object (e.g., vehicle 410) to maintain the vehicle within one or more limitations (e.g., acceleration to vehicle 410 less than 3 G during the collision) of the collision-related profile 240 (FIG. 2) of vehicle 410 (FIGS. 4, 6A, 6B).

At the operation 3808, a heat capacity of one or more tension bearing members is adjusted to control a motion or a status of the first object and to maintain the first object within one or more limitations in the collision-related profile for the first object. For example, a heat capacity material 512 may be applied to a tension-bearing member 230 (FIGS. 5A, 5B) to increase the heat or work capacity of the tension-bearing member 230, which may increase the amount of work the tension-bearing may perform, which may maintain the vehicle within one or more limitations in the collision-related profile (e.g., the vehicle 410 may not exceed an acceleration of 3 G).

At the operation 3810, a pressure or amount of a fluid in at least a portion of the cushioning element is adjusted to control a motion or a status of the first object and to maintain the first object within one or more limitations in the collision-related profile for the first object. For example, controller 154 or 214 (FIG. 2) may control stored energy reservoir 220 to increase a fluid pressure in cushioning element 210 to bring vehicle 410 to rest without exceeding an acceleration limit (e.g., 3 G) for vehicle 410.

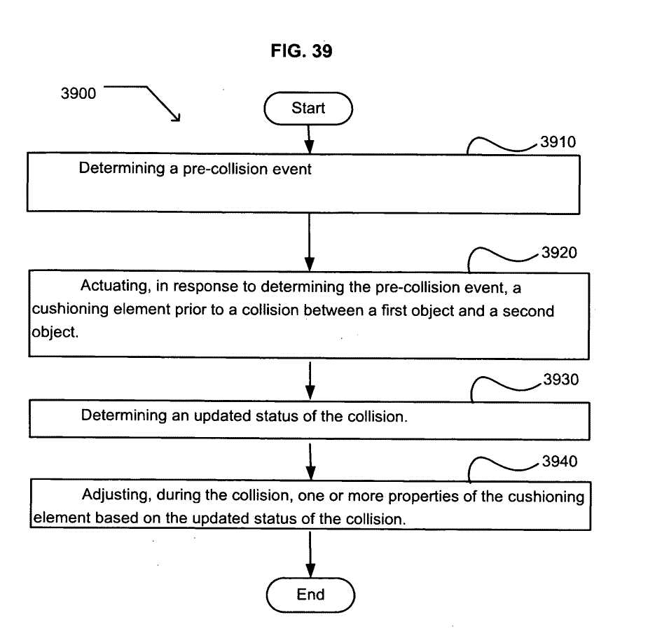

FIG. 39 illustrates an operational flow 3900 representing example operations related to an energy dissipative cushioning system.

After a start operation, the operational flow 3900 moves to a determining operation 3910 where a pre-collision event is determined. For example, an event detector 158 or 218 may detect or determine an event (or condition), or a series of events, such as a velocity that exceeds a threshold, an acceleration that exceeds a threshold, a change in acceleration or change in location or velocity, a relative location, velocity or acceleration of an object with respect to another object that is within a range or exceeds a threshold, etc. In an example embodiment, an event detector 158 or 218 provided in vehicle 410 may detect a pre-collision event (e.g., determine based on relative location, relative velocity and/or relative acceleration of objects (or vehicles) 410 and 420, that a collision between objects (or vehicles) 410 and 420 is likely to occur). This determining may be performed by event detector 158/218 and also possibly with controller 154 or 214.

Then, in an actuating operation 3920, a cushioning element is actuated, in response to determining the pre-collision event, prior to a collision between a first object and a second object. For example, as shown in FIG. 2, element controller 214 may actuate actuatable cushioning element 210 in response to event detector 218 determining the event. This actuating may include element controller 214 or central controller 154 deploying or placing the actuatable cushioning element 210 in an initial or pre-collision state, for example.

Then, in a determining operation 3930, an updated status of the collision is determined. For example, determining operation 3930 may include controller 154 or 214 determining or measuring one or more parameters with respect to a first vehicle 410, the second vehicle 420 and/or the cushioning element 210. For example, controller 154 or 214 may determine the relative location of vehicle 410 to vehicle 420 during the collision, based on, e.g., GPS or Radar or other sensor data. Or in another example embodiment, controller 154 or 214 may determine that a passenger (or sub-object 252) within vehicle 410 has undergone an acceleration of 3 G, or that the vehicles 410 and 420 have collided, or obtained the relative location and orientation of the vehicles 410 and 420 after the initial collision, or the location of the cushioning element with respect to the first vehicle 410, etc.

Then, in an adjusting operation 3940, during the collision, one or more properties of the cushioning element are adjusted based on the updated status of the collision. For example, a controller 154 or 214 may adjust a pressure or amount of a fluid (e.g., either gas or liquid) in at least a portion of the cushioning element 210. For example, the pressure of the fluid in the cushioning element may be adjusted to decrease or control an acceleration that is being applied to vehicle 410.

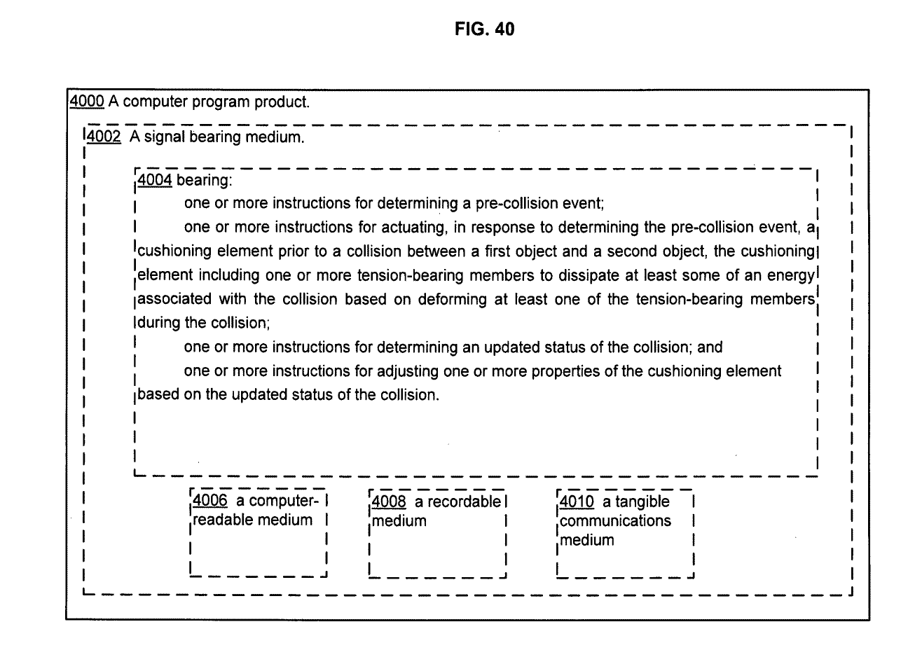

FIG. 40 illustrates a partial view of an example computer program product 4000 that includes a computer program 4004 for executing a computer process on a computing device. An embodiment of the example computer program product 4000 is provided using a signal bearing medium 4002, and may include one or more instructions for determining a pre-collision event, one or more instructions for actuating, in response to determining the pre-collision event, a cushioning element prior to a collision between a first object and a second object, the cushioning element including one or more tension-bearing members to dissipate at least some of an energy associated with the collision based on deforming at least one of the tension-bearing members during the collision, one or more instructions for determining an updated status of the collision, and one or more instructions for adjusting one or more properties of the cushioning element based on the updated status of the collision.

The one or more instructions may be, for example, computer executable and/or logic-implemented instructions. In one implementation, the signal-bearing medium 4002 may include a computer-readable medium 4006. In one implementation, the signal bearing medium 4002 may include a recordable medium 4008. In one implementation, the signal bearing medium 4002 may include a communications medium 4010.

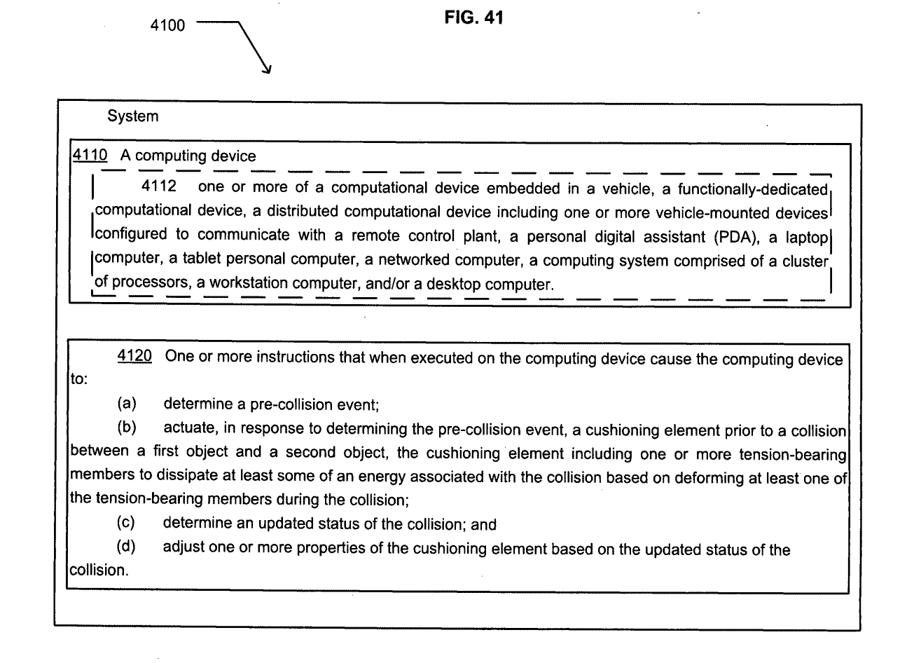

FIG. 41 illustrates an example system 4100. The system 4100 may include a computing device 4110. The system 4100 may also include one or more instructions 4120 that when executed on the computing device cause the computing device to: (a) determine a pre-collision event; (b) actuate, in response to determining the pre-collision event, a cushioning element prior to a collision between a first object and a second object, the cushioning element including one or more tension-bearing members to dissipate at least some of an energy associated with the collision based on deforming at least one of the tension-bearing members during the collision; (c) determine an updated status of the collision; and (d) adjust one or more properties of the cushioning element based on the updated status of the collision.

In some implementations, the computing device 4110 may be a computational device embedded in a vehicle, or may be a functionally-dedicated computational device. In some implementations, the computing device 4110 may include one or more of a computational device embedded in a vehicle, a functionally-dedicated computational device, a distributed computational device including one or more vehicle-mounted devices configured to communicate with a remote control plant, a personal digital assistant (PDA), a laptop computer, a tablet personal computer, a networked computer, a computing system comprised of a cluster of processors, a workstation computer, and/or a desktop computer (4112).

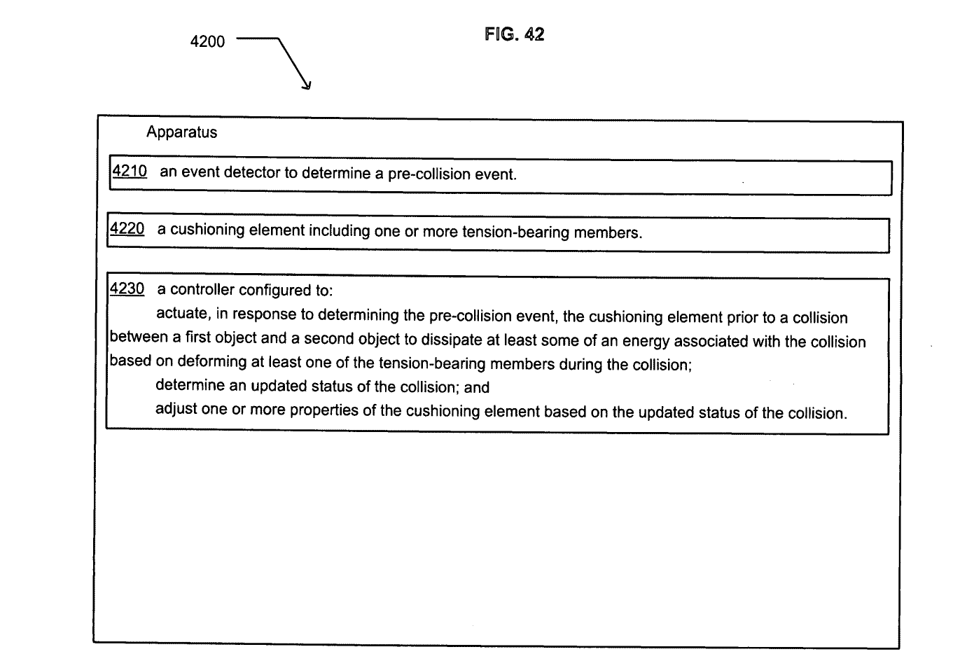

FIG. 42 illustrates an example apparatus in which embodiments may be implemented. FIG. 42 illustrates an example apparatus 4200 in which embodiments may be implemented. Example implementations may include implementations 4210, 4220 and 4230.

In implementation 4210, the apparatus 4200 may include an event detector to determine a pre-collision event. For example, a detector (e.g., 158 or 218, FIGS. 1, 2) may detect that a vehicle 410 has reached a specific location (e.g., via use of a GPS receiver), or has reached a specific speed (e.g., via use of a speedometer).

In implementation 4220, the apparatus 4200 may include a cushioning element including one or more tension-bearing members. For example, a cushioning element 210 may include one or more tension-bearing members 230 (FIGS. 2, 3A, 3B).

In implementation 4230, the apparatus 4200 may include a controller (e.g., controller 154, 214, FIG. 1, 2) configured to:

Actuate (e.g., by stored energy reservoir 220 under control of controller 154/214), in response to determining the pre-collision event, the cushioning element (210) prior to a collision between a first object (e.g., vehicle 410) and a second object (e.g., vehicle 420, FIG. 4) to dissipate at least some of an energy associated with the collision based on deforming at least one of the tension-bearing members (230) during the collision, determine an updated status of the collision (e.g., determine an update location or speed of vehicle 410 via detector 158), and adjust one or more properties of the cushioning element based on the updated status of the collision. For example, under control of controller 154/214 (FIG. 1, 2) of vehicle 410, a cushioning element may be actuated prior to the collision between vehicles 410 and 420. During the collision, for example, an updated status of the collision may be obtained by controller 154 or 214 (e.g., updated location or speed or orientation of vehicle 410, or acceleration applied to vehicle 410), and an adjustment may be performed such as adjusting a fluid pressure of cushioning element or deploying or actuating an additional cushioning element, or adjusting a length or tension of a tension-bearing member 230, etc.

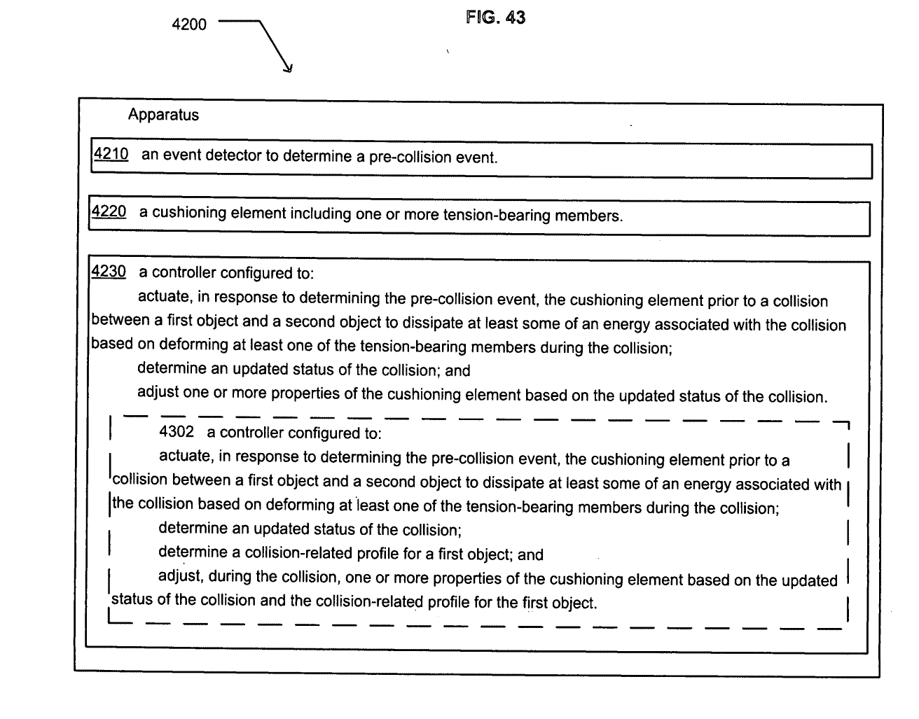

FIG. 43 also illustrates alternative embodiments of the example apparatus 4200. FIG. 43 illustrates example implementations where implementation 4230 may include at least one additional implementation. Additional implementations may include implementation 4302.

In implementation 4302, the apparatus 4200 may include a controller configured to: actuate, in response to determining the pre-collision event, the cushioning element prior to a collision between a first object and a second object to dissipate at least some of an energy associated with the collision based on deforming at least one of the tension-bearing members during the collision, determine an updated status of the collision, determine a collision-related profile for a first object, and adjust, during the collision, one or more properties of the cushioning element based on the updated status of the collision and the collision-related profile for the first object. For example, controller 154 or 214 may obtain a collision-related profile 240 for vehicle 410, and a cushioning element 210 may be actuated (e.g., by stored energy reservoir 220, FIG. 2, under control of controller 154 or 214) in response to a pre-collision event. Also, for example, an updated status of the collision may be obtained by controller 154 or 214 (e.g., updated location or speed or orientation of vehicle 410, or acceleration applied to vehicle 410), and an adjustment may be performed (e.g., under control of controller 154 or 214) during the collision, such as adjusting a fluid pressure of cushioning element or deploying or actuating an additional cushioning element, or adjusting a length or tension of a tension-bearing member 230, etc., based on the updated status and the collision-related profile 240 for the vehicle 410.

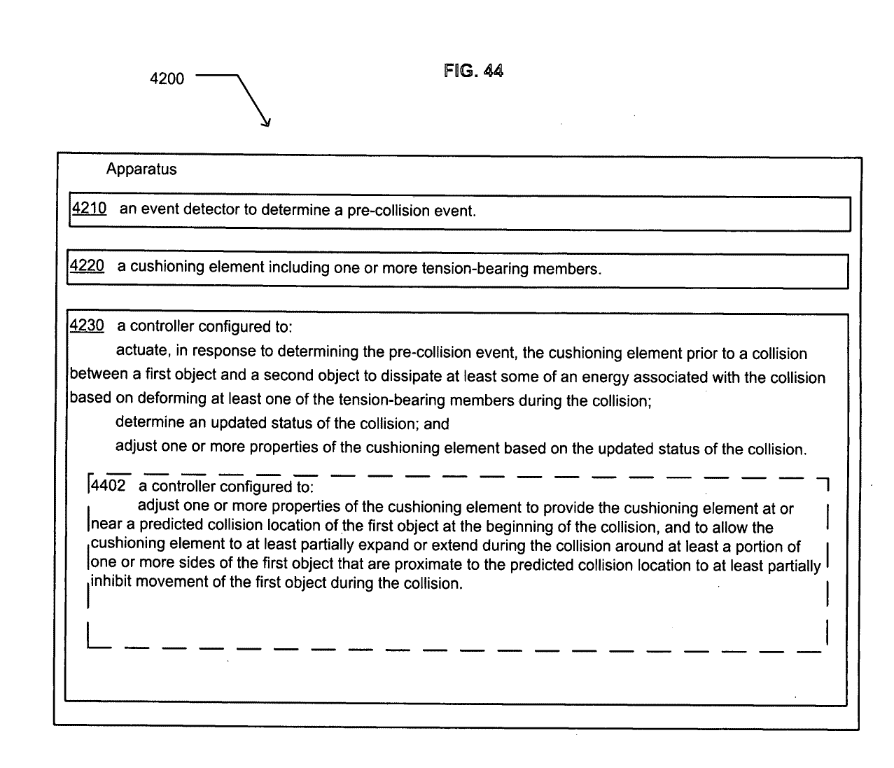

FIG. 44 also illustrates alternative embodiments of the example apparatus 4200. FIG. 44 illustrates example implementations where implementation 4230 may include at least one additional implementation. Additional implementations may include implementation 4402.

In implementation 4402, the apparatus 4200 may include a controller configured to: adjust one or more properties of the cushioning element to provide the cushioning element at or near a predicted collision location of the first object at the beginning of the collision, and to allow the cushioning element to at least partially expand or extend during the collision around at least a portion of one or more sides of the first object that are proximate to the predicted collision location to at least partially inhibit movement of the first object during the collision. In an example embodiment, in response to determining a pre-collision event, controller 154 or 214 of vehicle 410 may actuate a cushioning element 210 (and associated tension-bearing members 230) at or near the predicted collision location 610 prior to the collision between vehicles 410 and 420, as shown in FIG. 6A. Referring to FIG. 6B, during the collision between vehicles 410 and 420, at least a portion of cushioning element 210 may extend around at least a portion of one or more sides (such as sides 612A, 612B) of vehicle 410 that are proximate to the predicted collision location 610. For example, one or more adjustments may be made, such as before or during the collision, to the cushioning element 210 and/or associated tension-bearing members 230 for vehicle 410, which may allow or facilitate at least a portion of the cushioning element 210 to extend around at least a portion of one or both sides 612A, 612B of vehicle 410, as shown in FIG. 6B. When the cushioning element 210 extends around at least a portion of one or both sides 612A and 612B, this may create a glove or multi-sided support for the vehicle, which may inhibit movement of vehicle 410 during the collision based on the portion of the cushioning element extending around sides 612A and 612B, for example.

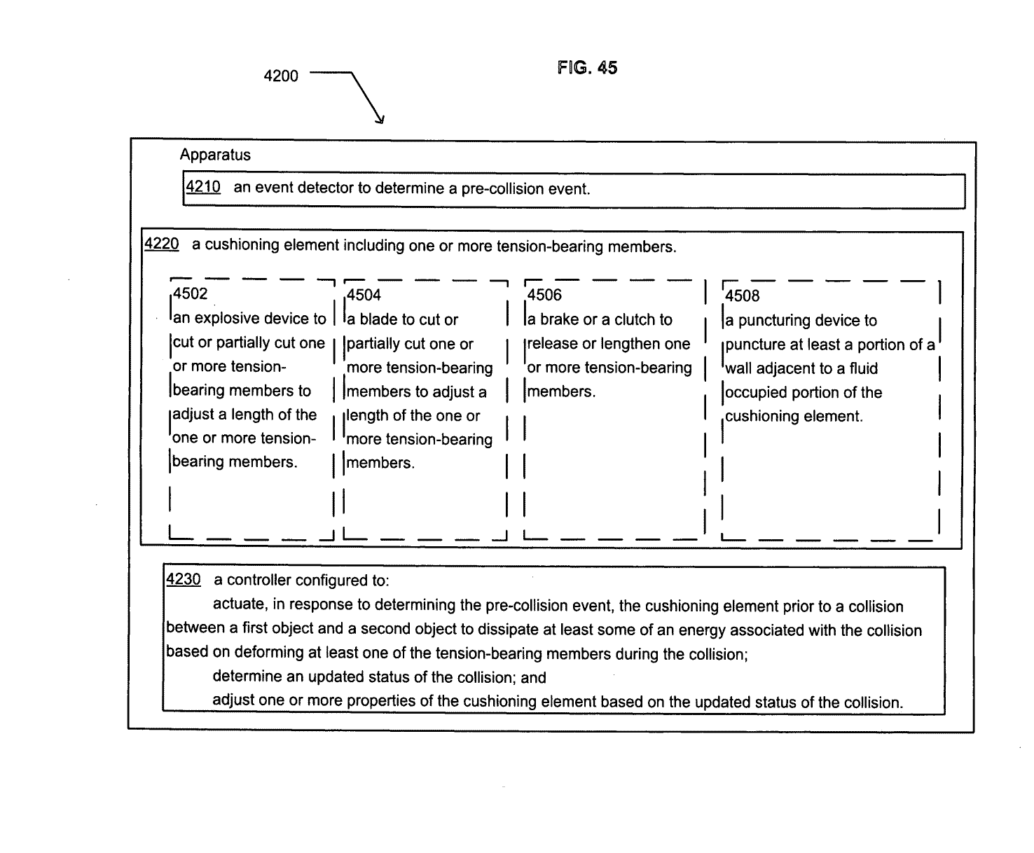

FIG. 45 also illustrates alternative embodiments of the example apparatus 4200. FIG. 45 illustrates example embodiments that may include at least one additional implementation. Additional implementations may include implementations 4502, 4504, 4506, and/or 4508.

In implementation 4502, the implementation 4220 may include an explosive device to cut or partially cut one or more of the tension-bearing members to adjust a length of one or more of the tension-bearing members. For example, as shown in FIG. 7A, a squib 710 (or small explosive device) may be activated or exploded, which may propel a blade 712. The moving blade 712 may cut one of the lengthening loops against a solid member 715.

In implementation 4504, the implementation 4220 may include a blade or electric cutter to cut or partially cut one or more tension-bearing members to adjust a length of one or more of the tension-bearing members. For example, as shown in FIG. 7A, a blade 712 may cut one of the lengthening loops 714 against a solid member 715, which may lengthen the tension-bearing member 230 that is connected to the lengthening loop 714.

In implementation 4506, the implementation 4220 may include a brake or a clutch to release or lengthen one or more of the tension-bearing members. For example, as shown in FIG. 7B, a lengthening loop 732 may be connected to a tension-bearing member 230A. In an example embodiment, a brake or clutch 730 may grip and release lengthening loop 732, under control of a controller 154 or 214, to increase or decrease a length of tension-bearing member 230A. For example, the brake or clutch 730 may release its grip on lengthening loop 732. When brake or clutch 730 releases its grip on lengthening loop 732, this may allow a portion of loop 732 to be pulled through the brake or clutch 730, increasing the length of tension-bearing member 230A.

In implementation 4508, the implementation 4220 may include a puncturing device to puncture at least a portion of a wall adjacent to a fluid occupied portion of the cushioning element. For example, in FIG. 7B, a blade, electric cutter, or needle 720 may puncture a fluid occupied portion of cushioning element 210. The fluid within cushioning element 210 may be liquid or gas, for example. By puncturing a portion of cushioning element 210, this may adjust (e.g., decrease) a pressure or amount of fluid in at least a portion of the cushioning element 210, for example.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electromechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electromechanical systems include but are not limited to a variety of consumer electronics systems, medical devices, as well as other systems such as motorized transport systems, factory automation systems, security systems, and/or communication/computing systems. Those skilled in the art will recognize that electromechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, a memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.) and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

1. A method comprising:
determining a pre-collision event;
actuating, in response to said determining the pre-collision event, a cushioning element prior to a collision between a first object and a second object, the cushioning element including one or more tension-bearing members to dissipate at least some of an energy associated with the collision based on deforming at least one of the tension-bearing members during the collision;
determining an updated status of the collision; and
adjusting one or more properties of the cushioning element based on the updated status of the collision.

2. The method of claim 1 wherein the determining a pre-collision event comprises:
determining that the first object has reached a specific location.

3. The method of claim 1 wherein the determining a pre-collision event comprises:
determining a change in acceleration for the first object that exceeds a threshold.

4. The method of claim 1 wherein the determining a pre-collision event comprises:
determining that the collision between the first object and the second object is likely to occur.

5. The method of claim 1 wherein the determining a pre-collision event comprises:
determining that the collision between the first object and the second object is likely to occur based on at least a relative location of the first object with respect to the second object.

6. The method of claim 1 wherein the determining a pre-collision event comprises:
determining that the collision between the first object and the second object is likely to occur based on at least a relative location and a relative velocity of the first object with respect to the second object.

7. The method of claim 1 wherein the determining a pre-collision event comprises:
determining that the collision between the first object and the second object is likely to occur based on a relative velocity of the first object with respect to the second object.

8. The method of claim 1 wherein the determining a pre-collision event comprises:
determining that the collision between the first object and the second object is likely to occur based on at least one of:
a relative location of the first object with respect to the second object;
a relative velocity of the first object with respect to the second object;
a relative acceleration of the first object with respect to the second object;
a relative orientation of the first object with respect to the second object;
a relative angular velocity of the first object with respect to the second object; or
a relative angular acceleration of the first object with respect to the second object.

9. The method of claim 1 wherein the determining a pre-collision event comprises:
predicting, based upon a calculational model, one or more outcomes of the collision between the first object and the second object.

10. The method of claim 1 wherein the determining a pre-collision event comprises:
predicting, based upon a calculational model, one or more outcomes of the collision between the first object and the second object, based at least in part upon an anticipated actuation of one or more cushioning elements.

11. The method of claim 1 wherein the actuating, in response to said determining the pre-collision event, a cushioning element prior to a collision between a first object and a second object, the cushioning element including one or more tension-bearing members to dissipate at least some of an energy associated with the collision based on deforming at least one of the tension-bearing members during the collision, comprises:
expanding a cushioning element to place one or more tension-bearing members in an initial state.

12. The method of claim 1 wherein the actuating, in response to said determining the pre-collision event, a cushioning element prior to a collision between a first object and a second object, the cushioning element including one or more tension-bearing members to dissipate at least some of an energy associated with the collision based on deforming at least one of the tension-bearing members during the collision, comprises:
inflating an inflatable fluid bag with gas or liquid to place one or more tension-bearing members in an initial state.

13. The method of claim 1 wherein the actuating, in response to said determining the pre-collision event, a cushioning element prior to a collision between a first object and a second object, the cushioning element including one or more tension-bearing members to dissipate at least some of an energy associated with the collision based on deforming at least one of the tension-bearing members during the collision, comprises:
determining, prior to the collision, a location or distance to place a cushioning element based on a relative velocity and relative location of the first object with respect to the second object; and
expanding the cushioning element to place the cushioning element at a determined location or distance prior to the collision between the first object and the second object.

14. The method of claim 1 wherein the actuating, in response to said determining the pre-collision event, a cushioning element prior to the collision between a first object and a second object, the cushioning element including one or more tension-bearing members to dissipate at least some of an energy associated with the collision based on deforming at least one of the tension-bearing members during the collision, comprises:
actuating, in response to determining a pre-collision event, a cushioning element prior to a collision between a first object and a second object, the cushioning element being actuated at or near a predicted collision location of the first object, at least a portion of the cushioning element extending during the collision around at least a portion of one or more sides of the first object that are proximate to the predicted collision location to at least partially inhibit movement of the first object during the collision.

15. The method of claim 1 wherein the determining an updated status of the collision comprises:
determining, during a collision, an updated status of the collision.

16. The method of claim 1 wherein the determining an updated status of the collision comprises at least one of:
determining an updated status of the first object;
determining an updated status of the first object with respect to the second object;
determining an updated status of the cushioning element;
determining or measuring one or more parameters with respect to the first object, the second object and/or the cushioning element; or
determining an updated status of a sub-object or passenger provided within the first object.

17. The method of claim 1 wherein the determining an updated status of the collision comprises:
determining an updated status of the first object, wherein said determining the updated status of the first object includes:
determining one or more of:
a location of the first object;
a velocity of the first object;
an acceleration of the first object;
an orientation of the first object;
an angular velocity of the first object;
an angular acceleration of the first object; or
values of one or more stresses or forces applied to the first object.

18. The method of claim 1 wherein the determining an updated status of the collision comprises:
determining an updated status of the first object with respect to the second object, wherein said determining the updated status of the first object with respect to the second object includes:
determining one or more of:
a relative location of the first object with respect to the second object;
a relative velocity of the first object with respect to the second object;
a relative acceleration of the first object with respect to the second object;
a relative orientation of the first object with respect to the second object;
a relative angular velocity of the first object with respect to the second object; or
a relative angular acceleration of the first object with respect to the second object.

19. The method of claim 1 wherein the determining an updated status of the collision comprises:
determining an updated status of a cushioning element, where said determining the updated status of the cushioning element includes:
determining one or more of:
a location or position of one or more portions of the cushioning element;
a relative location or position of one or more portions of the cushioning element with respect to the first object;
a relative location or position of one or more portions of the cushioning element with respect to the second object;
an amount of energy dissipated by the cushioning element during the collision;
a fluid pressure of a fluid within the cushioning element; or
a strain or stress of one or more of the tension bearing members.

20. The method of claim 1 wherein the determining an updated status of the collision comprises:
predicting, based upon a calculational model and one or more conditions sensed during a collision, one or more outcomes of the collision between the first object and the second object.

21. The method of claim 1 wherein the determining an updated status of the collision comprises:
predicting, based upon a calculational model and one or more conditions sensed during a collision, one or more outcomes of the collision between the first object and the second object, based at least in part upon an anticipated adjustment of a cushioning element.

22. The method of claim 1 wherein the adjusting one or more properties of the cushioning element based on the updated status of the collision comprises:
adjusting a pressure or amount of a fluid in at least a portion of a cushioning element.

23. The method of claim 1 wherein the adjusting one or more properties of the cushioning element based on the updated status of the collision comprises:
adjusting a load carrying capability of one or more tension bearing members.

24. The method of claim 1 wherein the adjusting one or more properties of the cushioning element based on the updated status of the collision comprises:
adjusting a stress-strain profile of one or more tension bearing members.

25. The method of claim 1 wherein the adjusting one or more properties of the cushioning element based on the updated status of the collision comprises:
adjusting a heat capacity of one or more tension bearing members.

26. The method of claim 1 wherein the adjusting one or more properties of the cushioning element based on the updated status of the collision comprises:
adjusting a length of one or more tension-bearing members.

27. The method of claim 1 wherein the adjusting one or more properties of the cushioning element based on the updated status of the collision comprises:
adjusting a length of one or more tension-bearing members by cutting or partially cutting the one or more tension-bearing members.

28. The method of claim 1 wherein the adjusting one or more properties of the cushioning element based on the updated status of the collision comprises:
adjusting a length of one or more tension-bearing members via use of an explosive device to cut or partially cut the one or more tension-bearing members.

29. The method of claim 1 wherein the adjusting one or more properties of the cushioning element based on the updated status of the collision comprises:
adjusting a length of one or more tension-bearing members via use of a brake or clutch to release or lengthen the one or more tension-bearing members.

30. The method of claim 1, wherein the adjusting one or more properties of the cushioning element based on the updated status of the collision comprises:
puncturing at least a portion of a wall adjacent to a fluid occupied portion of a cushioning element.

31. The method of claim 1, wherein the adjusting one or more properties of the cushioning element based on the updated status of the collision comprises:
adjusting one or more properties of a cushioning element to provide the cushioning element at or near a predicted collision location of the first object at a beginning of a collision, and to allow the cushioning element to expand during the collision around at least a portion of one or more sides of the first object that are proximate to the predicted collision location to at least partially inhibit movement of the first object during the collision.

32. The method of claim 1 wherein the adjusting one or more properties of the cushioning element based on the updated status of the collision comprises:
applying a heat capacity material to one or more tension-bearing members to increase a work capacity of the one or more tension-bearing members.

33. The method of claim 1
wherein the adjusting one or more properties of the cushioning element based on the updated status of the collision comprises:
adjusting one or more properties of a cushioning element, said adjusting the one or more properties of the cushioning element including:
adjusting a length of one or more tension-bearing members, said adjusting the length of the one or more tension-bearing members to dissipate energy associated with the collision and to maintain the first object within one or more limitations of a collision-related profile for the first object.

34. The method of claim 1
wherein the adjusting one or more properties of the cushioning element based on the updated status of the collision comprises:
adjusting one or more properties of a cushioning element, based on an updated status of a collision and a collision-related profile, said adjusting the one or more properties of the cushioning element to dissipate energy associated with the collision and to maintain the first object within one or more limitations of a collision-related profile for the first object.

35. The method of claim 1 and further comprising:
determining a collision-related profile for the first object; and
adjusting, during a collision, one or more properties of a cushioning element based on an updated status of the collision and the collision-related profile for the first object.

36. The method of claim 1
wherein the adjusting one or more properties of the cushioning element based on the updated status of the collision comprises:
adjusting a length of one or more tension-bearing members, said adjusting the length of the one or more tension-bearing members to control a motion or status of the first object and maintain the first object within one or more limitations in a collision-related profile for the first object.

37. The method of claim 1
wherein the adjusting one or more properties of the cushioning element based on the updated status of the collision comprises:
adjusting a length of one or more tension-bearing members via use of an explosive device to cut or partially cut the one or more tension-bearing members, said adjusting the length to control a motion or a status of the first object and maintain the first object within one or more limitations in a collision-related profile for the first object.

38. The method of claim 1
wherein the adjusting one or more properties of the cushioning element based on the updated status of the collision comprises:
adjusting, during a collision, one or more properties of a cushioning element based on an updated status of the collision and a collision-related profile for the first object, said adjusting to bring the first object to rest at an end of the collision and to maintain the first object within one or more limitations of the collision-related profile for the first object.

39. The method of claim 1
wherein the adjusting one or more properties of the cushioning element based on the updated status of the collision comprises:
adjusting, during a collision, one or more properties of a cushioning element based on an updated status of the collision and a collision-related profile for the first object, said adjusting to dissipate energy associated with the collision to bring the first object to rest without the first object exceeding an acceleration or a stress limit indicated by the collision-related profile for the first object.

40. The method of claim 1 and further comprising:
determining a collision-related profile or a calculational model for the first object, wherein said determining the collision-related profile or the calculational model further includes:
retrieving from a memory the collision-related profile or the calculational model for the first object, the collision-related profile or the calculational model including one or more of:
one or more limitations or preferences for acceleration for one or more portions of the first object;
one or more limitations or preferences for stress for one or more portions of the first object;
one or more limitations or preferences for damage for one or more portions of the first object;
one or more properties of the first object;
a model of an object indicating how the first object may move or operate during a collision;
a model of an object indicating how the first object may move or operate during a collision when the cushioning element is actuated or adjusted;
a desired orientation or location for the first object; or
one or more properties of a sub-object or passenger provided within the first object.

41. The method of claim 1 and further comprising:
actuating, during a collision, one or more additional cushioning elements.

42. A method comprising:
determining a collision-related profile for a first object;
determining a pre-collision event;
actuating, in response to said determining the pre-collision event, a cushioning element prior to a collision between the first object and a second object, the cushioning element including one or more tension-bearing members to dissipate at least some of an energy associated with the collision based on deforming at least one of the tension-bearing members during the collision;
determining, during the collision, an updated status of the collision; and
adjusting, during the collision, one or more properties of the cushioning element based on the updated status of the collision and the collision-related profile for the first object.

43. The method of claim 42 wherein the actuating, in response to said determining the pre-collision event, a cushioning element prior to a collision between the first object and a second object, the cushioning element including one or more tension-bearing members to dissipate at least some of an energy associated with the collision based on deforming at least one of the tension-bearing members during the collision, comprises:
determining, prior to a collision, a location to place a cushioning element to dissipate at least some of an energy associated with the collision and to maintain the first object within one or more limitations in the collision-related profile for the first object; and
expanding the cushioning element to place the cushioning element at a determined location.

44. The method of claim 42 wherein the actuating, in response to said determining the pre-collision event, a cushioning element prior to a collision between the first object and a second object, the cushioning element including one or more tension-bearing members to dissipate at least some of an energy associated with the collision based on deforming at least one of the tension-bearing members during the collision, comprises:
determining, based on the pre-collision event and the collision-related profile for the first object, one or more of a plurality of cushioning elements to be actuated to dissipate at least a portion of the energy associated with the collision; and
actuating the determined one or more cushioning elements.

45. The method of claim 42 wherein the actuating, in response to said determining the pre-collision event, a cushioning element prior to a collision between the first object and a second object, the cushioning element including one or more tension-bearing members to dissipate at least some of an energy associated with the collision based on deforming at least one of the tension-bearing members during the collision, comprises:
determining, prior to the collision, one or more desired dimensions of the cushioning element to dissipate at least some of an energy associated with the collision and maintain the first object within one or more limitations in the collision-related profile for the first object; and
expanding the cushioning element to the determined one or more desired dimensions.

46. The method of claim 42 wherein the determining, during the collision, an updated status of the collision comprises:
determining, during the collision, an updated status of the first object; and
comparing the updated status of the first object to the collision-related profile for the first object.

47. The method of claim 42 wherein the adjusting, during the collision, one or more properties of the cushioning element based on the updated status of the collision and the collision-related profile for the first object comprises:
adjusting a load carrying capability of one or more tension bearing members, to dissipate energy associated with the collision and maintain the first object within one or more limitations of the collision-related profile for the first object.

48. The method of claim 42 wherein the adjusting, during the collision, one or more properties of the cushioning element based on the updated status of the collision and the collision-related profile for the first object comprises:
adjusting a stress-strain profile of one or more tension bearing members, to control a motion or a status of the first object and maintain the first object within one or more limitations in the collision-related profile for the first object.

49. The method of claim 42 wherein the adjusting, during the collision, one or more properties of the cushioning element based on the updated status of the collision and the collision-related profile for the first object comprises:
adjusting a length of one or more tension-bearing members, to control a motion or a status of the first object and to maintain the first object within one or more limitations in the collision-related profile for the first object.

50. The method of claim 42 wherein the adjusting, during the collision, one or more properties of the cushioning element based on the updated status of the collision and the collision-related profile for the first object comprises:
adjusting a heat capacity of one or more tension bearing members, to control a motion or a status of the first object and to maintain the first object within one or more limitations in the collision-related profile for the first object.

51. The method of claim 42 wherein the adjusting, during the collision, one or more properties of the cushioning element based on the updated status of the collision and the collision-related profile for the first object comprises:
adjusting a pressure or amount of a fluid in at least a portion of the cushioning element, to control a motion or a status of the first object and to maintain the first object within one or more limitations in the collision-related profile for the first object.

52. A method comprising:
determining a pre-collision event;
actuating, in response to determining the pre-collision event, a cushioning element prior to a collision between a first object and a second object;
determining an updated status of the collision; and
adjusting, during the collision, one or more properties of the cushioning element based on the updated status of the collision.

53-116. (canceled)
